(19) United States
(12) Patent Application Publication
(10) Pub. No.: US 2012/0307170 A1
(43) Pub. Date: Dec. 6, 2012

(54) DISPLAY DEVICE, BARRIER DEVICE, BARRIER DRIVING CIRCUIT, AND BARRIER DEVICE DRIVING METHOD

(75) Inventors: Yuichi Inoue, Kanagawa (JP); Chiaki Kanai, Kanagawa (JP)

(73) Assignee: Sony Corporation, Tokyo (JP)

(21) Appl. No.: 13/479,718

(22) Filed: May 24, 2012

(30) Foreign Application Priority Data
May 31, 2011 (JP) 2011-122737
Jan. 13, 2012 (JP) 2012-004928

(51) Int. Cl. G09G 3/36

(52) U.S. Cl. 349/37

(57) ABSTRACT

A barrier driving circuit includes a barrier driving section that supplies drive signals to two or more liquid crystal barriers that are adjacent to each other and to be placed into a closed state among a plurality of liquid crystal barriers. The plurality of liquid crystal barriers are disposed side-by-side and each of the liquid crystal barriers is switchable between an open state and the closed state. The drive signals supplied to the two or more liquid crystal barriers have respective polarities that are same with respect to one another.

### BACKGROUND

This disclosure relates to a display device of a parallax barrier type capable of performing a stereoscopic display, to a barrier device and a barrier driving circuit that are used for such display device, and to a barrier device driving method.

In recent years, a display device capable of achieving a stereoscopic display has been drawing attention. The stereoscopic display is a technique by which an image for a left eye and an image for a right eye having a parallax therebetween (having different perspectives from each other) are displayed, allowing a viewer to perceive those images as a stereoscopic image having a stereoscopic effect by viewing those images with his/her left eye and right eye respectively. A display device has also been developed that displays three or more images having a parallax therebetween to provide a viewer with a more natural stereoscopic image.

Such display devices fall in two major categories: display devices that require dedicated eyeglasses and display devices that require no dedicated eyeglasses. The display devices that do not require the dedicated eyeglasses have been desired, since the dedicated eyeglasses may be troublesome for the viewer. Examples of the display devices that do not require the dedicated eyeglasses include those of a parallax barrier type, those of a lenticular lens type, and so forth. In these types, a plurality of images (perspective images) having a parallax therebetween are displayed simultaneously to provide an image, which is viewed differently according to a relative positional relationship (an angle) between a display device and a viewpoint of a viewer.

When the plurality of perspective images are displayed in the display device mentioned above, however, the image has a resolution in effect defined by the division of a resolution of a display device (such as a CRT (Cathode Ray Tube) and a liquid crystal display) itself by the number of perspectives, causing a decrease in image quality. To address this, various studies have been made. For example, Japanese Unexamined Patent Application Publication No. 2010-276965 discloses a display device of the parallax barrier type, in which displaying is performed by switching a transmission state (an open state) and a blocking state (a closed state) of each of liquid crystal barriers that are disposed side-by-side in a display plane in a time-divisional fashion, to improve a resolution equivalently.

### SUMMARY

Meanwhile, a plurality of liquid crystal barriers disposed side-by-side are each provided with a drive signal to be driven based on that drive signal. It is thus likely that a region between the liquid crystal barriers fails to establish a desired state, which may result in a decrease in image quality.

It is desirable to provide a display device, a barrier device, a barrier driving circuit, and a barrier device driving method, capable of suppressing a decrease in image quality.

A display device according to an embodiment of the technology includes: a display section; a barrier section including a plurality of liquid crystal barriers that are disposed side-by-side, wherein each of the liquid crystal barriers is switchable between an open state and a closed state; and a barrier driving section supplying drive signals to two or more liquid crystal barriers that are adjacent to each other and to be placed into the closed state among the plurality of liquid crystal barriers. The drive signals supplied to the two or more liquid crystal barriers have respective polarities that are same with respect to one another.

A barrier device according to an embodiment of the technology includes: a barrier section including a plurality of liquid crystal barriers that are disposed side-by-side, wherein each of the liquid crystal barriers is switchable between an open state and a closed state; and a barrier driving section supplying drive signals to two or more liquid crystal barriers that are adjacent to each other and to be placed into the closed state among the plurality of liquid crystal barriers. The drive signals supplied to the two or more liquid crystal barriers have respective polarities that are same with respect to one another.

A barrier driving circuit according to an embodiment of the technology includes: a barrier driving section supplying drive signals to two or more liquid crystal barriers that are adjacent to each other and to be placed into a closed state among a plurality of liquid crystal barriers, wherein the plurality of liquid crystal barriers are disposed side-by-side and each of the liquid crystal barriers is switchable between an open state and the closed state, and the drive signals supplied to the two or more liquid crystal barriers have respective polarities that are same with respect to one another.

A barrier device driving method according to an embodiment of the technology includes: generating drive signals supplied to two or more liquid crystal barriers that are adjacent to each other and to be placed into a closed state among a plurality of liquid crystal barriers, wherein the plurality of liquid crystal barriers are disposed side-by-side and each of the liquid crystal barriers is switchable between an open state and the closed state, and the drive signals supplied to the two or more liquid crystal barriers have respective polarities that are same with respect to one another; and driving the two or more liquid crystal barriers by supplying the two or more liquid crystal barriers with the generated drive signals.

In the display device, the barrier device, the barrier driving circuit, and the barrier device driving method according to the embodiments of the technology described above, the plurality of liquid crystal barriers are placed into the open state to allow a viewer to see an image displayed on the display section. The liquid crystal barriers are controlled to switch between the open state and the closed state based on the drive signals. The drive signals, that are the same in polarity with respect to one another, are applied to the two or more liquid crystal barriers that are adjacent to each other and to be placed into the closed state.

According to the display device, the barrier device, the barrier driving circuit, and the barrier device driving method of the embodiments of the technology described above, the two or more liquid crystal barriers that are adjacent to each other and to be placed into the closed state are supplied with the drive signals having the respective polarities that are the same with respect to one another. Hence, it is possible to suppress a decrease in image quality.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating an exemplary configuration of a stereoscopic display device according to an example embodiment of the technology.

FIGS. 2A and 2B each illustrate the exemplary configuration of the stereoscopic display device illustrated in FIG. 1.

FIG. 3 is a block diagram illustrating an exemplary configuration of a display driving section illustrated in FIG. 1.

FIG. 4 is a circuit diagram illustrating an exemplary configuration of a display section illustrated in FIG. 1.

FIGS. 5A and 5B each illustrate an exemplary configuration of a liquid crystal barrier section illustrated in FIG. 1.

FIG. 6 illustrates an exemplary group configuration of the liquid crystal barrier section illustrated in FIG. 1.

FIGS. 7A to 7D each schematically illustrate an exemplary operation of the display section and the liquid crystal barrier section illustrated in FIG. 1.

FIG. 8 is a block diagram illustrating an exemplary configuration of a barrier driving section illustrated in FIG. 1.

FIG. 9 is a timing waveform chart illustrating an exemplary operation of the barrier driving section illustrated in FIG. 8.

FIG. 10 is a timing waveform chart illustrating another exemplary operation of the barrier driving section illustrated in FIG. 8.

FIG. 11 schematically illustrates an exemplary operation of stereoscopic displaying in the stereoscopic display device illustrated in FIG. 1.

FIG. 12 is a timing waveform chart illustrating an exemplary operation of the stereoscopic display device according to the first embodiment of the technology.

FIG. 13 schematically illustrates voltages applied to respective opening-closing sections according to the first embodiment.

FIG. 14 describes a state in a boundary region between the opening-closing sections according to the first embodiment.

FIG. 15 is a timing waveform chart illustrating an exemplary operation of a stereoscopic display device according to a comparative example.

FIG. 16 schematically illustrates voltages applied to respective opening-closing sections according to the comparative example.

FIG. 17 describes a state in a boundary region between the opening-closing sections according to the comparative example.

FIG. 18 is a timing waveform chart illustrating an exemplary operation of a barrier driving section according to a modification of the first embodiment.

FIG. 19 is a timing waveform chart illustrating an exemplary operation of a stereoscopic display device according to the modification of the first embodiment.

FIG. 20 is a timing waveform chart illustrating an exemplary operation of a barrier driving section according to another modification of the first embodiment.

FIG. 21 is a timing waveform chart illustrating an exemplary operation of a stereoscopic display device according to another modification of the first embodiment.

FIG. 22 illustrates an exemplary group configuration of a liquid crystal barrier section according to yet another modification of the first embodiment.

FIG. 23 is a timing waveform chart illustrating an exemplary operation of a stereoscopic display device according to still another modification of the first embodiment.

FIG. 24 illustrates an exemplary group configuration of a liquid crystal barrier section according to still another modification of the first embodiment.

FIG. 25 is a timing waveform chart illustrating an exemplary operation of a stereoscopic display device according to still another modification of the first embodiment.

FIG. 26 is a timing waveform chart illustrating an exemplary operation of a stereoscopic display device according to still yet another modification of the first embodiment.

FIG. 27 is a timing waveform chart illustrating an exemplary operation of a barrier driving section according to a second embodiment of the technology.

FIG. 28 is a timing waveform chart illustrating an exemplary operation of a stereoscopic display device according to the second embodiment.

FIG. 29 is a timing waveform chart illustrating an exemplary operation of a stereoscopic display device according to a modification of the second embodiment.

FIG. 30 is a timing waveform chart illustrating an exemplary operation of a barrier driving section according to another modification of the second embodiment.

FIG. 31 is a block diagram illustrating an exemplary configuration of a barrier driving section according to a third embodiment of the technology.

FIG. 32 is a timing waveform chart illustrating an exemplary operation of the barrier driving section illustrated in FIG. 31.

FIG. 33 is a timing waveform chart illustrating another exemplary operation of the barrier driving section illustrated in FIG. 31.

FIG. 34 is a timing waveform chart illustrating an exemplary operation of a stereoscopic display device according to the third embodiment.

FIG. 35 is a plan view illustrating an exemplary configuration of a liquid crystal barrier section according to a fourth embodiment of the technology.

FIGS. 36A to 36D each schematically illustrate an exemplary operation of a display section and the liquid crystal barrier section according to the fourth embodiment.

FIG. 37 schematically illustrates an exemplary operation of a stereoscopic display device according to the fourth embodiment.

FIG. 38 is a block diagram illustrating an exemplary configuration of a barrier driving section according to a fifth embodiment of the technology.

FIG. 39 is a timing waveform chart illustrating an exemplary operation of the barrier driving section according to the fifth embodiment.

FIG. 40 is a timing waveform chart illustrating an exemplary operation of a stereoscopic display device according to the fifth embodiment.

FIG. 41 is a characteristic diagram illustrating an example of a luminance distribution of the stereoscopic display device according to the fifth embodiment.

FIGS. 42A and 42B are characteristic diagrams each illustrating an example of a contrast characteristic of the corresponding stereoscopic display device, according to the fifth embodiment.

FIG. 43 is a timing waveform chart illustrating an exemplary operation of a barrier driving section according to a sixth embodiment of the technology.

FIG. 44 is a timing waveform chart illustrating an exemplary operation of a stereoscopic display device according to the sixth embodiment.

FIG. 45 is a waveform chart illustrating an example of a barrier drive signal according to the sixth embodiment.

FIG. 46 is a characteristic diagram illustrating a transmittance of an opening-closing section according to the sixth embodiment.

FIGS. 47A to 47D are waveform charts each illustrating an example of a barrier drive signal according to a modification of the sixth embodiment.

FIG. 48 is a timing waveform chart illustrating an exemplary operation of a stereoscopic display device according to another modification of the sixth embodiment.

FIG. 49 is a timing waveform chart illustrating an exemplary operation of a stereoscopic display device according to yet another modification of the sixth embodiment.

FIG. 50 is a timing waveform chart illustrating an exemplary operation of a stereoscopic display device according to a modification.

FIGS. 51A and 51B each illustrate an exemplary configuration of a stereoscopic display device according to another modification.

FIGS. 52A and 52B each schematically illustrate an exemplary operation of stereoscopic displaying in the stereoscopic display device according to another modification.

FIG. 53 is a timing waveform chart illustrating an exemplary operation of a stereoscopic display device according to yet another modification.

### DETAILED DESCRIPTION

In the following, some embodiments of the technology will be described in detail with reference to the accompanying drawings. The description will be given in the following order:

### 1. First Embodiment;

### 2. Second Embodiment;

### 3. Third Embodiment;

### 4. Fourth Embodiment;

### 5. Fifth Embodiment; and

### 6. Sixth Embodiment.

### 1. First Embodiment

### Configuration Example

### [Example of Overall Configuration]

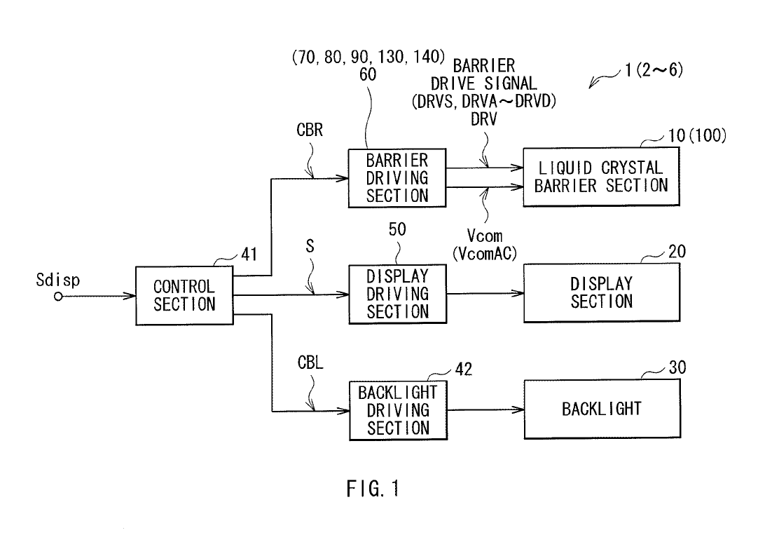

FIG. 1 illustrates an exemplary configuration of a stereoscopic display device 1 according to a first embodiment. The stereoscopic display device 1 is a display device of a parallax barrier type that uses liquid crystal barriers. It is to be noted that a barrier device, a barrier driving circuit, and a barrier device driving method according to respective embodiments of the technology are embodied by and are thus collectively described in the embodiments described herein. The stereoscopic display device 1 is provided with a control section 41, a backlight driving section 42, a backlight 30, a display driving section 50, a display section 20, a barrier driving section 60, and a liquid crystal barrier section 10.

The control section 41 is a circuit that supplies, based on an image signal Sdisp supplied from outside, a control signal to each of the backlight driving section 42, the display driving section 50, and the barrier driving section 60, to so control those sections as to operate in synchronization with one another. More specifically, the control section 41 supplies the backlight driving section 42 with a backlight control signal CBL, supplies the display driving section 50 with an image signal S based on the image signal Sdisp, and supplies the barrier driving section 60 with a barrier control signal CBR. In this embodiment, when the stereoscopic display device 1 performs stereoscopic displaying, the image signal S may be configured by image signals SA to SD each including a plurality of perspective images (eight perspective images in this embodiment), as will be described later in detail.

The backlight driving section 42 drives the backlight 30 based on the backlight control signal CBL supplied from the control section 41. The backlight 30 has a function of allowing surface-emission light to exit therefrom to the display section 20. The backlight 30 includes an LED (Light-Emitting Diode), CCFL (Cold Cathode Fluorescent Lamp), or other suitable light-emitting devices, for example.

The display driving section 50 drives the display section 20 based on the image signal S supplied from the control section 41. The display section 20 may be a liquid crystal display section in this embodiment, although it is not limited thereto. The display section 20 drives liquid crystal elements to modulate the light emitted from the backlight 30, so as to perform the displaying.

The barrier driving section 60 generates a barrier drive signal DRV (barrier drive signals DRVS and DRVA to DRVD described later) and a common signal Vcom based on the barrier control signal CBR supplied from the control section 41, and supplies those signals to the liquid crystal barrier section 10. The liquid crystal barrier section 10 allows light, having emitted from the backlight 30 and having passed through the display section 20, to transmit therethrough (an open operation) and blocks the light (an close operation). The liquid crystal barrier section 10 has a plurality of opening-closing sections 11 and 12 each including liquid crystals, as described later.

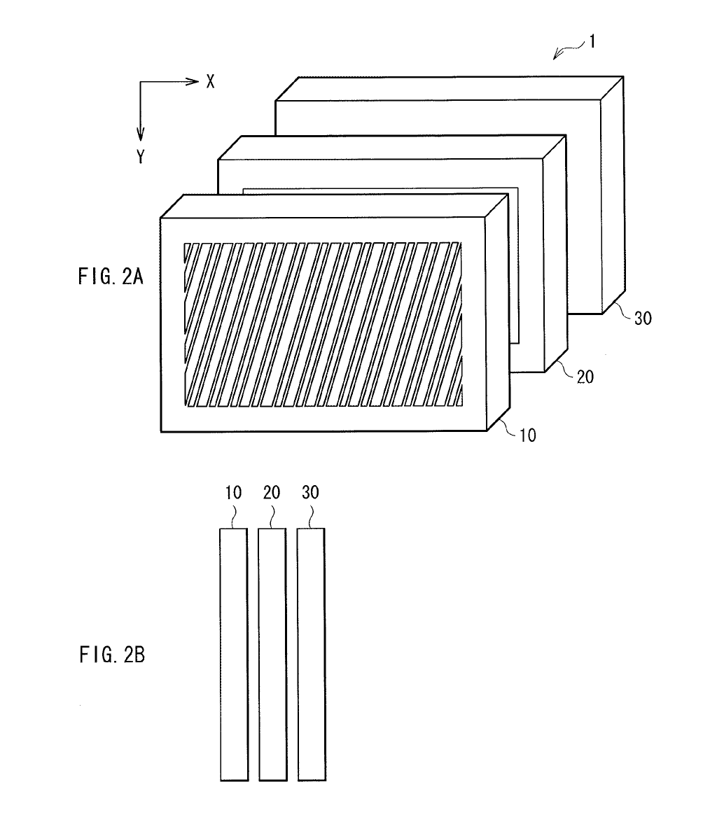

FIGS. 2A and 2B illustrate an exemplary configuration of a major section of the stereoscopic display device 1. FIG. 2A illustrates an exploded perspective configuration of the stereoscopic display device 1, and FIG. 2B illustrates a side of the configuration of the stereoscopic display device 1. Referring to FIGS. 2A and 2B, the backlight 30, the display section 20, and the liquid crystal barrier section 10 are disposed in this order in the stereoscopic display device 1. That is, the light emitted from the backlight 30 reaches a viewer via the display section 20 and the liquid crystal barrier section 10 sequentially.

### [Display Driving Section 50 and Display Section 20]

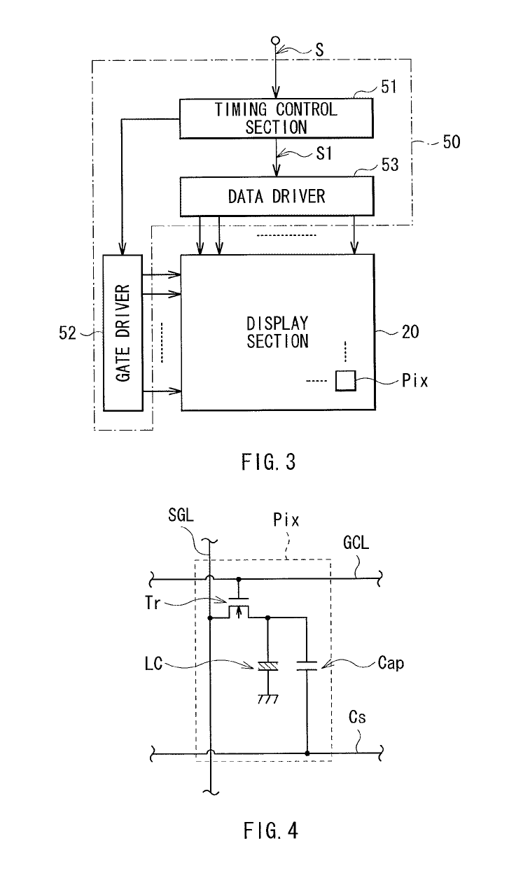

FIG. 3 illustrates an exemplary block diagram of the display driving section 50. The display driving section 50 includes a timing control section 51, a gate driver 52, and a data driver 53. The timing control section 51 controls drive timings of the gate driver 52 and the data driver 53, and supplies the image signal S supplied from the control section 41 to the data driver 53 as an image signal 51. The gate driver 52 sequentially selects pixels Pix in the display section 20 on a row-by-row basis to perform line-sequential scanning thereof, in response to the timing control by the timing control section 51. The data driver 53 supplies a pixel signal based on the image signal S1 to each of the pixels Pix in the display section 20. More specifically, the data driver 53 performs a D/A (digital/analog) conversion based on the image signal S1 to generate the analog pixel signal, and supplies the thus-generated pixel signal to each of the pixels Pix.

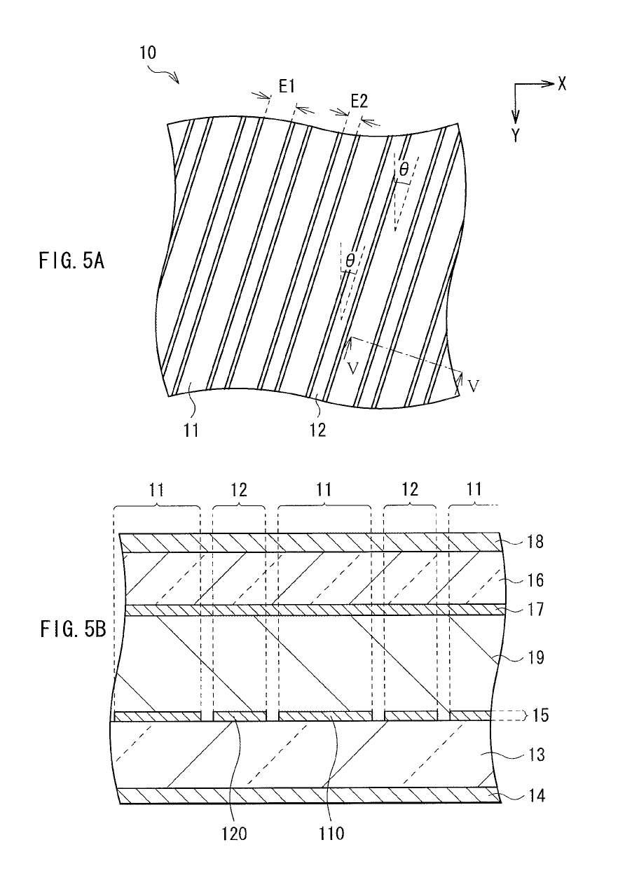

FIG. 4 illustrates an exemplary circuit diagram of the pixel Pix in the display section 20. The pixel Pix is provided with a TFT (Thin-Film Transistor) element Tr, a liquid crystal element LC, and a holding capacitive element Cap. For example, the TFT element Tr may be configured of a MOS-FET (Metal Oxide Semiconductor-Field Effect Transistor). The TFT element Tr may have a gate connected to a gate line GCL, a source connected to a data line SGL, and a drain connected to a first end of the liquid crystal element LC and to a first end of the holding capacitive element Cap. The liquid crystal element LC may have the first end connected to the drain of the TFT element Tr, and a second end connected to the ground. The holding capacitive element Cap may have the first end connected to the drain of the TFT element Tr, and a second end connected to a holding capacitive line Cs. The gate line GCL may be connected to the gate driver 52, and the data line SGL may be connected to the data driver 53.

### [Liquid Crystal Barrier Section 10 and Barrier Driving Section 60]

FIGS. 5A and 5B each illustrate an exemplary configuration of the liquid crystal barrier section 10, in which FIG. 5A illustrates a planar configuration of the liquid crystal barrier section 10, and FIG. 5B illustrates a cross-sectional configuration of the liquid crystal barrier section 10 taken along a V-V line in FIG. 5A as viewed in an arrow direction. In this embodiment, the liquid crystal barrier section 10 performs a normally-white operation, in which the liquid crystal barrier section 10 allows the light to transmit therethrough in a state where the liquid crystal barrier section 10 is not driven, although it is not limited thereto.

The liquid crystal barrier section 10 is a so-called parallax barrier, and has the plurality of opening-closing sections (the liquid crystal barriers) 11 and 12 that are disposed alternately and allow the light to pass therethrough and block the light. The opening-closing sections 11 and 12 perform different operations depending on whether the stereoscopic display device 1 performs normal displaying (two-dimensional displaying) or stereoscopic displaying (three-dimensional displaying). More specifically, the opening-closing sections 11 are in an open state (a transmission state) in performing the normal displaying, and are in a closed state (a blocking state) in performing the stereoscopic displaying, as described later in detail. Also, the opening-closing sections 12 are in the open state (the transmission state) in performing the normal displaying, and are caused to perform an opening-closing operation in a time-divisional fashion in performing the stereoscopic displaying, as described later in detail.

The opening-closing sections 11 and 12 are provided to extend in one direction (for example, in a direction forming a predetermined angle θ with a vertical direction Y in this embodiment) in an X-Y plane. This angle θ may be set to 18 degrees, for example. Providing the opening-closing sections 11 and 12 to extend in an oblique direction makes it possible to reduce moire in the stereoscopic display device 1. The opening-closing sections 11 and 12 may have different widths E1 and E2, respectively, and the widths E1 and E2 may have a relationship defined by E1>E2 in this embodiment. However, note that the more or less relationship between the opening-closing sections 11 and 12 is not limited thereto. Alternatively, the relationship may be either E1<E2 or E1=E2. Such opening-closing sections 11 and 12 include a liquid crystal layer (a liquid crystal layer 19 described later), in which switching between opening and closing thereof is carried out in accordance with a drive voltage applied to the liquid crystal layer 19.

Referring to FIG. 5B, the liquid crystal barrier section 10 has a configuration in which the liquid crystal layer 19 is provided between a transparent substrate 13 and a transparent substrate 16. The transparent substrates 13 and 16 may be made of such as glass. In this embodiment, the transparent substrate 13 is disposed on a light incident side, and the transparent substrate 16 is disposed on a light emitting side. A surface of the transparent substrate 13 facing the liquid crystal layer 19 and a surface of the transparent substrate 16 facing the liquid crystal layer 19 are provided with transparent electrode layers 15 and 17, respectively. The transparent electrode layers 15 and 17 may be made of such as ITO (Indium Tin Oxide). Further, a surface of the transparent electrode layer 15 facing the liquid crystal layer 19 and a surface of the transparent electrode layer 17 facing the liquid crystal layer 19 are provided with respective alignment films which are unillustrated. The liquid crystal layer 19 may be configured by TN (Twisted Nematic) liquid crystals, i.e., the liquid crystal layer 19 in this embodiment includes the TN liquid crystals by which the normally-white operation is performed, although it is not limited thereto. Alternatively, STN (Super-Twisted Nematic) liquid crystals may be employed that achieves the normally-white operation, for example. A surface of the transparent substrate 13 on the light incident side and a surface of the transparent substrate 16 on the light emitting side are attached with polarization plates 14 and 18, respectively. The polarization plates 14 and 18 control a polarization direction of light incident on the liquid crystal layer 19 and a polarization direction of light to be emitted therefrom, respectively. A transmission axis of the polarization plate 14 may be in a horizontal direction X, and a transmission axis of the polarization plate 18 may be in the vertical direction Y, for example. That is, the transmission axes of the polarization plates 14 and 18 may be so set as to be orthogonal to each other.

The transparent electrode layer 15 has a plurality of transparent electrodes 110 and 120. The transparent electrodes 110 are applied with the barrier drive signal DRVS by the barrier driving section 60, and the transparent electrodes 120 are applied with the barrier drive signals DRVA to DRVD by the barrier driving section 60. The transparent electrode layer 17 is provided as an electrode common to each of the transparent electrodes 110 and 120. In this embodiment, the transparent electrode layer 17 is applied with the common signal Vcom (which may be a DC voltage of 0V, for example) by the barrier driving section 60. The transparent electrode 110 of the transparent electrode layer 15 and portions of the liquid crystal layer 19 as well as the transparent electrode layer 17 corresponding to that transparent electrode 110 configure the opening-closing section 11. Likewise, the transparent electrode 120 of the transparent electrode layer 15 and portions of the liquid crystal layer 19 as well as the transparent electrode layer 17 corresponding to that transparent electrode 120 configure the opening-closing section 12.

With this configuration, when a voltage is applied to the transparent electrode layer 15 (the transparent electrodes 110 and 120) and the transparent electrode layer 17 to increase a potential difference thereof, transmittance of light in the liquid crystal layer 19 is decreased, placing the opening-closing sections 11 and 12 into the blocking state (the closed state). On the other hand, when the potential difference of the voltage is decreased, the transmittance of light in the liquid crystal layer 19 is increased, placing the opening-closing sections 11 and 12 into the transmission state (the open state).

In the liquid crystal barrier section 10, the opening-closing sections 12 are grouped into a plurality of groups, and the opening-closing sections 12 belonging to the same group perform the open operation and the close operation at the same timing, in performing the stereoscopic displaying. In the following, the groups of the opening-closing sections 12 are described.

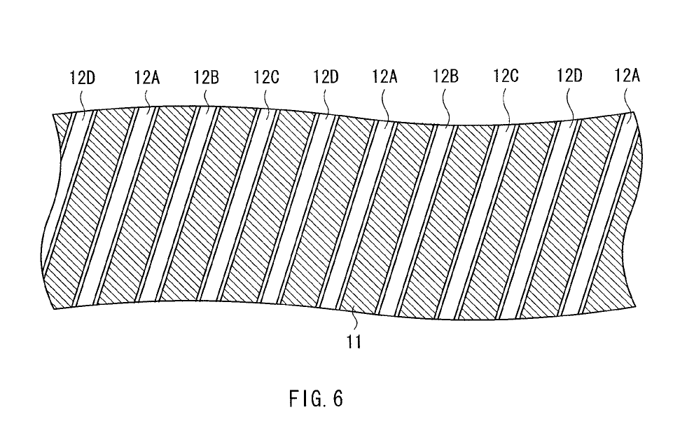

FIG. 6 illustrates an exemplary configuration of the groups configured by the opening-closing sections 12. In this example, the opening-closing sections 12 configure four groups A to D. For example, the opening-closing sections 12 configuring a group A, the opening-closing sections 12 configuring a group B, the opening-closing sections 12 configuring a group C, and the opening-closing sections 12 configuring a group D are disposed in turn in this order, as illustrated in FIG. 6. In the following description, the opening-closing sections 12 belonging to the group A are referred to as “opening-closing sections 12A”, and the opening-closing sections 12 belonging to the group B are referred to as “opening-closing sections 12B” as appropriate. Likewise, the opening-closing sections 12 belonging to the group C are referred to as “opening-closing sections 12C”, and the opening-closing sections 12 belonging to the group D are referred to as “opening-closing sections 12D” as appropriate.

The barrier driving section 60, in performing the stereoscopic displaying, so drives the opening-closing sections 12 as to allow the opening-closing sections 12 belonging to the same group perform the open operation and the close operation at the same timing. More specifically, the barrier driving section 60 supplies the barrier drive signal DRVA to the plurality of opening-closing sections 12A belonging to the group A, supplies the barrier drive signal DRVB to the plurality of opening-closing sections 12B belonging to the group B, supplies the barrier drive signal DRVC to the plurality of opening-closing sections 12C belonging to the group C, and supplies the barrier drive signal DRVD to the plurality of opening-closing sections 12D belonging to the group D, to so drive the opening-closing sections 12A to 12D as to allow those opening-closing sections 12A to 12D to perform the open operation and the close operation in turn (in a circuit fashion) in a time-divisional fashion. This operation will be described later in greater detail.

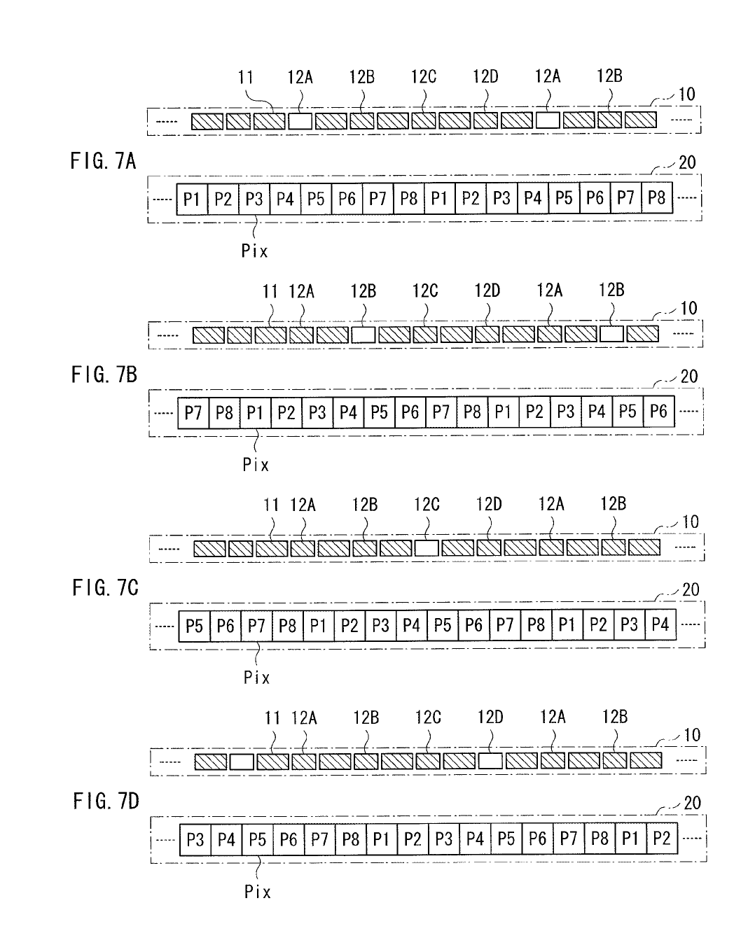

FIG. 7A to FIG. 7D schematically illustrate, using a cross-sectional configuration of the liquid crystal barrier section 10, an exemplary operation of the liquid crystal barrier section 10 and the display section 20. FIGS. 7A to 7D illustrate four states in performing the stereoscopic displaying. In this embodiment, one opening-closing section 12A is provided for every eight pixels Pix of the display section 20. Likewise, one opening-closing section 12B, one opening-closing section 12C, and one opening-closing section 12D are provided for every eight pixels Pix of the display section 20. In the following description, the pixel Pix is a pixel configured by three sub-pixels (for example, RGB), although it is not limited thereto. Alternatively, the pixel Pix itself may be a sub-pixel, for example. Note that, among the opening-closing sections 11 and 12 (12A to 12D) in the liquid crystal barrier section 10, those that block the light are shown shaded in FIGS. 7A to 7D.

Upon the stereoscopic displaying in the stereoscopic display device 1, the image signals SA to SD are supplied in a time-divisional fashion to the display driving section 50, and the display section 20 performs a displaying operation based on those image signals SA to SD. The liquid crystal barrier section 10 causes the opening-closing section 11 to maintain the closed state (the blocking state), while causing the opening-closing sections 12 (the opening-closing sections 12A to 12D) to perform the open and close operations in a time-divisional fashion in synchronization with the displaying performed by the display section 20. In more detail, when the image signal SA is supplied to the display driving section 50, the opening-closing section 12A enters the open state and the remaining other opening-closing sections 12 enter the closed state, as illustrated in FIG. 7A. Whereas in the display section 20, eight pixels Pix, which are disposed adjacent to one another at a position corresponding to that opening-closing section 12A, perform displaying corresponding to eight perspective images included in the image signal SA (pieces of pixel information P1 to P8), as described later in detail. Likewise, when the image signal SB is supplied to the display driving section 50, the opening-closing section 12B enters the open state and the remaining other opening-closing sections 12 enter the closed state, whereas in the display section 20, eight pixels Pix, which are disposed adjacent to one another at a position corresponding to that opening-closing section 12B, perform displaying corresponding to eight perspective images included in the image signal SB, as illustrated in FIG. 7B. When the image signal SC is supplied to the display driving section 50, the opening-closing section 12C enters the open state and the remaining other opening-closing sections 12 enter the closed state, whereas in the display section 20, eight pixels Pix, which are disposed adjacent to one another at a position corresponding to that opening-closing section 12C, perform displaying corresponding to eight perspective images included in the image signal SC, as illustrated in FIG. 7C. Further, when the image signal SD is supplied to the display driving section 50, the opening-closing section 12D enters the open state and the remaining other opening-closing sections 12 enter the closed state, whereas in the display section 20, eight pixels Pix, which are disposed adjacent to one another at a position corresponding to that opening-closing section 12D, perform displaying corresponding to eight perspective images included in the image signal SD, as illustrated in FIG. 7D. As will be described later, this enables a viewer to see different perspective images with his/her left and right eyes, making it possible for the viewer to sense the displayed images as a stereoscopic image, for example. Thus, the stereoscopic display device 1 displays the images by time-divisionally switching the opening-closing sections 12A to 12D to open those opening-closing sections 12A to 12D, making it possible to increase resolution of the display device as described later in detail.

On the other hand, in performing the normal displaying (the two-dimensional displaying), the display section 20 displays a normal two-dimensional image based on the image signal S, and the liquid crystal barrier section 10 causes all the opening-closing sections 11 and the opening-closing sections 12 (the opening-closing sections 12A to 12D) to maintain the open state (the transmission state). This enables a viewer to see the normal two-dimensional image displayed on the display section 20 as it is.

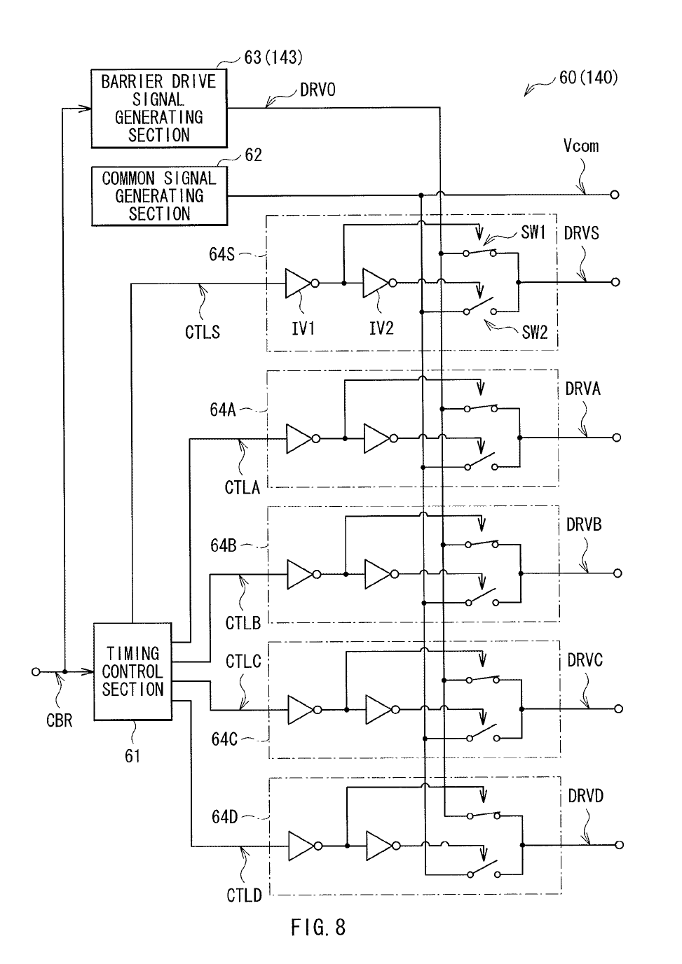

FIG. 8 illustrates an exemplary configuration of the barrier driving section 60. The barrier driving section 60 is provided with a timing control section 61, a common signal generating section 62, a barrier drive signal generating section 63, and selector circuits 64S and 64A to 64D.

The timing control section 61 generates opening-closing control signals CTLS and CTLA to CTLD based on the barrier control signal CBR. The opening-closing control signal CTLS is a logic signal by which opening and closing of the opening-closing section 11 are controlled, and the opening-closing control signals CTLA to CTLD are logic signals by which opening and closing of the respective opening-closing sections 12A to 12D are controlled. In this embodiment, a low (L) level corresponds to the open state and a high (H) level corresponds to the closed state as will be described later in the opening-closing control signals CTLS and CTLA to CTLD.

The common signal generating section 62 generates the common signal Vcom which may be a DC voltage of 0V, for example. The common signal Vcom is supplied to a common electrode (the transparent electrode layer 17) of the liquid crystal barrier section 10. The barrier drive signal generating section 63 generates a barrier drive signal DRV0 based on the barrier control signal CBR. The barrier drive signal DRV0, more specifically, is a barrier drive signal with a rectangular waveform, in which the common signal Vcom is defined as a center level and transition is made from a high level voltage VH to a low level voltage VL and vice versa in a predetermined cycle.

The selector circuit 64S generates the barrier drive signal DRVS based on the opening-closing control signal CTLS. The selector circuits 64A to 64D generate the barrier drive signals DRVA to DRVD based on the opening-closing control signals CTLA to CTLD, respectively. The barrier drive signal DRVS is applied to the transparent electrode 110 of the opening-closing section 11. The barrier drive signals DRVA to DRVD are applied to the respective transparent electrodes 120 of the opening-closing sections 12A to 12D.

Each of the selector circuits 64S and 64A to 64D has inverters IV1 and IV2 and switches SW1 and SW2. The inverter IV1 logically inverts corresponding one of the opening-closing control signals CTLS and CTLA to CTLD inputted thereto, and outputs the resultant as an output signal. The inverter IV2 logically inverts the output signal of the inverter IV1, and outputs the resultant as an output signal. The switch SW1 has a first end to which the barrier drive signal DRV0 is supplied, and a second end connected to an output terminal of corresponding one of the selector circuits 64S and 64A to 64D. The switch SW2 has a first end to which the common signal Vcom is supplied, and a second end connected to the output terminal of corresponding one of the selector circuits 64S and 64A to 64D.

With this configuration, in the selector circuit 64S, the switch SW1 is turned on and the switch SW2 is turned off, and the barrier drive signal DRV0 is outputted as the barrier drive signal DRVS, when the opening-closing control signal CTLS is at the L level, for example. Also, the switch SW1 is turned off and the switch SW2 is turned on, and the common signal Vcom is outputted as the barrier drive signal DRVS, when the opening-closing control signal CTLS is at the H level in the selector circuit 64S. This is applicable to the selector circuits 64A to 64D.

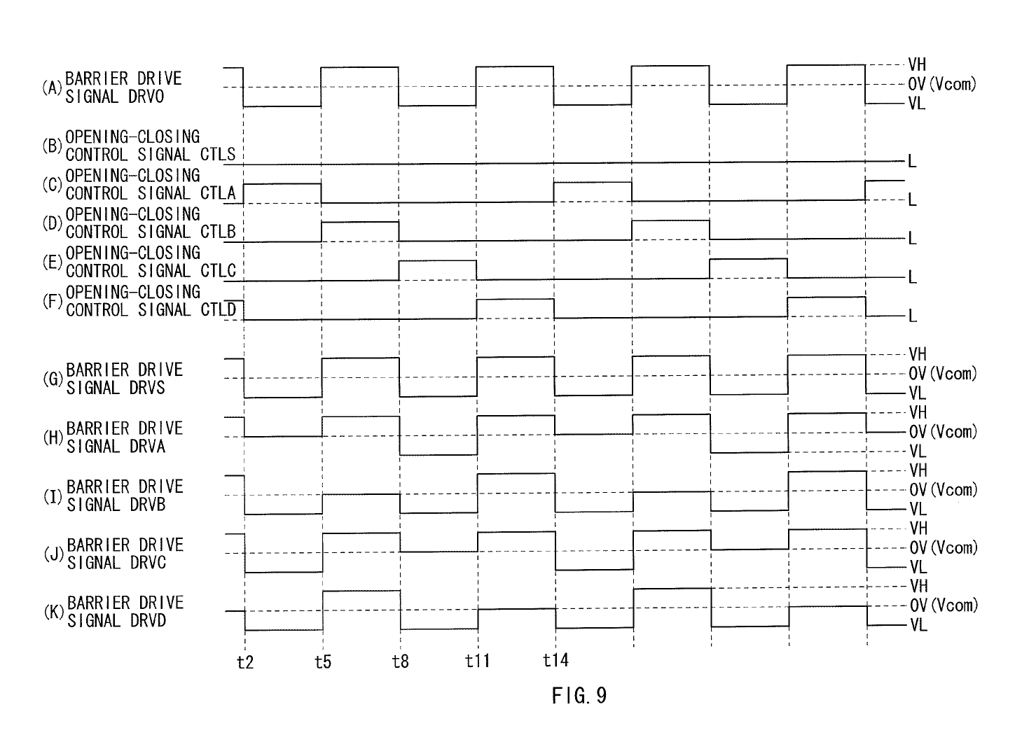

FIG. 9 illustrates an exemplary operation of the barrier driving section 60 in performing the stereoscopic displaying, in which (A) illustrates a waveform of the barrier drive signal DRV0, (B) to (F) illustrate waveforms of the respective opening-closing control signals CTLS and CTLA to CTLD, and (G) to (K) illustrate waveforms of the respective barrier drive signals DRVS and DRVA to DRVD. In performing the stereoscopic displaying, the timing control section 61 generates the opening-closing control signal CTLS which is constantly at the low level ((B) of FIG. 9), and generates the opening-closing control signals CTLA to CTLD each of which becomes the high level sequentially and time-divisionally ((C) to (F) of FIG. 9). In this embodiment, each of the opening-closing control signals CTLA to CTLD makes the transition at the same timing as a transition timing of the barrier drive signal DRV0, and a pulse width of each of the opening-closing control signals CTLA to CTLD is the same as or corresponds to a period of a half-cycle of the barrier drive signal DRV0. As illustrated in (G) to (H) of FIG. 9, each of the selector circuits 64S and 64A to 64D outputs, based on corresponding one of the opening-closing control signals CTLS and CTLA to CTLD, the barrier drive signal DRV0 as corresponding one of the barrier drive signals DRVS and DRVA to DRVD, when the corresponding one of the opening-closing control signals CTLS and CTLA to CTLD is at the low level. Also, each of the selector circuits 64S and 64A to 64D outputs, based on corresponding one of the opening-closing control signals CTLS and CTLA to CTLD, the common signal Vcom as corresponding one of the barrier drive signals DRVS and DRVA to DRVD, when the corresponding one of the opening-closing control signals CTLS and CTLA to CTLD is at the high level.

More specifically, in timing t2, the barrier drive signal generating section 63 inverts the barrier drive signal DRV0 ((A) of FIG. 9) and the timing control section 61 varies a level of the opening-closing control signal CTLA from the low level to the high level ((C) of FIG. 9). This causes the switch SW1 to be turned off and causes the switch SW2 to be turned on, allowing the common signal Vcom to be outputted for the barrier drive signal DRVA in the selector circuit 64A ((H) of FIG. 9). On the other hand, in the selector circuits 64S and 64B to 64D, the switches SW1 are turned on and the switches SW2 are turned off since the opening-closing control signals CTLS and CTLB to CTLD are each at the low level, allowing the barrier drive signal DRV0 to be outputted for each of the barrier drive signals DRVS and DRVB to DRVD ((G) and (I) to (K) of FIG. 9). Thereby, the opening-closing sections 12A are placed into the open state and the opening-closing sections 11 and 12B to 12D are placed into the closed state in the liquid crystal barrier section 10, as described later in detail.

Likewise, during a period from timing t5 to timing t8, the barrier driving section 60 outputs the common signal Vcom for the barrier drive signal DRVB, and outputs the barrier drive signal DRV0 for each of the barrier drive signals DRVS, DRVA, DRVC, and DRVD ((G) to (K) of FIG. 9). Thereby, the opening-closing sections 12B are placed into the open state and the opening-closing sections 11, 12A, 12C, and 12D are placed into the closed state in the liquid crystal barrier section 10, as described later in detail. Then, during a period from the timing t8 to timing t11, the barrier driving section 60 outputs the common signal Vcom for the barrier drive signal DRVC, and outputs the barrier drive signal DRV0 for each of the barrier drive signals DRVS, DRVA, DRVB, and DRVD ((G) to (K) of FIG. 9). Thereby, the opening-closing sections 12C are placed into the open state and the opening-closing sections 11, 12A, 12B, and 12D are placed into the closed state in the liquid crystal barrier section 10, as described later in detail. Then, during a period from the timing t11 to timing t14, the barrier driving section 60 outputs the common signal Vcom for the barrier drive signal DRVD, and outputs the barrier drive signal DRV0 for each of the barrier drive signals DRVS, DRVA, DRVB, and DRVC ((G) to (K) of FIG. 9). Thereby, the opening-closing sections 12D are placed into the open state and the opening-closing sections 11, 12A, 12B, and 12C are placed into the closed state in the liquid crystal barrier section 10, as described later in detail. The barrier driving section 60 repeats the operations carried out in the period from the timing t2 to the timing t14.

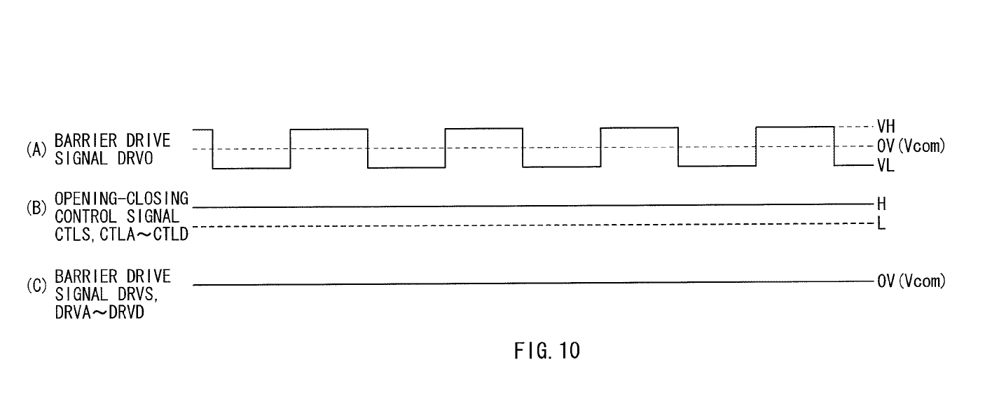

FIG. 10 illustrates an exemplary operation of the barrier driving section 60 in performing the normal displaying (two-dimensional displaying), in which (A) illustrates the waveform of the barrier drive signal DRV0, (B) illustrates the waveforms of the respective opening-closing control signals CTLS and CTLA to CTLD, and (C) illustrates the waveforms of the respective barrier drive signals DRVS and DRVA to DRVD. In performing the normal displaying, the timing control section 61 generates the opening-closing control signals CTLS and CTLA to CTLD each of which is constantly at the high level ((B) of FIG. 10). In the selector circuits 64S and 64A to 64D, the switches SW1 are turned off and the switches SW2 are turned on since the opening-closing control signals CTLS and CTLB to CTLD are each at the high level, allowing the common signal Vcom to be outputted for each of the barrier drive signals DRVS and DRVB to DRVD ((C) of FIG. 10). Thereby, the opening-closing sections 11 and 12A to 12D are all placed into the open state in the liquid crystal barrier section 10, as described later in detail.

In one embodiment, the opening-closing sections 11 and 12 correspond to a concrete (but not limitative) example of “liquid crystal barriers”. The opening-closing sections 12 correspond to a concrete (but not limitative) example of “first liquid crystal barriers”, and the opening-closing sections 11 correspond to a concrete (but not limitative) example of “second liquid crystal barriers”. The liquid crystal barrier section 10 corresponds to a concrete (but not limitative) example of a “liquid crystal barrier section”.

Also, in one embodiment, the barrier drive signal DRV corresponds to a concrete (but not limitative) example of “drive signals”. The barrier drive signals DRVA to DRVD correspond to a concrete (but not limitative) example of “first drive signals”. The barrier drive signal DRVS corresponds to a concrete (but not limitative) example of a “second drive signal”.

### [Operation and Function]

Next, operation and function of the stereoscopic display device 1 according to this embodiment are described.

### [Outline of General Operation]

First, referring to FIG. 1, an outline of a general operation of the stereoscopic display device 1 is described. The control section 41 supplies the control signal to each of the backlight driving section 42, the display driving section 50, and the barrier driving section 60 on the basis of the image signal Sdisp supplied from the outside, to control those backlight driving section 42, display driving section 50, and barrier driving section 60 to operate in synchronization with one another. The backlight driving section 42 drives the backlight 30. The backlight 30 allows the surface-emission light to exit therefrom to the display section 20. The display driving section 50 drives the display section 20 on the basis of the image signal S supplied from the control section 41. The display section 20 modulates the light emitted from the backlight 30 to perform the displaying. The barrier driving section 60 uses the barrier drive signal DRV (the barrier drive signals DRVS and DRVA to DRVD) to drive the liquid crystal barrier section 10. The opening-closing sections 11 and 12 (12A to 12D) of the liquid crystal barrier section 10 each perform the opening-closing operation on the basis of the barrier drive signal DRV (the barrier drive signals DRVS and DRVA to DRVD), to allow the light, which has emitted from the backlight 30 and has passed through the display section 20, to transmit therethrough or to block that light.

### [Detailed Operation of Stereoscopic Displaying]

Next, referring to some drawings, a detailed operation in performing the stereoscopic displaying is described.

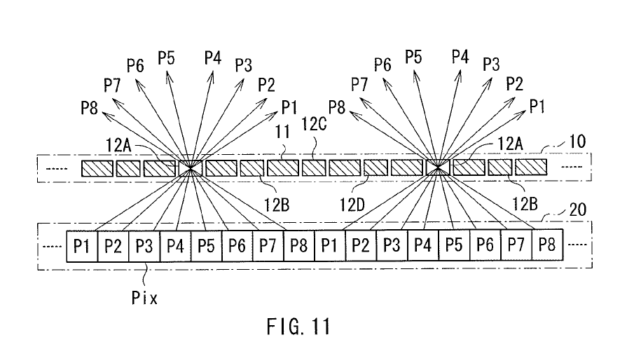

FIG. 11 illustrates an exemplary operation of the displays section 20 and the liquid crystal barrier section 10 when the image signal SA is supplied. The display section 20, when the image signal SA is supplied thereto, displays the pieces of pixel information P1 to P8, corresponding to the respective eight perspective images included in the image signal SA, on the respective pixels Pix disposed in the proximity of the opening-closing section 12A. In the liquid crystal barrier section 10, the opening-closing section 12A is set to the open state (transmission state), and the opening-closing sections 12B to 12D are set to the closed state. Thus, the light exited from each of the pixels Pix on the display section 20 is outputted with its angle limited by the opening-closing section 12A. A viewer sees a stereoscopic image by viewing, for example, the pixel information P4 with a left eye and the pixel information P5 with a right eye. It is to be noted that, although the description is given here with reference to a case where the image signal SA is supplied, the same hold true for the cases where the image signals SB to SD are supplied.

In such a manner, a viewer sees different pieces of pixel information among the pixel information P1 to P8 with a left eye and a right eye, thereby allowing to feel such pieces of pixel information as a stereoscopic image. Further, the images are displayed with the opening-closing sections 12A to 12D open sequentially in a time-divisional fashion, which enables the viewer to see averaged images displayed at positions shifted from one another. This allows the stereoscopic display device 1 to achieve the resolution four times as high as a case where only the opening-closing sections 12A are provided. In other words, for the stereoscopic display device 1, the resolution in the stereoscopic displaying may suffice to be only a half (=⅛×4) of that in the two-dimensional displaying.

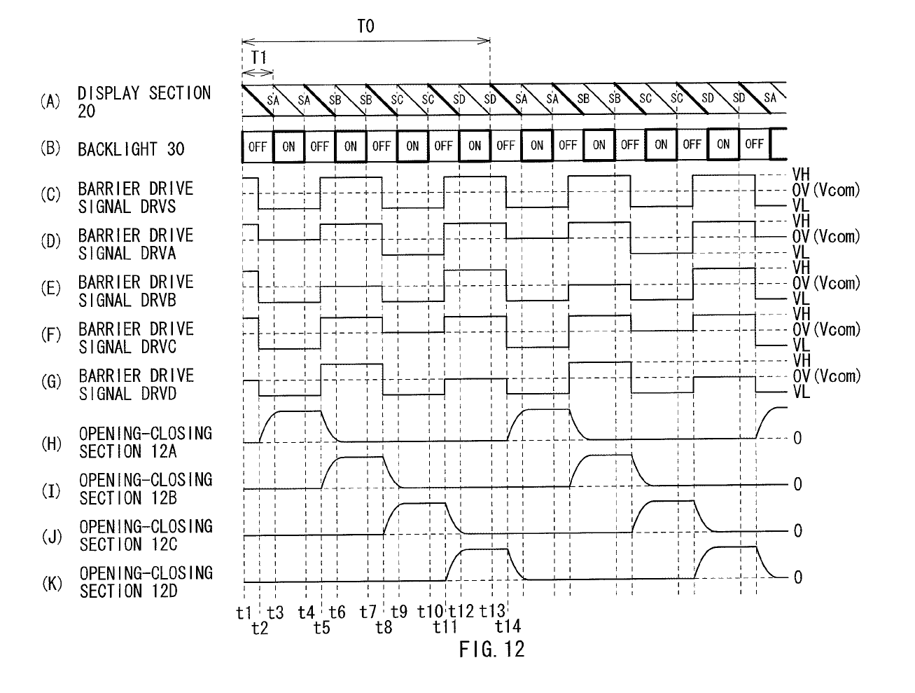

FIG. 12 is a timing chart illustrating operations of the stereoscopic displaying in the stereoscopic display device 1, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D.

A vertical axis in (A) of FIG. 12 denotes a position in the display section 20 at which a line-sequential scanning is being performed in a line-sequential scanning direction (Y direction). In other words, (A) of FIG. 12 denotes a state of operation of the display section 20 in each position in the Y direction at a certain time. In (A) of FIG. 12, “SA” denotes a state where displaying based on the image signal SA is being performed by the display section 20, “SB” denotes a state where displaying based on the image signal SB is being performed by the display section 20, “SC” denotes a state where displaying based on the image signal SC is being performed by the display section 20, and “SD” denotes a state where displaying based on the image signal SD is being performed by the display section 20. In (B) of FIG. 12, “ON” denotes a state where the backlight 30 is lighted, and “OFF” denotes a state where the backlight 30 not lighted. It is to be noted that timing t2 and so forth illustrated in FIG. 12 correspond to those illustrated in FIG. 9.

The stereoscopic display device 1 carries out a line-sequential scanning performed on a scanning cycle T1 basis, to carry out the displaying on each of the opening-closing sections 12A to 12D (the displaying operations based on the respective image signals SA to SD) sequentially in a time-divisional fashion. These displaying operations are repeated every displaying cycle T0. For example, the displaying cycle T0 may be 16.7 [msec] (= 1/60 [Hz]), and the scanning cycle T1 in this case may be 2.1 [msec] (=T0/8). In the following, a detail of an example embodiment illustrated in FIG. 12 is described.

First, the stereoscopic display device 1 performs the displaying based on the image signal SA, in a period from timing t1 to timing t4. More specifically, in the display section 20 from the timing t1 to timing t3 first, the line-sequential scanning is performed from the top to the bottom of the display section 20 on the basis of the drive signal supplied from the display driving section 50 to allow the displaying to be performed based on the image signal SA ((A) of FIG. 12), and the backlight 30 is turned off ((B) of FIG. 12). Then, in timing t2, the barrier driving section 60 varies the barrier drive signal DRVA to have zero volts (the common signal Vcom; (D) of FIG. 12), and varies the remaining other barrier drive signals DRVS and DRVB to DRVD to have the low level voltage VL ((C) and (E) to (G) of FIG. 12). This causes transmittance T of light in the opening-closing section 12A to increase in the liquid crystal barrier section 10 ((H) of FIG. 12). Then, from the timing t3 to the timing t4, the line-sequential scanning is performed from the top to the bottom of the display section 20, to allow the displaying based on the image signal SA to be performed again in the display section 20 ((A) of FIG. 12). In other words, the same frame image based on the image signal SA is displayed twice repeatedly. Also, the backlight 30 is turned on from the timing t3 to the timing t4 ((B) of FIG. 12). Thereby, a viewer may see the displaying based on the image signal SA on the display section 20 from the timing t3 to the timing t4.

Then, the stereoscopic display device 1 performs the displaying based on the image signal SB in a period from the timing t4 to timing t7, in a similar manner to the displaying based on the image signal SA in the period from the timing t1 to the timing t3. More specifically, from the timing t4 to timing t6 first, the backlight 30 is turned off ((B) of FIG. 12) and the display section 20 performs the displaying based on the image signal SB ((A) of FIG. 12). Then, in timing t5, the barrier driving section 60 varies the barrier drive signal DRVB to have zero volts (the common signal Vcom), and varies the remaining other barrier drive signals DRVS, DRVA, DRVC, and DRVD to have the high level voltage VH ((C) to (G) of FIG. 12). This causes the transmittance T of light in the opening-closing section 12A to decrease ((H) of FIG. 12), and causes the transmittance T of light in the opening-closing section 12B to increase ((I) of FIG. 12) in the liquid crystal barrier section 10. Then, from the timing t6 to the timing t7, the displaying based on the image signal SB is performed again ((A) of FIG. 12), and the backlight 30 is turned on ((B) of FIG. 12) in the display section 20. Thereby, a viewer may see the displaying based on the image signal SB on the display section 20 from the timing t6 to the timing t7. Also, the backlight 30 is turned off in the period from the timing t4 to the timing t6, allowing the viewer not to see a transitional change from the displaying based on the image signal SA to the displaying based on the image signal SB in the display section 20, as well as a transitional change in the transmittance T of light in the opening-closing sections 12A and 12B. Hence, it is possible to reduce degradation in image quality.

Then, the stereoscopic display device 1 likewise performs the displaying based on the image signal SC in a period from the timing t7 to timing t10. More specifically, from the timing t7 to timing t9 first, the backlight 30 is turned off ((B) of FIG. 12) and the display section 20 performs the displaying based on the image signal SC ((A) of FIG. 12). Then, in timing t8, the barrier driving section 60 varies the barrier drive signal DRVC to have zero volts (the common signal Vcom), and varies the remaining other barrier drive signals DRVS, DRVA, DRVB, and DRVD to have the low level voltage VL ((C) to (G) of FIG. 12). This causes the transmittance T of light in the opening-closing section 12B to decrease ((I) of FIG. 12), and causes the transmittance T of light in the opening-closing section 12C to increase ((J) of FIG. 12) in the liquid crystal barrier section 10. Then, from the timing t9 to the timing t10, the displaying based on the image signal SC is performed again ((A) of FIG. 12), and the backlight 30 is turned on ((B) of FIG. 12) in the display section 20. Thereby, a viewer may see the displaying based on the image signal SC on the display section 20 from the timing t9 to the timing t10. Also, the backlight 30 is turned off in the period from the timing t7 to the timing t9, allowing the viewer not to see a transitional change from the displaying based on the image signal SB to the displaying based on the image signal SC in the display section 20, as well as a transitional change in the transmittance T of light in the opening-closing sections 12B and 12C. Hence, it is possible to reduce degradation in image quality.

Then, the stereoscopic display device 1 likewise performs the displaying based on the image signal SD in a period from the timing t10 to timing t13. More specifically, from the timing t10 to timing t12 first, the backlight 30 is turned off ((B) of FIG. 12) and the display section 20 performs the displaying based on the image signal SD ((A) of FIG. 12). Then, in timing t11, the barrier driving section 60 varies the barrier drive signal DRVD to have zero volts (the common signal Vcom), and varies the remaining other barrier drive signals DRVS and DRVA to DRVC to have the high level voltage VH ((C) to (G) of FIG. 12). This causes the transmittance T of light in the opening-closing section 12C to decrease ((J) of FIG. 12), and causes the transmittance T of light in the opening-closing section 12D to increase ((K) of FIG. 12) in the liquid crystal barrier section 10. Then, from the timing t12 to the timing t13, the displaying based on the image signal SD is performed again ((A) of FIG. 12), and the backlight 30 is turned on ((B) of FIG. 12) in the display section 20. Thereby, a viewer may see the displaying based on the image signal SD on the display section 20 from the timing t12 to the timing t13. Also, the backlight 30 is turned off in the period from the timing t10 to the timing t12, allowing the viewer not to see a transitional change from the displaying based on the image signal SC to the displaying based on the image signal SD in the display section 20, as well as a transitional change in the transmittance T of light in the opening-closing sections 12C and 12D. Hence, it is possible to reduce degradation in image quality.

The stereoscopic display device 1 repeats the operations carried out in the period from the timing t1 to the timing t13 described above from then on to sequentially perform the displaying operations based on the image signals SA to SD (the displaying in the opening-closing sections 12A to 12D) in a time-divisional fashion.

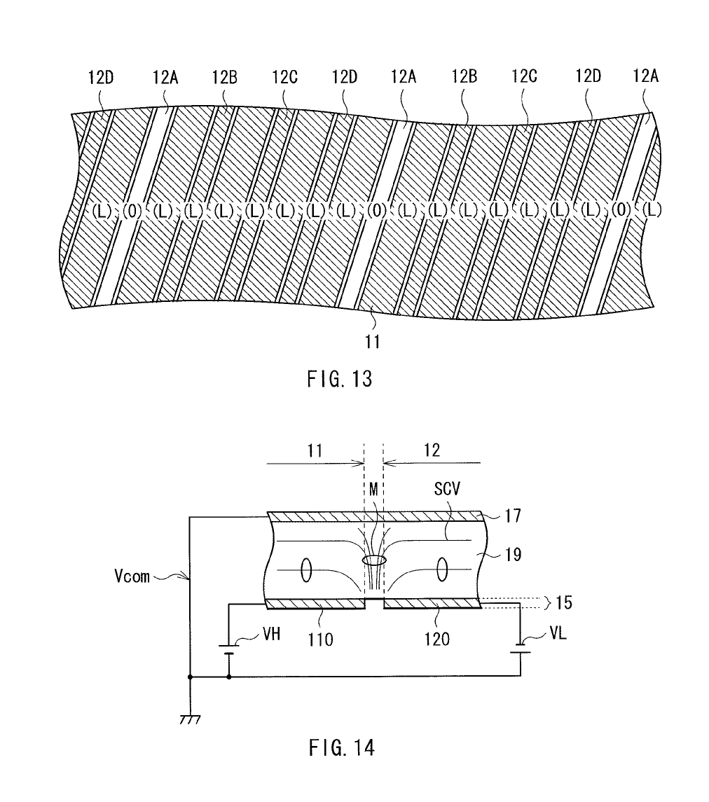

FIG. 13 illustrates voltages of the barrier drive signals DRVS and DRVA to DRVD applied to the respective opening-closing sections 11 and 12 (12A to 12D) from the timing t2 to the timing t5 illustrated in FIG. 12. Referring to FIG. 13, (0) denotes application of zero volts to the corresponding opening-closing section, (H) denotes application of the high level voltage VH to the corresponding opening-closing section, and (L) denotes application of the low level voltage VL to the corresponding opening-closing section. Also, those in each of which the light is blocked among the opening-closing sections 11 and 12 (12A to 12D) are shown shaded.

In the stereoscopic display device 1, the barrier driving section 60 applies the same voltages to the opening-closing sections that are to be placed in the closed state (i.e., the voltage applied to the opening-closing sections to be placed in the closed state is the same among those opening-closing sections). More specifically, as illustrated in FIG. 13, the barrier driving section 60 applies the low level voltage VL to the opening-closing sections 11 and 12B to 12D, excluding the opening-closing sections 12A, from the timing t2 to the timing t5 in FIG. 12. Likewise, the barrier driving section 60 applies: the high level voltage VH to the opening-closing sections 11, 12A, 12C, and 12D, excluding the opening-closing sections 12B, from the timing t5 to the timing t8 in FIG. 12; the low level voltage VL to the opening-closing sections excluding the opening-closing sections 12C from the timing t8 to the timing t11 in FIG. 12; and the high level voltage VH to the opening-closing sections 11 and 12A to 12C, excluding the opening-closing sections 12D, from the timing t11 to the timing t14 in FIG. 12. In this manner, the voltages, which are the same among the opening-closing sections to be placed in the closed state, are applied to those opening-closing sections in the stereoscopic display device 1.

Next, description is given on a behavior near a boundary between the opening-closing sections 11 and 12.

FIG. 14 schematically illustrates a behavior of liquid crystal molecules in the vicinity of the boundary between the opening-closing sections 11 and 12 in the stereoscopic display device 1. In one example illustrated in FIG. 14, a voltage of zero volts is applied to the common electrode (the transparent electrode layer 17), and the high level voltage VH is applied to each of the transparent electrode 110 in the opening-closing section 11 and the transparent electrode 120 in the opening-closing section 12.

In the liquid crystal layer 19 corresponding to the opening-closing section 11, an electric field is generated between the common electrode and the transparent electrode 110 to form an equipotential plane SCV parallel (horizontal) to a substrate. The liquid crystal molecules M in the liquid crystal layer 19 are so oriented that major axes thereof become perpendicular to the equipotential plane SCV. Thus, in the opening-closing section 11, the major axes of the liquid crystal molecules M are oriented in a direction perpendicular to a substrate plane, allowing the transmittance T of light to decrease in the opening-closing section 11 and placing the opening-closing section 11 into the blocking state (the closed state). Likewise, in the liquid crystal layer 19 corresponding to the opening-closing section 12, the electric field is also generated between the common electrode and the transparent electrode 120, whereby the major axes of the liquid crystal molecules M in the liquid crystal layer 19 are oriented in the direction perpendicular to the substrate plane. Thus, the opening-closing section 12 is also placed in the blocking state (the closed state).

On the other hand, in the vicinity of the boundary between the opening-closing sections 11 and 12, the voltage of the transparent electrode 110 and the voltage of the transparent electrode 120 are equal to each other, forming also in that boundary region the equipotential plane SCV substantially parallel to the substrate. Thereby, the major axes of the liquid crystal molecules M in the liquid crystal layer 19 are oriented in the direction perpendicular to the substrate plane, thus allowing the transmittance T of light to decrease in the boundary region as well.

### Comparative Example

Next, description is given on a function of the present embodiment in comparison to a comparative example. A stereoscopic display device 1R according to the comparative example has a configuration in which a barrier drive signal (a barrier drive signal DRVSR) for driving the opening-closing section 11 is an inversion of the barrier drive signal DRVS according to the present embodiment. In other words, the stereoscopic display device 1R includes a barrier driving section 60R that generates such barrier drive signal DRVSR. Other parts of the configuration in the stereoscopic display device 1R are the same as those according to the present embodiment illustrated in FIG. 1. In the following, the stereoscopic display device 1R according to the comparative example is described in detail.

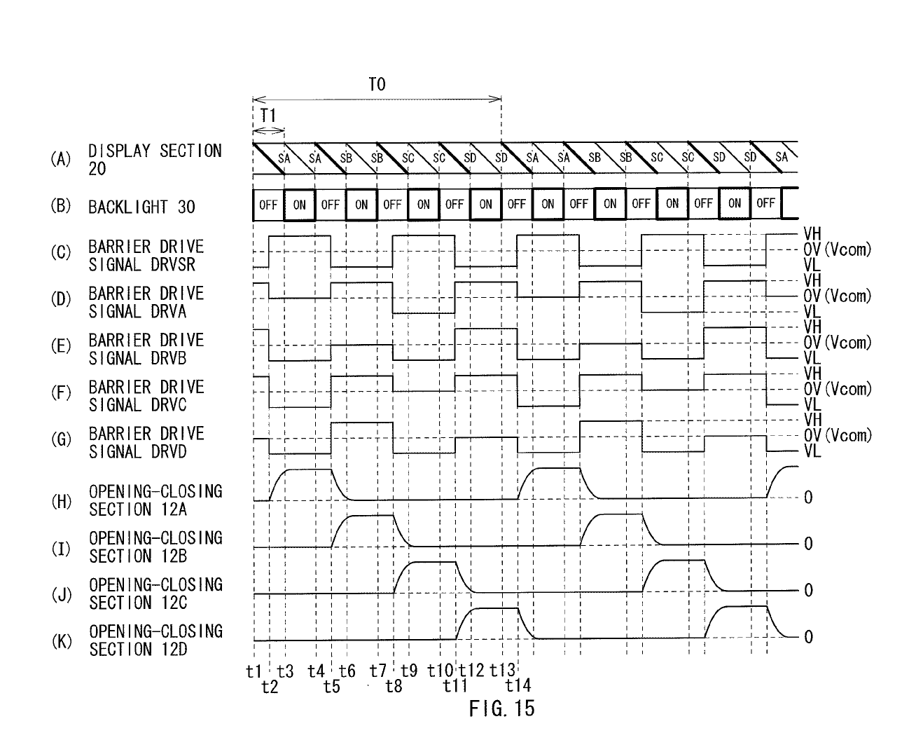

FIG. 15 is a timing chart illustrating operations of stereoscopic displaying in the stereoscopic display device 1R according to the comparative example, in which (A) illustrates an operation of the display section 20, (B) illustrates an operation of the backlight 30, (C) to (G) illustrate the waveforms of the respective barrier drive signals DRVSR and DRVA to DRVD, and (H) to (K) illustrate transmittance T of light for the respective opening-closing sections 12A to 12D. As illustrated in (C) of FIG. 15, the barrier drive signal DRVSR has a waveform which is the inversion of that of the barrier drive signal DRVS ((C) of FIG. 12) according to the present embodiment.

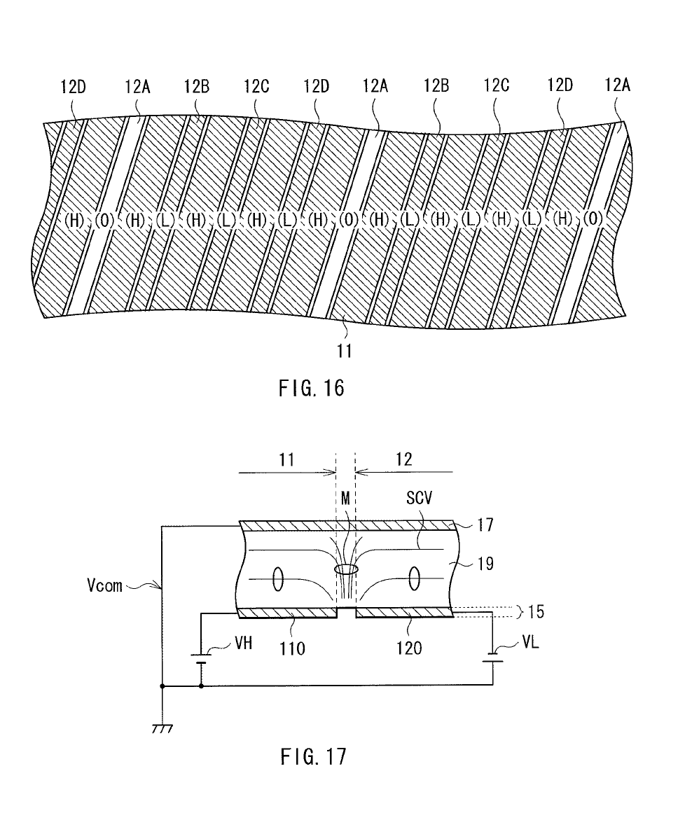

FIG. 16 illustrates voltages of the barrier drive signals DRVSR and DRVA to DRVD applied to the respective opening-closing sections 11 and 12 (12A to 12D). In the stereoscopic display device 1R, the barrier driving section 60R, in placing the mutually-adjacent opening-closing sections to be both in the closed state, applies different voltages to those respective opening-closing sections. For example, as illustrated in FIG. 16, the barrier driving section 60R applies the high level voltage VH to the opening-closing section 11, and applies the low level voltage VL to each of the opening-closing sections 12B to 12D.

Next, description is given on a behavior near the boundary between the opening-closing sections 11 and 12 in the stereoscopic display device 1R.

FIG. 17 schematically illustrates a behavior of liquid crystal molecules in the vicinity of the boundary between the opening-closing sections 11 and 12 in the stereoscopic display device 1R. In the comparative example illustrated in FIG. 17, a voltage of zero volts is applied to the common electrode (the transparent electrode layer 17), the high level voltage VH is applied the transparent electrode 110 in the opening-closing section 11, and the low level voltage VL is applied to the transparent electrode 120 in the opening-closing section 12. In other words, as illustrated in FIG. 17, the voltages VH and VL different from each other are applied to the mutually-adjacent opening-closing sections 11 and 12 that are to be placed in the closed state, respectively.

In the stereoscopic display device 1R, the liquid crystal molecules M in the liquid crystal layer 19 corresponding to the opening-closing sections 11 and 12 are so oriented that major axes thereof are oriented in the direction perpendicular to the substrate plane as with the stereoscopic display device 1 according to the present embodiment, whereby the opening-closing section 11 are placed in the blocking state (the closed state). On the other hand, the voltage of the transparent electrode 110 and that of the transparent electrode 120 are different from each other in the vicinity of the boundary between the opening-closing sections 11 and 12, by which the equipotential plane SCV becomes substantially perpendicular to the substrate as illustrated in FIG. 17. This causes the liquid crystal molecules M in the liquid crystal layer 19 in that boundary region to be oriented in a direction parallel to the substrate plane. In other words, it is likely that the transmittance T of light increases in the boundary region.

A viewer may feel as if the image quality has deteriorated when the light leaks near the boundary of the mutually-adjacent opening-closing sections. For example, when the stereoscopic display device 1R displays an image as illustrated in FIG. 11 and a viewer sees that image from the front of a display screen of the stereoscopic display device 1R, the viewer sees the pixel information P4 with his/her left eye and sees the pixel information P5 with his/her right eye, through the opening-closing sections 12A that are in the open state. Under such circumstances, although the opening-closing sections 11 and 12B to 12D are in the closed state, regions near the boundaries between those opening-closing sections 11 and 12B to 12D may allow the light to transmit therethrough to a certain extent. Thus, it is likely that the viewer sees slightly the pieces of information other than the pixel information P4 and the pixel information P5. That is, the stereoscopic display device 1R may allow the viewer to see the perspective images different from those that are supposed to be seen by the viewer as well, which may cause the viewer to feel as if the image quality has deteriorated.

In this manner, the voltages different from each other are applied to the respective opening-closing sections in placing those mutually-adjacent opening-closing sections to be in the closed state in the stereoscopic display device 1R according to the comparative example, causing the possible leakage of light in the boundary region between those opening-closing sections. Hence, it is likely that the viewer may feel as if the deterioration has occurred in the image quality.

In contrast, in the stereoscopic display device 1 according to the present embodiment, the same voltages are applied to the opening-closing sections in placing those mutually-adjacent opening-closing sections into the closed state. This allows the equipotential plane SCV to be formed substantially parallel to a substrate also in the boundary region between those opening-closing sections, as compared with the comparative example described above, making it possible to lower the transmittance T of light in that boundary region. Hence, it is possible to reduce the decrease in the image quality.

### Effect

According to the present embodiment as described above, the same voltages are applied to the opening-closing sections in placing those mutually-adjacent opening-closing sections into the closed state, making it possible to suppress the decrease in the image quality.

### Modification 1-1

In the above-described embodiment, each of the opening-closing control signals CTLA to CTLD makes the transition at the same timing as the transition timing of the barrier drive signal DRV0 in performing the stereoscopic displaying, although it is not limited thereto. Alternatively, as in a modification described below in detail, each of the opening-closing control signals CTLA to CTLD may make the transition at the timing different from the transition timing of the barrier drive signal DRV0.

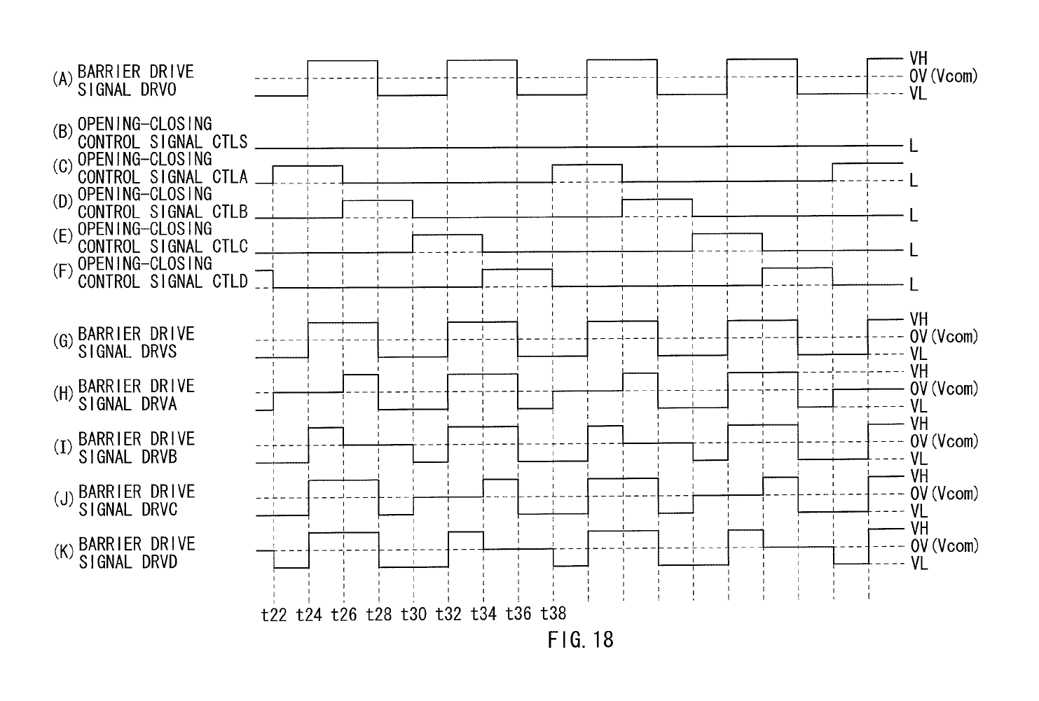

FIG. 18 illustrates an exemplary operation of a barrier driving section 60A in a stereoscopic display device 1A according to the present modification, in which (A) illustrates a waveform of the barrier drive signal DRV0, (B) to (F) illustrate waveforms of the respective opening-closing control signals CTLS and CTLA to CTLD, and (G) to (K) illustrate waveforms of the respective barrier drive signals DRVS and DRVA to DRVD. In the present modification, the opening-closing control signals CTLA to CTLD make the transition at the timing different from the transition timing of the barrier drive signal DRV0 ((A) to (F) of FIG. 18).

More specifically, in timing t22, the timing control section 61 first varies a level of the opening-closing control signal CTLA from the low level to the high level ((C) of FIG. 18), and the selector circuit 64A outputs the common signal Vcom for the barrier drive signal DRVA ((H) of FIG. 18). Also, each of the selector circuits 64S and 64B to 64D outputs the barrier drive signal DRV0 for the respective barrier drive signals DRVS and DRVB to DRVD, based on the respective opening-closing control signals CTLS and CTLB to CTLD that are at the low level ((G) and (I) to (K) of FIG. 18). Then, in timing t24, the barrier drive signal generating section 63 inverts the barrier drive signal DRV0 ((A) of FIG. 18). Thereby, the barrier drive signals DRVS and DRVB to DRVD are also inverted ((G) and (I) to (K) of FIG. 18).

Likewise, in a period from timing t26 to timing t30, the barrier driving section 60A outputs the common signal Vcom for the barrier drive signal DRVB, and outputs the barrier drive signal DRV0 for each of the barrier drive signals DRVS, DRVA, DRVC, and DRVD ((G) to (K) of FIG. 18). Then, in a period from the timing t30 to timing t34, the barrier driving section 60A outputs the common signal Vcom for the barrier drive signal DRVC, and outputs the barrier drive signal DRV0 for each of the barrier drive signals DRVS, DRVA, DRVB, and DRVD ((G) to (K) of FIG. 18). Then, in a period from the timing t34 to timing t38, the barrier driving section 60A outputs the common signal Vcom for the barrier drive signal DRVD, and outputs the barrier drive signal DRV0 for each of the barrier drive signals DRVS and DRVA to DRVD ((G) to (K) of FIG. 18).

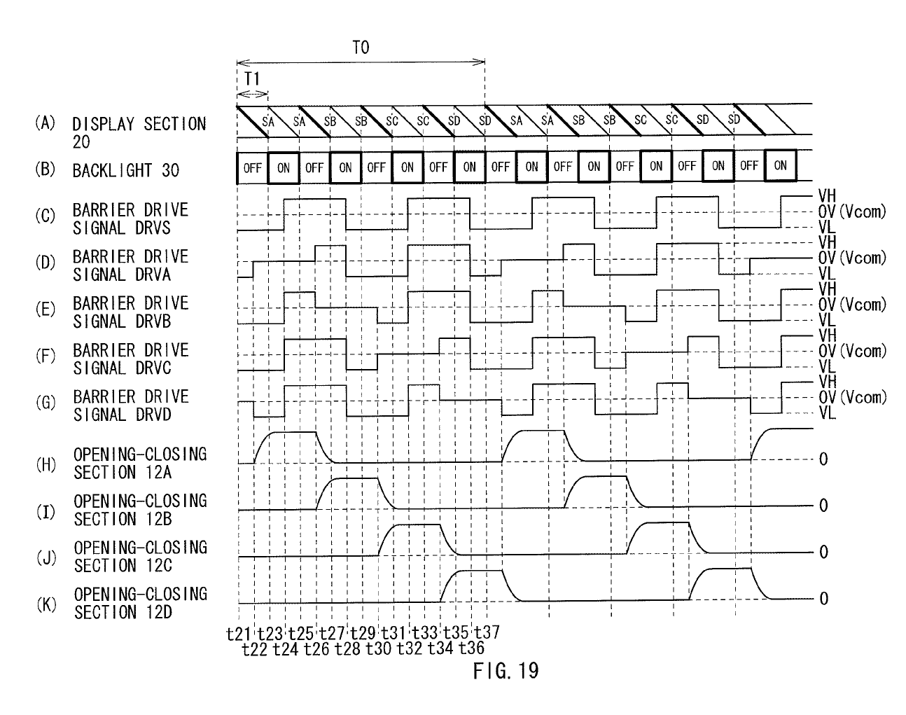

FIG. 19 is a timing chart illustrating operations of stereoscopic displaying in the stereoscopic display device 1A, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D. It is to be noted that timing t22 and so forth illustrated in FIG. 19 correspond to those illustrated in FIG. 18.

First, the stereoscopic display device 1A performs the displaying based on the image signal SA, in a period from timing t21 to timing t25. More specifically, in the display section 20 from the timing t21 to timing t23 first, the displaying based on the image signal SA is performed ((A) of FIG. 19), and the backlight 30 is turned off ((B) of FIG. 19). Then, in timing t22, the barrier driving section 60A varies the barrier drive signal DRVA to have zero volts (the common signal Vcom; (D) of FIG. 19). This causes the transmittance T of light in the opening-closing section 12A to increase in the liquid crystal barrier section 10 ((H) of FIG. 19). Then, in the display section 20 from the timing t23 to the timing t25, the displaying based on the image signal SA is performed again ((A) of FIG. 19), and the backlight 30 is turned on ((B) of FIG. 19). At this time, the barrier driving section 60A varies each of the barrier drive signals DRVS and DRVB to DRVD to have the high level voltage VH in the timing t24 ((C) and (E) to (G) of FIG. 19). Thereby, a viewer may see the displaying based on the image signal SA on the display section 20 from the timing t23 to the timing t25.

Likewise, the stereoscopic display device 1A performs the displaying based on the image signal SB in a period from the timing t25 to timing t29, performs the displaying based on the image signal SC in a period from the timing t29 to timing t33, and performs the displaying based on the image signal SD in a period from the timing t33 to timing t37.

### Modification 1-2

In the above-described embodiment, the pulse width of each of the opening-closing control signals CTLA to CTLD is the same as the period corresponding to a half-cycle of the barrier drive signal DRV0 in performing the stereoscopic displaying, although it is not limited thereto. Alternatively, a modification described in detail below may be employed.

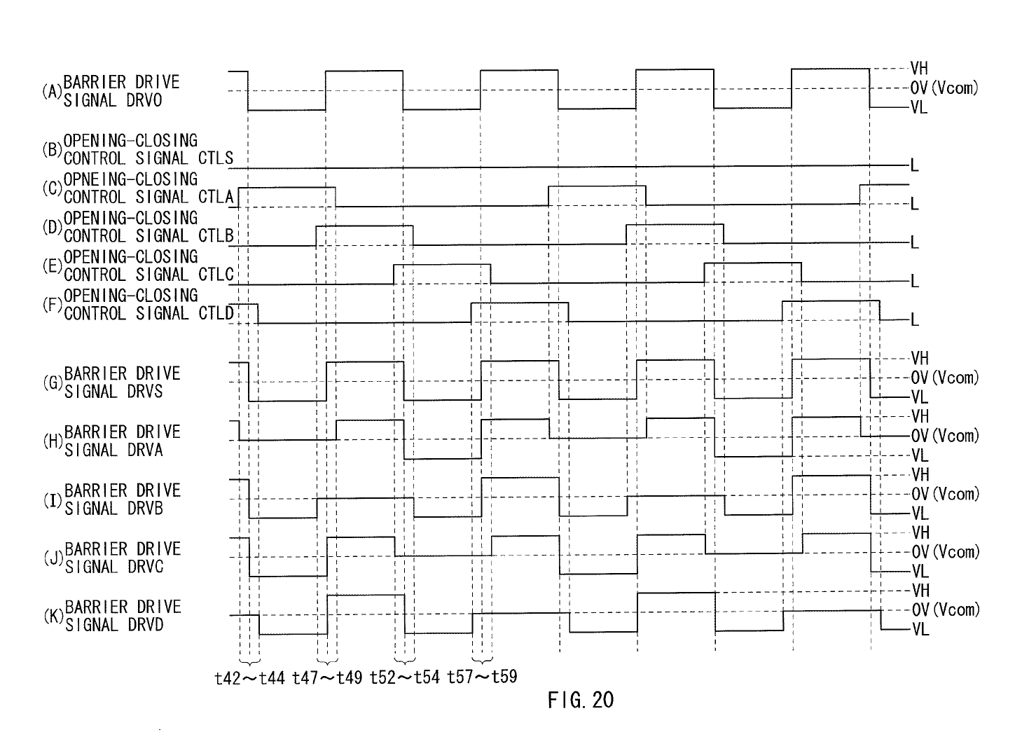

FIG. 20 illustrates an exemplary operation of a barrier driving section 60B in a stereoscopic display device 1B according to the present modification, in which (A) illustrates a waveform of the barrier drive signal DRV0, (B) to (F) illustrate waveforms of the respective opening-closing control signals CTLS and CTLA to CTLD, and (G) to (K) illustrate waveforms of the respective barrier drive signals DRVS and DRVA to DRVD. In the present modification, the pulse width of each of the opening-closing control signals CTLA to CTLD is longer than the period corresponding to a half-cycle of the barrier drive signal DRV0 ((A) to (F) of FIG. 20). For example, a pulse of each of the opening-closing control signals CTLA to CTLD starts before the timing of transition of the barrier drive signal DRV0, and ends after the subsequent timing of transition of the barrier drive signal DRV0. In other words, the barrier driving section 60B so generates the opening-closing control signals CTLA to CTLD as to allow the pulses thereof to overlap with each other.

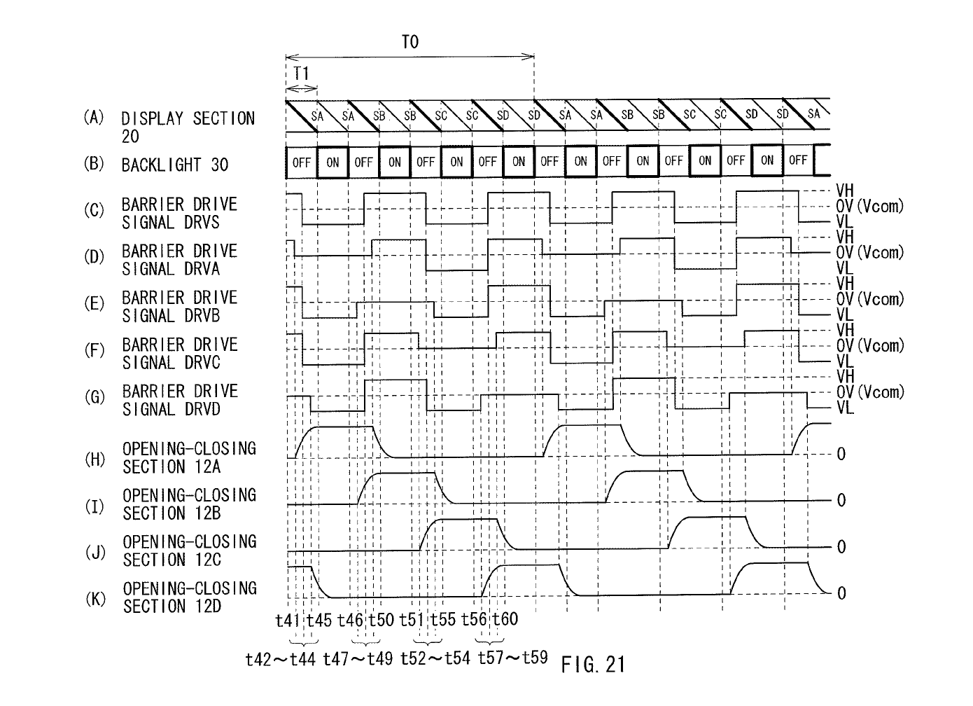

FIG. 21 is a timing chart illustrating operations of stereoscopic displaying in the stereoscopic display device 1B, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D. It is to be noted that timing t42 and so forth illustrated in FIG. 21 correspond to those illustrated in FIG. 20.

First, the stereoscopic display device 1B performs the displaying based on the image signal SA, in a period from timing t41 to timing t46. More specifically, in the display section 20 from the timing t41 to timing t45 first, the displaying based on the image signal SA is performed ((A) of FIG. 21), and the backlight 30 is turned off ((B) of FIG. 21). Then, in timing t42, the barrier driving section 60B varies the barrier drive signal DRVA to have zero volts (the common signal Vcom; (D) of FIG. 21). This causes the transmittance T of light in the opening-closing section 12A to increase in the liquid crystal barrier section 10 ((H) of FIG. 21). Then, in timing 43, the barrier driving section 60B varies each of the barrier drive signals DRVS, DRVB, and DRVC to have the low level voltage VL ((C), (E), and (F) of FIG. 21). Then, in timing 44, the barrier driving section 60B varies the barrier drive signal DRVD to have the low level voltage VL ((G) of FIG. 21). Then, in the display section 20 from the timing t45 to the timing t46, the displaying based on the image signal SA is performed again ((A) of FIG. 21), and the backlight 30 is turned on ((B) of FIG. 21). Thereby, a viewer may see the displaying based on the image signal SA on the display section 20 from the timing t45 to the timing t46.

Likewise, the stereoscopic display device 1B performs the displaying based on the image signal SB in a period from the timing t46 to timing t51, performs the displaying based on the image signal SC in a period from the timing t51 to timing t56, and performs the displaying based on the image signal SD in a period from the timing t56 to timing t61.

In the present modification, the pulse widths of the opening-closing control signals CTLA to CTLD are adjusted, making it possible to adjust timing at which each of the opening-closing sections 12A to 12D is open or closed, as well as to adjust a length of time during which each of the opening-closing sections 12A to 12D is in the open state.

### Modification 1-3

In the above-described embodiment, the opening-closing sections 12 are divided into four groups, although it is not limited thereto. In the following, a modification where the opening-closing sections 12 are divided into three groups (a stereoscopic display device 1C) and a modification where the opening-closing sections 12 are divided into two groups (a stereoscopic display device 1D) are described.

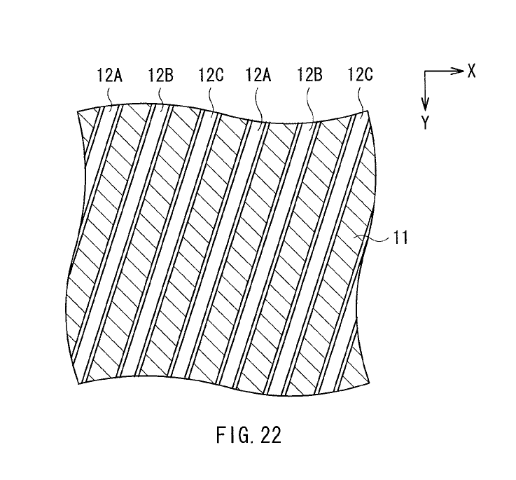

FIG. 22 illustrates an exemplary configuration of the groups configured by the opening-closing sections 12 in the stereoscopic display device 1C. In this example, the opening-closing sections 12A, 12B, and 12C are disposed in turn in this order.

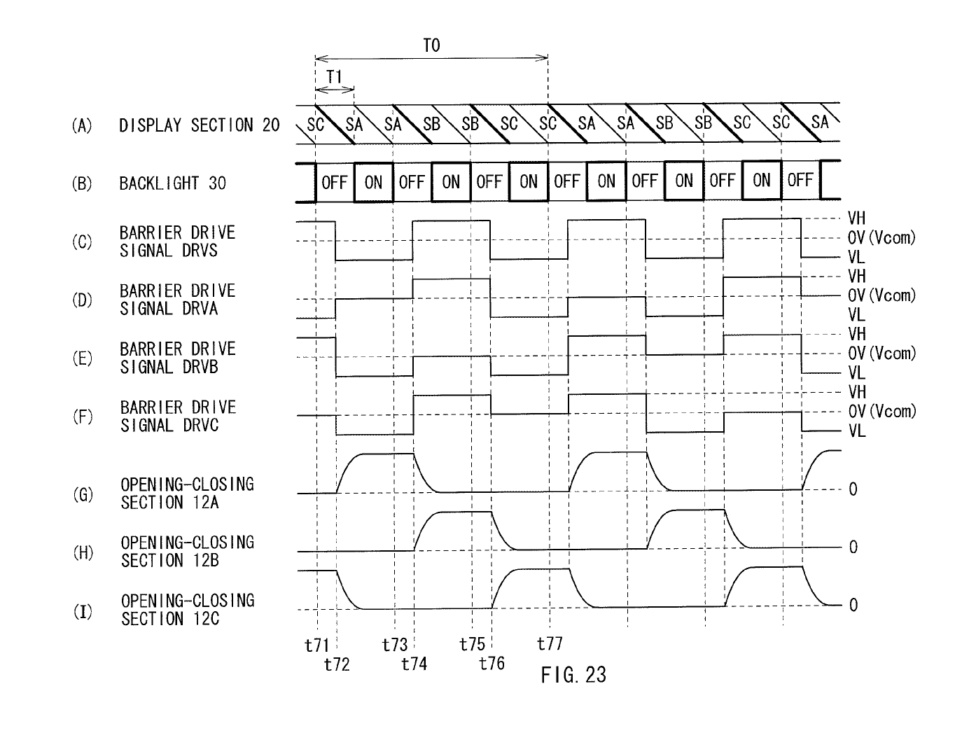

FIG. 23 is a timing chart illustrating operations of stereoscopic displaying in the stereoscopic display device 1C, in which (A) illustrates an operation of the display section 20, (B) illustrates an operation of the backlight 30, (C) to (F) illustrate the waveforms of the respective barrier drive signals DRVS and DRVA to DRVC, and (G) to (I) illustrate transmittance T of light for the respective opening-closing sections 12A to 12C. The stereoscopic display device 1C carries out the line-sequential scanning performed on the scanning cycle T1 basis, to carry out the displaying on each of the opening-closing sections 12A to 12C (the displaying operations based on the respective image signals SA to SC) sequentially and time-divisionally. The stereoscopic display device 1C repeats those displaying operations every displaying cycle T0. For example, the displaying cycle T0 may be 16.7 [msec] (= 1/60 [Hz]), and the scanning cycle T1 in this case may be 2.8 [msec] (=T0/6).

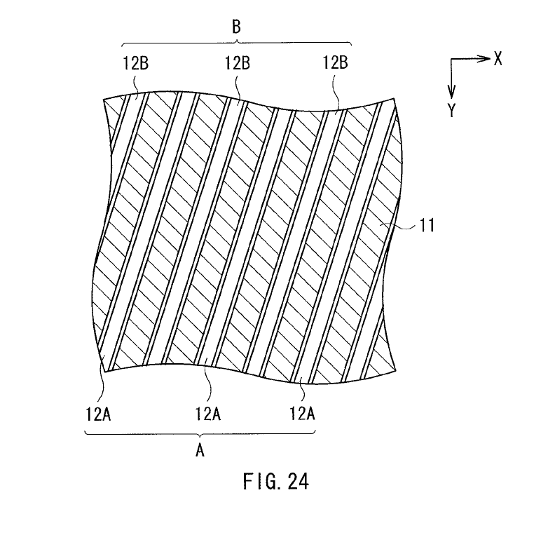

FIG. 24 illustrates an exemplary configuration of the groups configured by the opening-closing sections 12 in the stereoscopic display device 1D. In this example, the opening-closing sections 12A and 12B are disposed alternately.

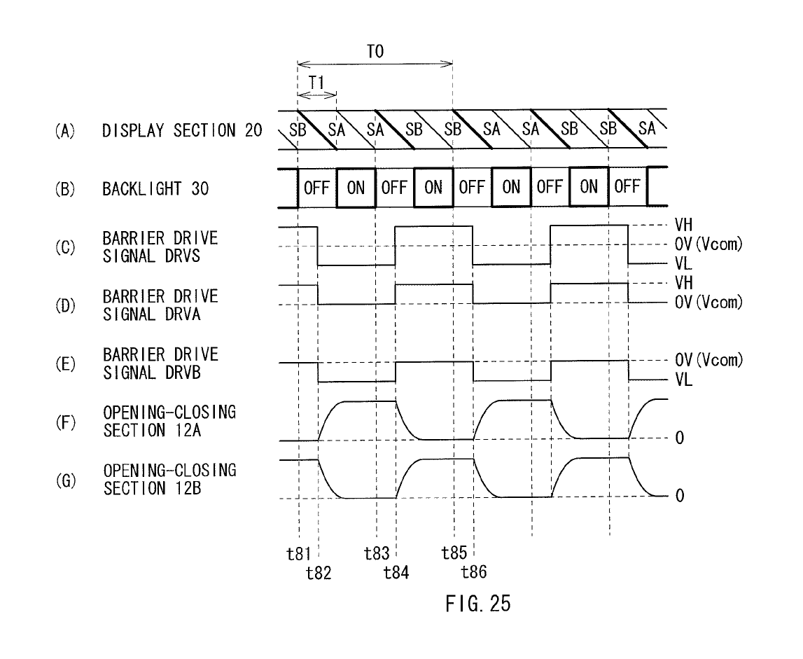

FIG. 25 is a timing chart illustrating operations of stereoscopic displaying in the stereoscopic display device 1D, in which (A) illustrates an operation of the display section 20, (B) illustrates an operation of the backlight 30, (C) to (E) illustrate the waveforms of the respective barrier drive signals DRVS, DRVA, and DRVB, and (F) and (G) illustrate transmittance T of light for the respective opening-closing sections 12A and 12B. The stereoscopic display device 1D carries out the line-sequential scanning performed on the scanning cycle T1 basis, to carry out the displaying on each of the opening-closing sections 12A and 12B (the displaying operations based on the respective image signals SA and SB) sequentially and time-divisionally. The stereoscopic display device 1D repeats those displaying operations every displaying cycle T0. For example, the displaying cycle T0 may be 16.7 [msec] (= 1/60 [Hz]), and the scanning cycle T1 in this case may be 4.2 [msec] (=T0/4).

### Modification 1-4

In the above-described embodiment, the barrier drive signal DRV0 (the barrier drive signal DRVS in performing the stereoscopic displaying) is a barrier drive signal with a rectangular waveform having a predetermined cycle, although it is not limited thereto. Alternatively, a modification described in detail below may be employed.

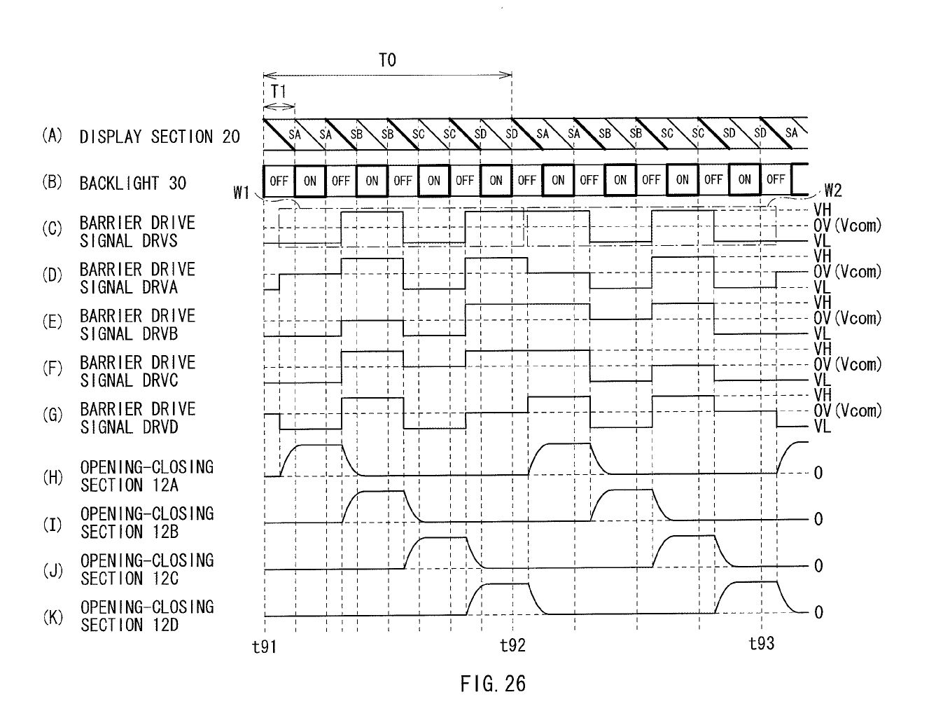

FIG. 26 is a timing chart of a stereoscopic display device 1E according to the present embodiment, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D.

Referring to (C) of FIG. 26, the barrier drive signal DRVS in the stereoscopic display device 1E according to the present modification has a configuration in which two waveform portions W1 and W2 are arranged alternately. Each of the waveform portions W1 and W2 is a rectangular waveform that makes transition from the high level voltage VH to the low level voltage VL and vice versa. The waveform portion W2 is an inversion of the waveform portion W1. As in the embodiment described above, the barrier drive signal DRVS is generated by the barrier drive signal generating section 63 as the barrier drive signal DRV0, i.e., the barrier drive signal DRV0 also has the two waveform portions W1 and W2 mentioned previously. In performing the stereoscopic displaying, the selector circuit 64S outputs the barrier drive signal DRV0 for the barrier drive signal DRVS. Also, the selector circuits 64A to 64D, respectively, generate the barrier drive signals DRVA to DRVD based on such barrier drive signal DRV0 and the common signal Vcom, and output the thus-generated barrier drive signals DRVA to DRVD, as in the above-described embodiment ((D) to (G) of FIG. 26).

The stereoscopic display device 1E according to the present modification performs the displaying on each of the opening-closing sections 12A to 12D (the displaying operations based on the respective image signals SA to SD) sequentially and time-divisionally. In performing the displaying, the stereoscopic display device 1E alternately performs time-divisional displaying based on the waveform portion W1 of the barrier drive signal DRVS (timing t91 to timing t92) and time-divisional displaying based on the waveform portion W2 of the barrier drive signal DRVS (timing t92 to timing t3).

The use of the barrier drive signal DRV0 in which two waveform portions W1 and W2 are arranged alternately as described makes it possible to reduce so-called “image persistence (image sticking)” in the liquid crystal layer 19. For example, the time during which the high level voltage VH is applied and the time during which the low level voltage VL is applied are equal to each other in the barrier drive signal DRVA applied to the opening-closing section 12A, in a period from timing t91 to timing t93 ((D) of FIG. 26). Thus, an average value of the potential difference between the voltage applied to the transparent electrode 120 and the voltage applied to the common electrode (the transparent electrode layer 17) in each of the opening-closing sections 11 and 12 (12A to 12D) becomes zero volts, making it possible to reduce the image persistence in the liquid crystal layer 19.

It is to be noted that, in the stereoscopic display device 1 according to the embodiment described above, the time during which the high level voltage VH is applied is longer than the time during which the low level voltage VL is applied in the barrier drive signal DRVA applied to the opening-closing section 12A ((D) of FIG. 12), for example, which may cause the image persistence in the liquid crystal layer 19. It is thus preferable, but not necessary, that the stereoscopic display device 1 be used in applications where the image persistence does not have major impact such as on image quality. Also, the time during which the high level voltage VH is applied and the time during which the low level voltage VL is applied become equal to each other as illustrated in FIG. 23, when the opening-closing sections 12 configure odd-number of groups of the opening-closing sections 12 as in the stereoscopic display device 1C according to the modification described above (three groups in the stereoscopic display device 1C), making it possible to reduce the image persistence in the liquid crystal layer 19.

### 2. Second Embodiment

A stereoscopic display device 2 according to a second embodiment will now be described. In the present embodiment, the barrier drive signals DRVS and DRVA to DRVD are generated based on the barrier drive signal DRV0 that has a longer cycle than that in the first embodiment described above. That is, the present embodiment has a configuration in which a barrier driving section 70 provided with a barrier drive signal generating section 73 that generates such barrier drive signal DRV0 is used. Other parts of the configuration in the stereoscopic display device 2 are the same as those according to the first embodiment described above (illustrated in FIG. 1 etc). Note that the same or equivalent elements as those of the stereoscopic display device 1 according to the first embodiment described above are denoted with the same reference numerals, and will not be described in detail.

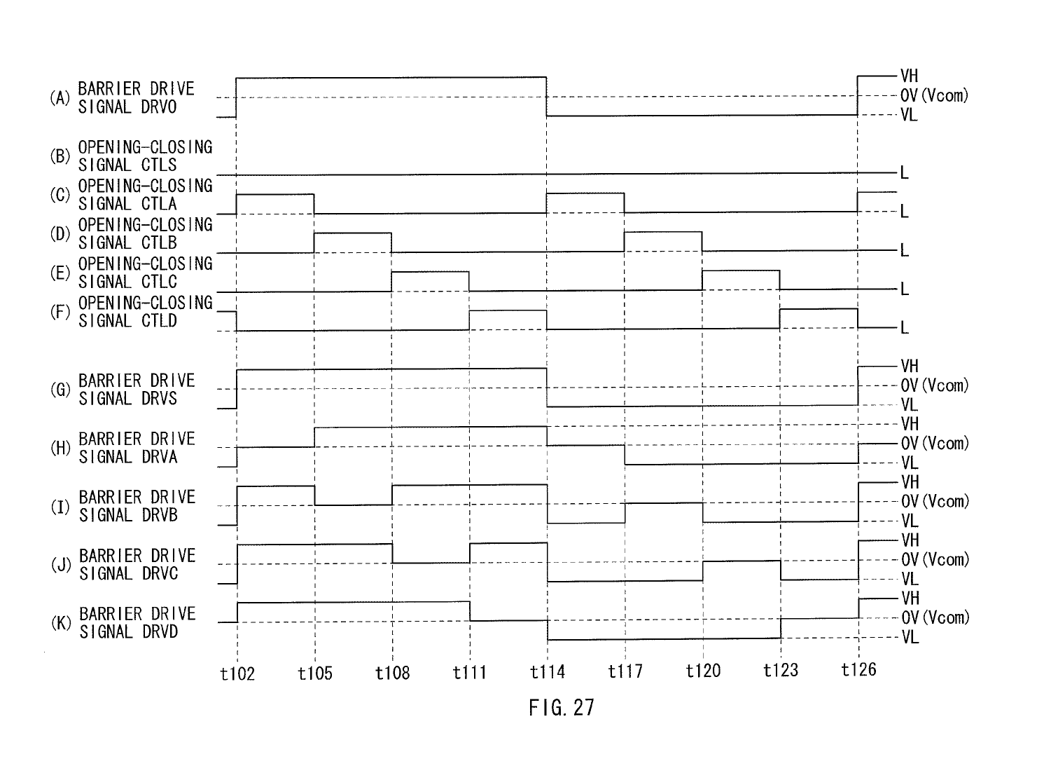

FIG. 27 illustrates an exemplary operation of the barrier driving section 70 in performing the stereoscopic displaying, in which (A) illustrates a waveform of the barrier drive signal DRV0, (B) to (F) illustrate waveforms of the respective opening-closing control signals CTLS and CTLA to CTLD, and (G) to (K) illustrate waveforms of the respective barrier drive signals DRVS and DRVA to DRVD.

The barrier drive signal generating section 73 of the barrier driving section 70 generates the barrier drive signal DRV0 ((A) of FIG. 27) that has the cycle longer than that of the barrier drive signal DRV0 generated by the barrier drive signal generating section 63 according to the above-described first embodiment ((A) of FIG. 9, for example). Further, the timing control section 61 outputs the pulses sequentially as the opening-closing control signals CTLA to CTLD, in a period corresponding to a half-cycle of the barrier drive signal DRV0.

More specifically, in timing t102, the barrier drive signal generating section 73 first inverts the barrier drive signal DRV0 ((A) of FIG. 27), and at the same time, the timing control section 61 varies the level of the opening-closing control signal CTLA from the low level to the high level ((C) of FIG. 27). Thereby, the selector circuit 64A outputs the common voltage Vcom for the barrier drive signal DRVA ((H) of FIG. 27), and each of the selector circuits 64S and 64B to 64D outputs the barrier drive signal DRV0 for the respective barrier drive signals DRVS and DRVB to DRVD ((G) and (I) to (K) of FIG. 27).

Then, the barrier driving section 70 generates the barrier drive signal DRVS and DRVA to DRVD while maintaining the voltage level of the barrier drive signal DRV0. More specifically, in a period from timing t105 to timing t108, the barrier driving section 70 outputs the common signal Vcom for the barrier drive signal DRVB, and outputs the barrier drive signal DRV0 for each of the barrier drive signal DRVS, DRVA, DRVC, and DRVD ((G) to (K) of FIG. 27). Then, in a period from the timing t108 to timing t111, the barrier driving section 70 outputs the common signal Vcom for the barrier drive signal DRVC, and outputs the barrier drive signal DRV0 for each of the barrier drive signal DRVS, DRVA, DRVB, and DRVD ((G) to (K) of FIG. 27). Then, in a period from the timing t111 to timing t114, the barrier driving section 70 outputs the common signal Vcom for the barrier drive signal DRVD, and outputs the barrier drive signal DRV0 for each of the barrier drive signal DRVS and DRVA to DRVC ((G) to (K) of FIG. 27).

Then, in the timing t114, the barrier drive signal generating section 73 inverts the barrier drive signal DRV0 ((A) of FIG. 27). Then, in a period from the timing t114 to timing t126, the barrier driving section 70 generates the barrier drive signal DRVS and DRVA to DRVD, in a similar manner to that in the period from the timing t102 to the timing 114. The barrier driving section 70 repeats the operations carried out in the period from the timing t102 to the timing t126.

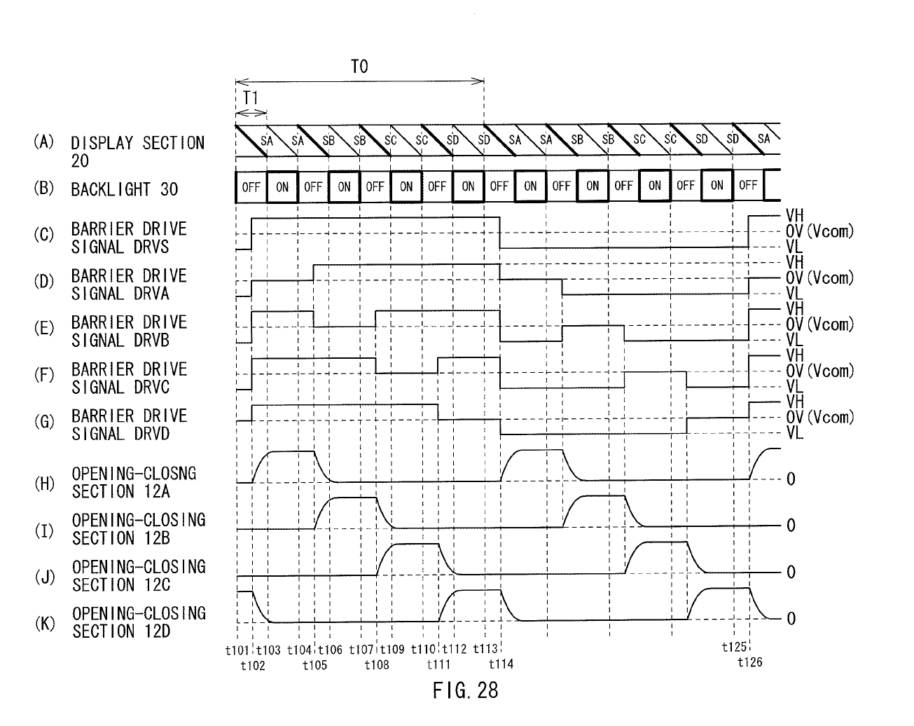

FIG. 28 is a timing chart illustrating operations of the stereoscopic displaying in the stereoscopic display device 2, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D. It is to be noted that timing t102 and so forth illustrated in FIG. 28 correspond to those illustrated in FIG. 27.

First, the stereoscopic display device 2 performs the displaying based on the image signal SA, in the period from the timing t101 to timing t104. More specifically, in the display section 20 from the timing t101 to timing t103 first, the displaying based on the image signal SA is performed ((A) of FIG. 28), and the backlight 30 is turned off ((B) of FIG. 28). Then, in the timing t102, the barrier driving section 70 varies the barrier drive signal DRVA to have zero volts (the common signal Vcom; (D) of FIG. 28), and varies the remaining other barrier drive signals DRVS and DRVB to DRVD to have the high level voltage VH ((C) and (E) to (G) of FIG. 28). This causes the transmittance T of light in the opening-closing section 12A to increase in the liquid crystal barrier section 10 ((H) of FIG. 28). Then, in the display section 20 from the timing t103 to the timing t104, the displaying based on the image signal SA is performed again ((A) of FIG. 28), and the backlight 30 is turned on ((B) of FIG. 28). Thereby, a viewer may see the displaying based on the image signal SA on the display section 20 from the timing t103 to the timing t104.

Then, in the period from the timing t104 to the timing 113, the stereoscopic display device 2 sequentially and time-divisionally performs the displaying operations based on the image signals SB to SD (the displaying in the opening-closing sections 12B to 12D), while maintaining the voltage level of the barrier drive signal DRV0.

Then, the barrier drive signal DRV0 inverts in the timing t114, and the stereoscopic display device 2, in the period from the timing t114 to the timing 125, sequentially and time-divisionally performs the displaying operations based on the image signals SA to SD (the displaying in the opening-closing sections 12A to 12D). The stereoscopic display device 2 repeats the operations carried out in the period from the timing t101 to the timing t125.

The use of the barrier drive signal DRV0 having the longer cycle to allow the display operations for the opening-closing sections 12A to 12D to be performed in each half-cycle period of the barrier drive signal DRV0 makes it possible to reduce so-called “image persistence” in the liquid crystal layer 19. For example, the time during which the high level voltage VH is applied and the time during which the low level voltage VL is applied are equal to each other in the barrier drive signal DRVA applied to the opening-closing section 12A in the period from the timing t102 to the timing t126 ((D) of FIG. 28). Thus, an average value of the potential difference between the voltage applied to the transparent electrode 120 and the voltage applied to the common electrode (the transparent electrode layer 17) in each of the opening-closing sections 11 and 12 (12A to 12D) becomes zero volts in the stereoscopic display device 2, making it possible to reduce the image persistence in the liquid crystal layer 19.

According to the second embodiment of the technology, the barrier drive signal DRV0 having the longer cycle is used to perform the display operations for the opening-closing sections 12A to 12D in each of the half-cycle periods of the barrier drive signal DRV0, making it possible to reduce the “image persistence” in the liquid crystal layer 19. Other effects achieved by the second embodiment are the same as those according to the first embodiment described above.

### Modification 2-1

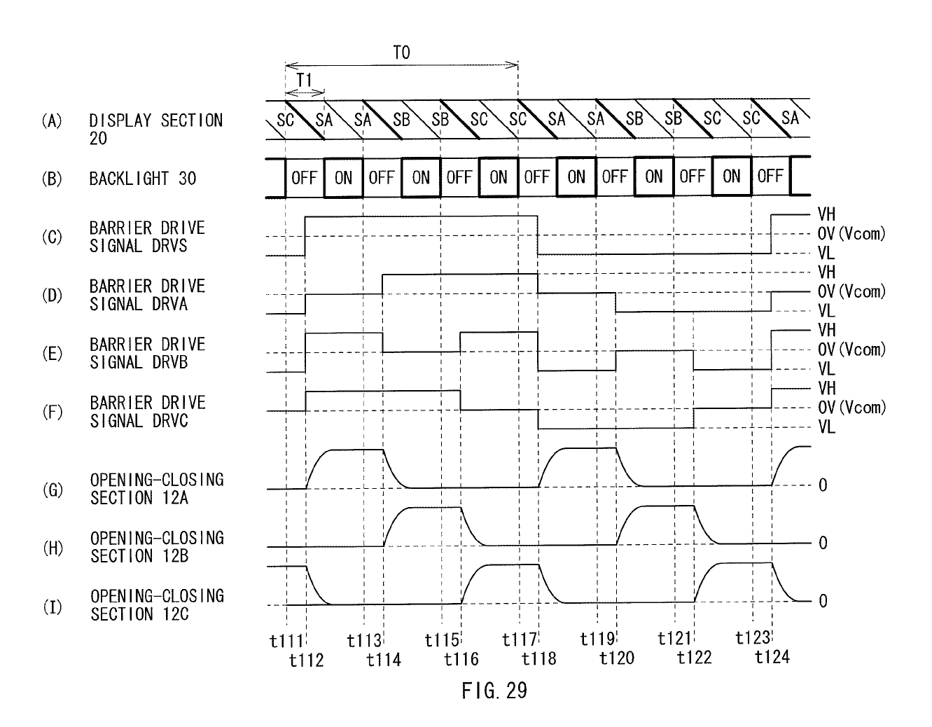

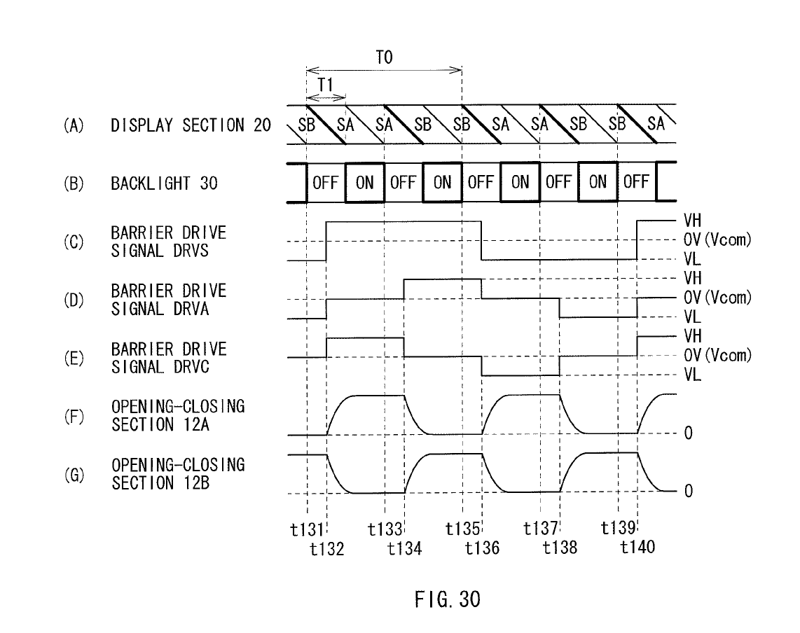

In the second embodiment, the opening-closing sections 12 are divided into four groups, although it is not limited thereto. Alternatively, the opening-closing sections 12 may be divided into three groups, or may be divided into two groups, as in the modification 1-3 according to the first embodiment described above. For example, the timing chart of operations for the stereoscopic displaying in one modification where the opening-closing sections 12 are divided into three groups and that of operations for the stereoscopic displaying in one modification where the opening-closing sections 12 are divided into two groups are illustrated in FIGS. 29 and 30, respectively.

### Other Modifications

For example, the modifications 1-1 and 1-2 according to the first embodiment are applicable to the second embodiment described above.

### 3. Third Embodiment

A stereoscopic display device 3 according to a third embodiment will now be described. The present embodiment uses a common signal VcomAC in the form of an AC (alternating current) signal. That is, the stereoscopic display device 3 according to the present embodiment has a configuration in which a barrier driving section 80 that generates such common signal VcomAC is used. Other parts of the configuration in the stereoscopic display device 3 are the same as those according to the first embodiment described above (illustrated in FIG. 1 etc). Note that the same or equivalent elements as those of the stereoscopic display device 1 according to the first embodiment described above are denoted with the same reference numerals, and will not be described in detail.

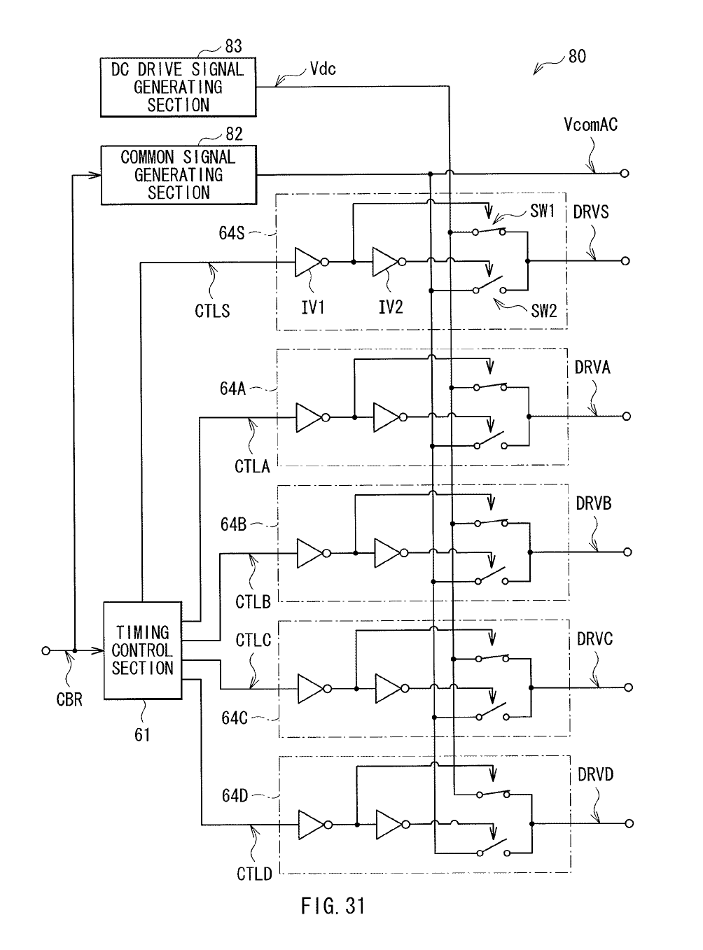

FIG. 31 illustrates an exemplary configuration of the barrier driving section 80. The barrier driving section 80 is provided with a DC (direct current) drive signal generating section 83 and a common signal generating section 82. The DC drive signal generating section 83 generates a DC drive signal Vdc which may be zero volts, for example. The common signal generating section 82 generates the common signal VcomAC in the form of the AC signal. The common signal VcomAC, more specifically, is a common signal with a rectangular waveform in which the DC drive signal Vdc is defined as a center level and transition is made from the high level voltage VH to the low level voltage VL and vice versa in a predetermined cycle. The common signal VcomAC is supplied to the common electrode (the transparent electrode layer 17) of the liquid crystal barrier section 10, as in the first and the second embodiments described above.

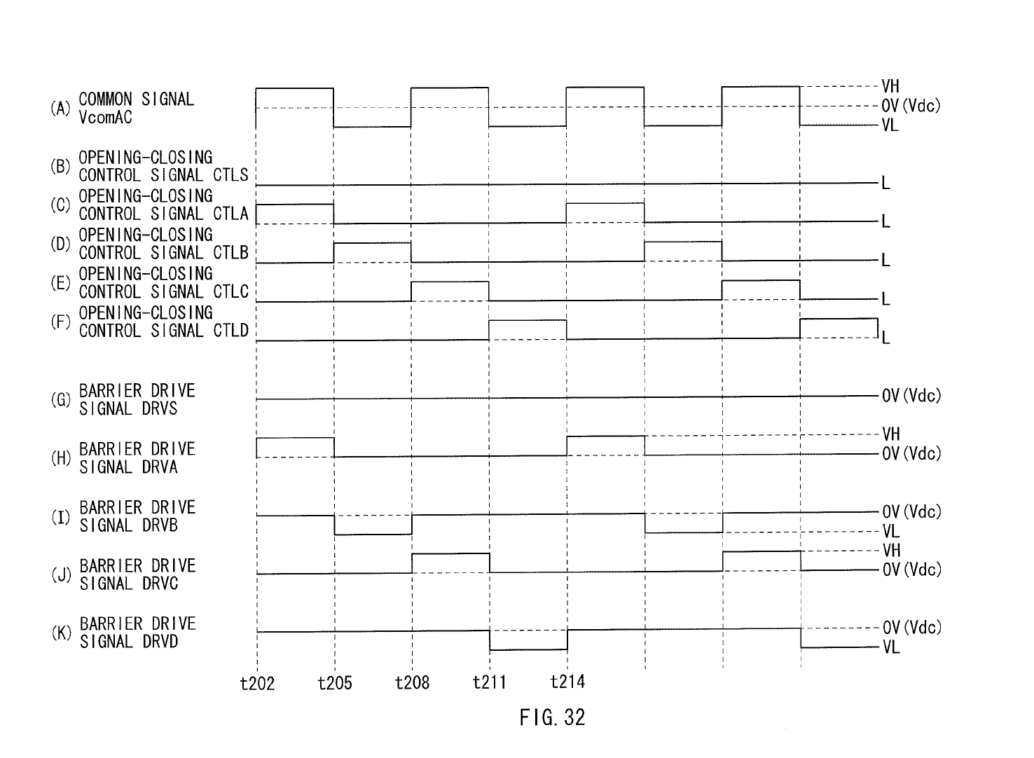

FIG. 32 illustrates an exemplary operation of the barrier driving section 80 in performing the stereoscopic displaying, in which (A) illustrates a waveform of the common signal VcomAC, (B) to (F) illustrate waveforms of the respective opening-closing control signals CTLS and CTLA to CTLD, and (G) to (K) illustrate waveforms of the respective barrier drive signals DRVS and DRVA to DRVD.

In the barrier driving section 80, the common signal generating section 82 first inverts the common signal VcomAC ((A) of FIG. 32) and the timing control section 61 varies the level of the opening-closing control signal CTLA from the low level to the high level ((C) of FIG. 32) in timing t202. Thereby, in the selector circuit 64A, the switch SW1 is turned off and the switch SW2 is turned on, allowing the common signal VcomAC to be outputted as the barrier drive signal DRVA ((H) of FIG. 32). On the other hand, in the selector circuits 64S and 64B to 64D, the opening-closing control signals CTLS and 64B to 64D are each at the low level. Thus, in each of the selector circuits 64S and 64B to 64D, the switch SW1 is turned on and the switch SW2 is turned off, allowing the DC drive signal Vdc to be outputted for each of the barrier drive signals DRVS and DRVB to DRVD ((G) and (I) to (K) of FIG. 32).

Likewise, in a period from timing t205 to timing t208, the barrier driving section 80 outputs the common signal VcomAC for the barrier drive signal DRVB, and outputs the DC drive signal Vdc for each of the barrier drive signals DRVS, DRVA, DRVC, and DRVD ((G) to (K) of FIG. 32). Then, in a period from the timing t208 to timing t211, the barrier driving section 80 outputs the common signal VcomAC for the barrier drive signal DRVC, and outputs the DC drive signal Vdc for each of the barrier drive signals DRVS, DRVA, DRVB, and DRVD ((G) to (K) of FIG. 32). Then, in a period from the timing t211 to timing t214, the barrier driving section 80 outputs the common signal VcomAC for the barrier drive signal DRVD, and outputs the DC drive signal Vdc for each of the barrier drive signals DRVS and DRVA to DRVC ((G) to (K) of FIG. 32).

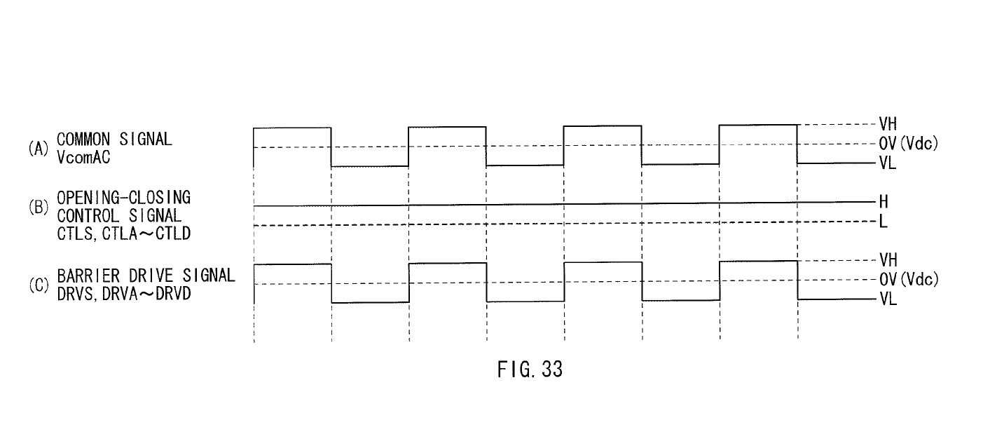

FIG. 33 illustrates an exemplary operation of the barrier driving section 80 in performing the normal displaying (the two-dimensional displaying), in which (A) illustrates a waveform of the common signal VcomAC, (B) illustrates a waveform of each of the opening-closing control signals CTLS and CTLA to CTLD, and (C) illustrates a waveform of each of the barrier drive signals DRVS and DRVA to DRVD. In the selector circuits 64S and 64A to 64D, the opening-closing control signals CTLS and CTLA to CTLD are each at the high level ((B) of FIG. 33). Thus, in each of the selector circuits 64S and 64A to 64D, the switch SW1 is turned off and the switch SW2 is turned on, allowing the common signal VcomAC to be outputted for each of the barrier drive signals DRVS and DRVA to DRVD ((C) of FIG. 33).

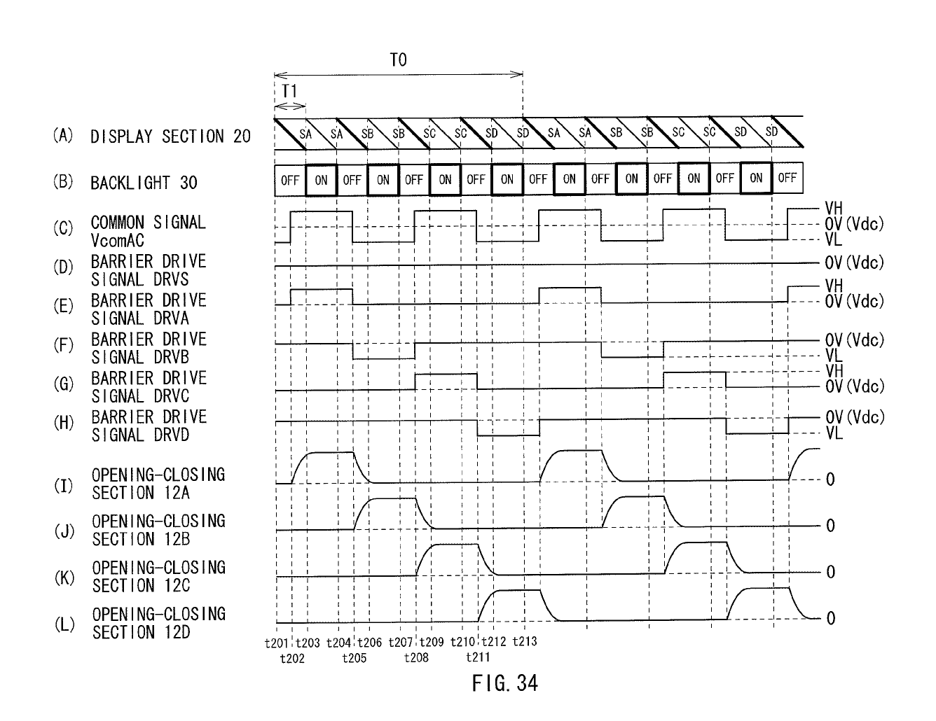

FIG. 34 is a timing chart illustrating operations of the stereoscopic displaying in the stereoscopic display device 3, in which (A) illustrates an operation of the display section 20, (B) illustrates an operation of the backlight 30, (C) illustrates the waveform of the common signal VcomAC, (D) to (H) illustrate the waveforms of the respective barrier drive signals DRVS and DRVA to DRVD, and (I) to (L) illustrate the transmittance T of light for the respective opening-closing sections 12A to 12D. It is to be noted that timing t202 and so forth illustrated in FIG. 34 correspond to those illustrated in FIG. 32.

First, the stereoscopic display device 3 performs the displaying based on the image signal SA, in the period from timing t201 to timing t204. More specifically, in the display section 20 from the timing t201 to timing t203, the displaying based on the image signal SA is performed first ((A) of FIG. 34). Then, in timing t202, the barrier driving section 80 inverts the common signal VcomAC ((C) of FIG. 34), and varies the barrier drive signal DRVA to have the high level voltage VH ((E) of FIG. 34). This causes the transmittance T of light in the opening-closing section 12A to increase in the liquid crystal barrier section 10 ((I) of FIG. 34). Then, in the display section 20 from the timing t203 to the timing t204, the displaying based on the image signal SA is performed again ((A) of FIG. 34), and the backlight 30 is turned on ((B) of FIG. 34). Thereby, a viewer may see the displaying based on the image signal SA on the display section 20 from the timing t203 to the timing t204.

Likewise, the stereoscopic display device 3 performs the displaying based on the image signal SB in a period from the timing t204 to timing t207, performs the displaying based on the image signal SC in a period from the timing t207 to timing t210, and performs the displaying based on the image signal SD in a period from the timing t210 to timing t213.

The stereoscopic display device 3 applies the same voltage (the DC drive voltage Vdc) to each of the opening-closing sections in placing those mutually-adjacent opening-closing sections into the closed state, as in the stereoscopic display device 1 according to the first embodiment described above. In other words, the potential difference between the voltage applied to the transparent electrodes 110 and 120 and the voltage applied to the common electrode (the transparent electrode layer 17) becomes equal between those opening-closing sections, making it possible to lower the transmittance T of light in the boundary region between those mutually-adjacent opening-closing sections. Hence, it is possible to reduce the decrease in the image quality as in the above-described first embodiment.

According to the third embodiment as described above, the use of the common signal VcomAC in the form of the AC signal also makes it possible reduce the decrease in the image quality. Other effects achieved by the third embodiment are the same as those according to the first embodiment described above.

### Modification 3-1

In the third embodiment of the technology, a cycle of the common signal VcomAC may be made longer, as in the stereoscopic display device 2 according to the second embodiment described above where the barrier drive signal DRV0 having the longer cycle is used.

### Other Modifications

For example, any one of a combination of the modifications 1-1 to 1-4 according to the first embodiment is applicable to the third embodiment described above.

### 4. Fourth Embodiment

A stereoscopic display device 4 according to a fourth embodiment will now be described. The present embodiment uses only the opening-closing sections 12 to configure the liquid crystal barrier section, without using the opening-closing sections 11. That is, the stereoscopic display device 4 according to the present embodiment has a configuration in which such liquid crystal barrier section 100 and a barrier driving section 90 are used. The barrier driving section 90 supplies the liquid crystal barrier section 100 with the barrier drive signals DRVA to DRVD and the common signal Vcom. Also, for the purpose of convenience, the description on the present embodiment is given on the premise that the image signal S is configured by the image signals SA to SD in performing the stereoscopic displaying by the stereoscopic display device 4, where each of the image signals SA to SD includes four perspective images. Other parts of the configuration in the stereoscopic display device 4 are the same as those according to the first embodiment described above (illustrated in FIG. 1 etc). Note that the same or equivalent elements as those of the stereoscopic display device 1 according to the first embodiment described above are denoted with the same reference numerals, and will not be described in detail.

FIG. 35 illustrates an exemplary configuration of the liquid crystal barrier section 100. The liquid crystal barrier section 100 has the opening-closing sections 12. In other words, although the liquid crystal barrier section 10 according to each of the embodiments and the modifications described above has the opening-closing sections 11 and 12, such opening-closing sections 11 are eliminated in the fourth embodiment. In the fourth embodiment, the opening-closing sections 12A, 12B, 12C, and 12D are disposed in turn in this order.

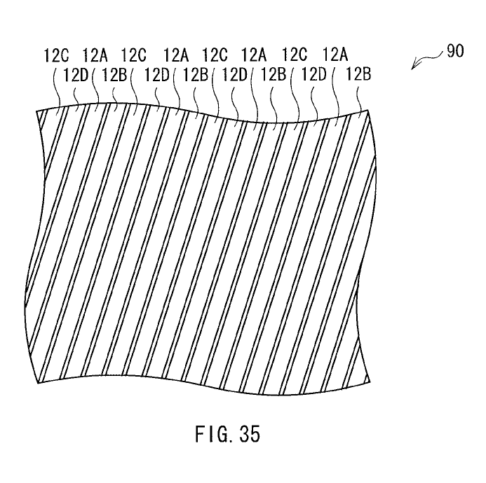

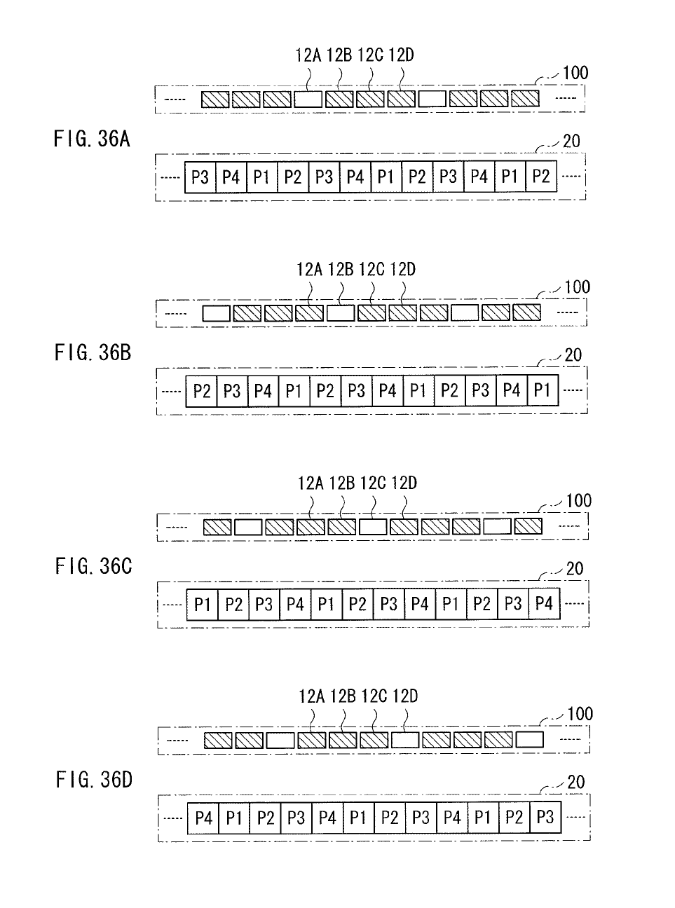

FIG. 36A to FIG. 36D schematically illustrate, using a cross-sectional configuration of the liquid crystal barrier section 100, an exemplary operation of the liquid crystal barrier section 100 and the display section 20. FIGS. 36A to 36D illustrate four states in performing the stereoscopic displaying. In this embodiment, one opening-closing section 12A is provided for every four pixels Pix of the display section 20. Likewise, one opening-closing section 12B, one opening-closing section 12C, and one opening-closing section 12D are provided for every four pixels Pix of the display section 20.

Upon the stereoscopic displaying in the stereoscopic display device 4, the image signals SA to SD are supplied in a time-divisional fashion to the display driving section 50, and the display section 20 performs a displaying operation based on those image signals SA to SD. The liquid crystal barrier section 100 causes the opening-closing sections 12 (the opening-closing sections 12A to 12D) to perform the open and close operations in a time-divisional fashion in synchronization with the displaying performed by the display section 20. In more detail, when the image signal SA is supplied to the display driving section 50, the opening-closing section 12A enters the open state and the remaining other opening-closing sections 12 enter the closed state, as illustrated in FIG. 36A. Whereas in the display section 20, four pixels Pix, which are disposed adjacent to one another at a position corresponding to that opening-closing section 12A, perform displaying corresponding to four perspective images included in the image signal SA (pieces of pixel information P1 to P4). Likewise, when the image signal SB is supplied to the display driving section 50, the opening-closing section 12B enters the open state and the remaining other opening-closing sections 12 enter the closed state, whereas in the display section 20, four pixels Pix, which are disposed adjacent to one another at a position corresponding to that opening-closing section 12B, perform displaying corresponding to four perspective images included in the image signal SB, as illustrated in FIG. 36B. When the image signal SC is supplied to the display driving section 50, the opening-closing section 12C enters the open state and the remaining other opening-closing sections 12 enter the closed state, whereas in the display section 20, four pixels Pix, which are disposed adjacent to one another at a position corresponding to that opening-closing section 12C, perform displaying corresponding to four perspective images included in the image signal SC, as illustrated in FIG. 36C. Further, when the image signal SD is supplied to the display driving section 50, the opening-closing section 12D enters the open state and the remaining other opening-closing sections 12 enter the closed state, whereas in the display section 20, four pixels Pix, which are disposed adjacent to one another at a position corresponding to that opening-closing section 12D, perform displaying corresponding to four perspective images included in the image signal SD, as illustrated in FIG. 36D.

On the other hand, in performing the normal displaying (the two-dimensional displaying), the liquid crystal barrier section 100 causes all the opening-closing section 12 (the opening-closing sections 12A to 12D) to maintain the open state (the transmission state).

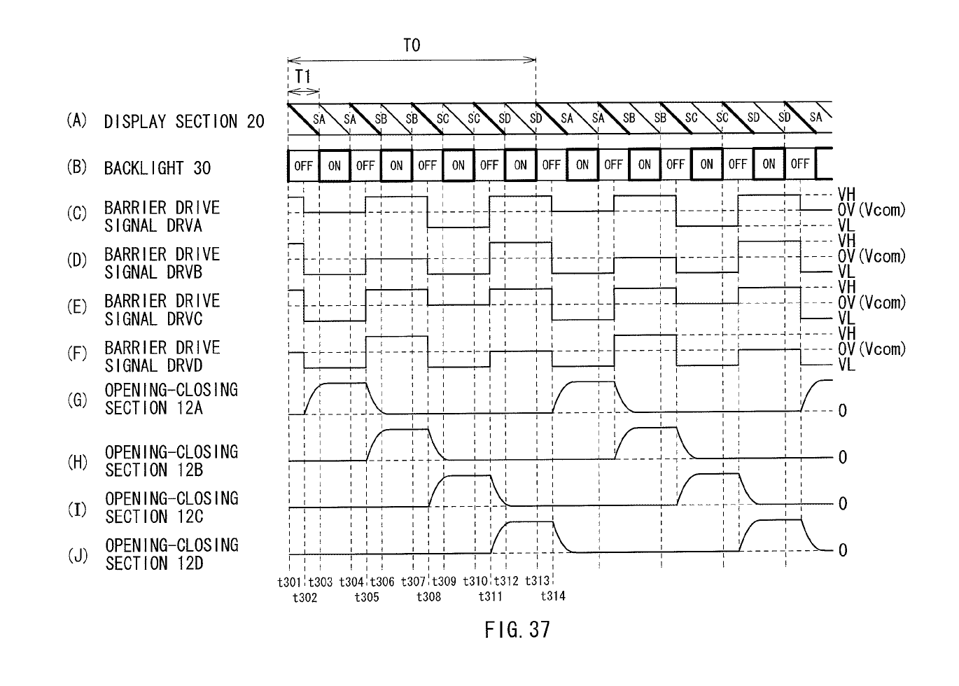

FIG. 37 is a timing chart illustrating operations of the stereoscopic displaying in the stereoscopic display device 4, in which (A) illustrates an operation of the display section 20, (B) illustrates an operation of the backlight 30, (C) to (F) illustrate the waveforms of the respective barrier drive signals DRVA to DRVD, and (G) to (J) illustrate transmittance T of light for the respective opening-closing sections 12A to 12D. FIG. 37 is the same as the timing chart (FIG. 12) of the stereoscopic display device 1 according to the first embodiment described above, except that the waveform for the barrier drive signal DRVS is removed from FIG. 12. In other words, the opening-closing sections 12A to 12D in the stereoscopic display device 4 operate exactly the same way as the opening-closing sections 12A to 12D in the stereoscopic display device 1 according to the first embodiment, respectively.

Thus, the fourth embodiment makes it possible to reduce the decrease in the image quality even with the configuration where the opening-closing sections 11 are eliminated. Other effects achieved by the fourth embodiment are the same as those according to the first embodiment described above.

### Modification 4-1

In the fourth embodiment described above, the liquid crystal barrier section 100 is applied to the stereoscopic display device 1 according to the first embodiment, although it is not limited thereto. Alternatively, the liquid crystal barrier section 100 may be applied to the stereoscopic display devices 2 and 3 according to the second and the third embodiments, respectively, and may be applied to each of the modifications according to the first to the third embodiments.

### 5. Fifth Embodiment

A stereoscopic display device 5 according to a fifth embodiment will now be described. In the present embodiment, amplitude of the barrier drive signal DRVS, supplied to the opening-closing sections 11 that are constantly placed into the blocking state (the closed state) in performing the stereoscopic displaying on the basis of the first embodiment described above, is set larger than amplitude of each of the barrier drive signals DRVA to DRVD that are placed in a time-divisional fashion into the transmission state (the open state). That is, the stereoscopic display device 5 according to the present embodiment has a configuration in which a barrier driving section 130 that generates such barrier drive signals DRVS and DRVA to DRVD is used. Other parts of the configuration in the stereoscopic display device 5 are the same as those according to the first embodiment described above (illustrated in FIG. 1 etc). Note that the same or equivalent elements as those of the stereoscopic display device 1 according to the first embodiment described above are denoted with the same reference numerals, and will not be described in detail.

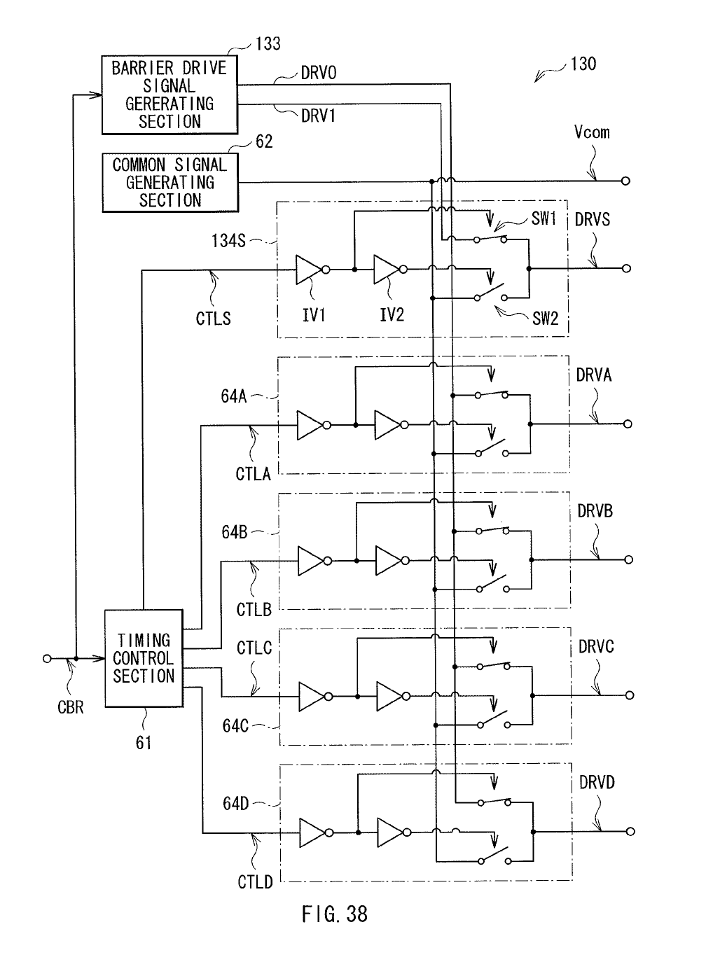

FIG. 38 illustrates an exemplary configuration of the barrier driving section 130. The barrier driving section 130 is provided with a barrier drive signal generating section 133 and a selector circuit 134S. The barrier drive signal generating section 133 has a function of generating a barrier drive signal DRV1 in addition to the barrier drive signal DRV0, based on the barrier control signal CBR. The barrier drive signal DRV1 has a waveform with a shape similar to that of the waveform of the barrier drive signal DRV0, and has amplitude larger than that of the barrier drive signal DRV0. More specifically, the barrier drive signal DRV1 makes transition from a high level voltage VH1 to a low level voltage VL1 and vice versa in a predetermined cycle, in which the common signal Vcom is defined as a center level. The high level voltage VH1 is higher than the high level voltage VH of the barrier drive signal DRV0, and the low level voltage VL1 is lower than the low level voltage VL of the barrier drive signal DRV0. The selector circuit 134S generates the barrier drive signal DRVS based on the opening-closing control signal CTLS. In the selector circuit 134S, the switch SW1 has a first end to which the barrier drive signal DRV1 is supplied, and a second end connected to an output terminal of the selector circuit 134S. With this configuration, in the selector circuit 134S, the switch SW1 is turned on and the switch SW2 is turned off, and the barrier drive signal DRV1 is outputted as the barrier drive signal DRVS, when the opening-closing control signal CTLS is at the low level, for example.

FIG. 39 illustrates an exemplary operation of the barrier driving section 130 in performing the stereoscopic displaying, in which (A) illustrates waveforms of the respective barrier drive signals DRV0 and DRV1, (B) to (F) illustrate waveforms of the respective opening-closing control signals CTLS and CTLA to CTLD, and (G) to (K) illustrate waveforms of the respective barrier drive signals DRVS and DRVA to DRVD. It is to be noted that timing t2 and so forth illustrated in FIG. 39 correspond to those illustrated in FIGS. 9 and 12, etc.

Referring to (A) of FIG. 39, the barrier drive signal generating section 133 generates, in addition to the barrier drive signal DRV0, the barrier drive signal DRV1 whose amplitude is larger than that of the barrier drive signal DRV0. In the selector circuit 134S, the opening-closing control signal CTLS is at the low level, allowing the switch SW1 to be turned on and the switch SW2 to be turned off, whereby the barrier drive signal DRV1 is outputted as the barrier drive signal DRVS ((G) of FIG. 39).

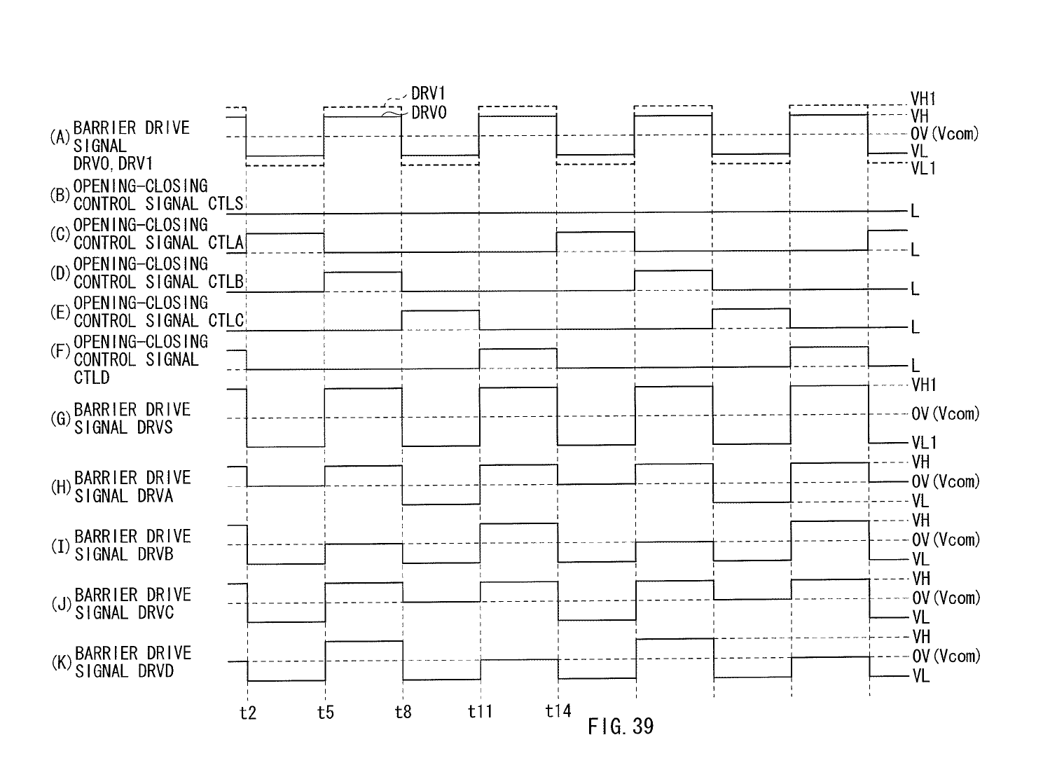

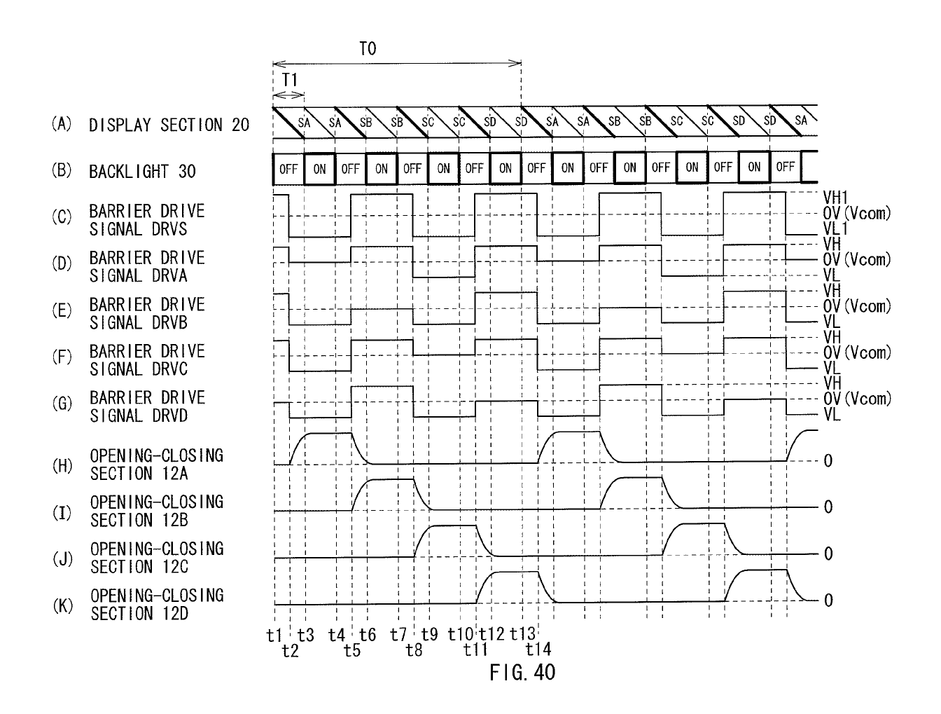

FIG. 40 is a timing chart illustrating operations of the stereoscopic displaying in the stereoscopic display device 5, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D. It is to be noted that timing t2 and so forth illustrated in FIG. 40 correspond to those illustrated in FIG. 39, etc.

First, the stereoscopic display device 5 performs the displaying based on the image signal SA, in a period from timing t1 to timing t4. More specifically, in the display section 20 from the timing t1 to timing t3, the displaying based on the image signal SA is performed first ((A) of FIG. 40). Then, in timing t2, the barrier driving section 130 varies the barrier drive signal DRVS to have the low level voltage VL1, varies the barrier drive signal DRVA to have zero volts (the common signal Vcom), and varies the remaining other barrier drive signals DRVB to DRVD to have the low level voltage VL ((C) to (G) of FIG. 40). This causes the transmittance T of light in the opening-closing section 12A to increase in the liquid crystal barrier section 10 ((H) of FIG. 40). Then, in the display section 20 from the timing t3 to the timing t4, the displaying based on the image signal SA is performed again ((A) of FIG. 40), and the backlight 30 is turned on ((B) of FIG. 40). Thereby, a viewer may see the displaying based on the image signal SA on the display section 20 from the timing t3 to the timing t4.

Likewise, the stereoscopic display device 5 performs the displaying based on the image signal SB in a period from the timing t4 to timing t7, performs the displaying based on the image signal SC in a period from the timing t7 to timing t10, and performs the displaying based on the image signal SD in a period from the timing t10 to timing t13.

Thus, the stereoscopic display device 5 supplies the opening-closing sections 11, that are placed into the blocking state (the closed state) constantly in performing the stereoscopic displaying, with the barrier drive signal DRV1 having the larger amplitude. This makes it possible to improve such as contrast of the displaying and a so-called crosstalk where the mutually-different perspective images are observed as being mixed together, as described below.

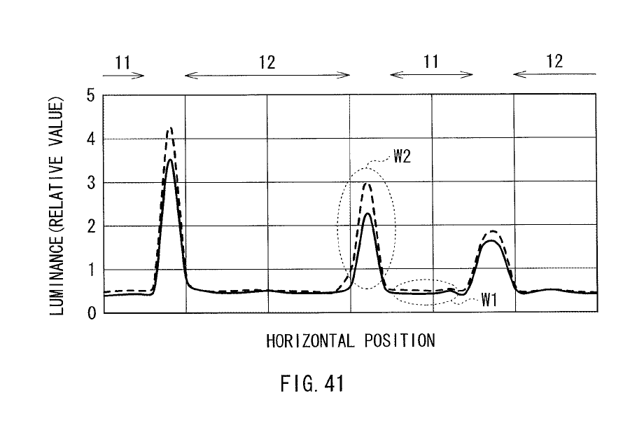

FIG. 41 illustrates an example of a luminance distribution on a display plane of each of the stereoscopic display devices 1 and 5, where the opening-closing sections 11 and 12 are both placed into the blocking state. FIG. 41 is a result of measurement of luminance in various positions (horizontal positions) along a horizontal direction of the display plane, with the conditions under which the display section 20 performs white displaying and all of the opening-closing sections 11 and 12 in the liquid crystal barrier section 10 are in the blocking state (the closed state). A solid line denotes an example luminance distribution of the stereoscopic display device 5 according to the fifth embodiment, and a dashed line denotes an example luminance distribution of the stereoscopic display device 1 according to the first embodiment. In one example illustrated in FIG. 41, a width E1 of the opening-closing section 11 is made smaller in width than a width E2 of the opening-closing section 12.

In the stereoscopic display device 5 according to the fifth embodiment, the barrier drive signal DRV1 with the larger amplitude is supplied in placing the opening-closing section 11 into the blocking state. This lowers the luminance in the opening-closing section 11 as compared with an example (denoted by the dashed line) of the stereoscopic display device 1 according to the first embodiment as illustrated in FIG. 41, allowing the light to be blocked further (denoted by a portion W1). In addition, this also lowers the luminance in the boundary region between the opening-closing sections 11 and 12 as compared with an example (denoted by the dashed line) of the stereoscopic display device 1, allowing the light to be blocked further (denoted by a portion W2).

Thus, referring to FIGS. 7A to 7D, the stereoscopic display device 5 reduces the possible leakage of light such as in the boundary region between the opening-closing sections 11 and 12 that are placed into the blocking state mutually, in time-divisionally switching the opening-closing sections 12A to 12D to open those opening-closing sections 12A to 12D so as to perform the displaying. Hence, it is possible to reduce the crosstalk, and to improve the image quality.

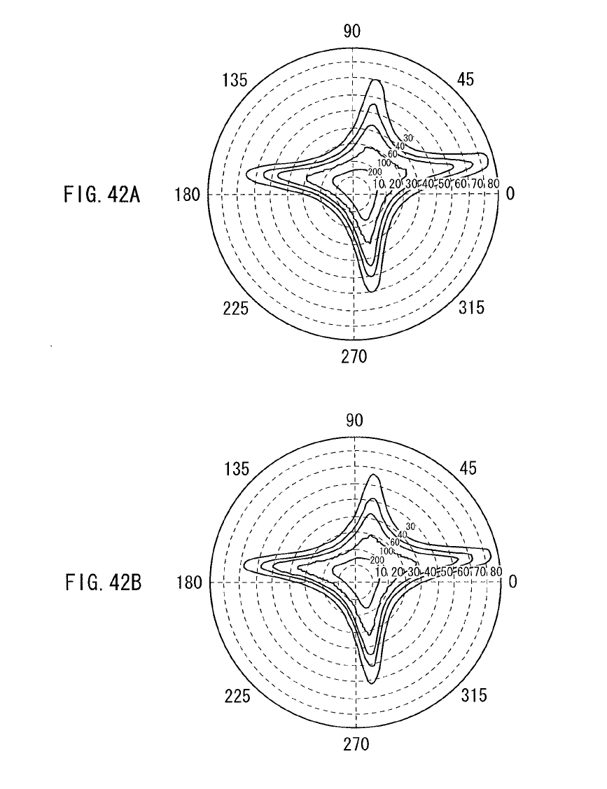

FIG. 42A illustrates a contrast of the stereoscopic display device 1, and FIG. 42B illustrates a contrast of the stereoscopic display device 5. FIGS. 42A and 42B each illustrate, as a viewing angle characteristic, a ratio (contrast) of a luminance when all of the opening-closing sections 11 and 12 in the liquid crystal barrier section 10 are placed in the transmission state (the open state) to a luminance when all of the opening-closing sections 11 and 12 are placed in the blocking state (the closed state). In other words, a lateral direction and a vertical direction in each of FIGS. 42A and 42B respectively correspond to the horizontal direction and a perpendicular direction of a display screen of each of the stereoscopic display devices 1 and 5. Also, in each of FIGS. 42A and 42B, a solid line is a contour line that indicates the contrast, representing that the contrast increases as approaching the center.

The stereoscopic display device 5 according to the present embodiment (illustrated in (B) of FIG. 42) makes it possible to enlarge, to a certain extent, a region indicative of a same contrast (such as a region in which the contrast is 100, for example) as compared with the stereoscopic display device 1 according to the first embodiment (illustrated in (A) of FIG. 42). In other words, the stereoscopic display device 5 is capable of lowering the luminance under circumstances where the opening-closing sections 11 and 12 are placed into the blocking state as illustrated in FIG. 41, making it possible to increase the contrast. Thus, in the stereoscopic display device 5, the contrast improves, making it possible to improve the image quality.

According to the fifth embodiment, the amplitude is made larger of the barrier drive signal DRVS supplied to the opening-closing sections 11 that are constantly placed into the blocking state in performing the stereoscopic displaying. Hence, it is possible to improve such as the crosstalk and contrast, and to improve the image quality. Other effects achieved by the fifth embodiment are the same as those according to the first embodiment described above.

### Modification 5-1

In the fifth embodiment described above, the amplitude of the barrier drive signal DRVS in the stereoscopic display device 1 according to the first embodiment is made larger, although it is not limited thereto. Alternatively, amplitude of the barrier drive signal DRVS according to each of the first and the second embodiments and the modifications thereof may be made larger, for example.

### 6. Sixth Embodiment

A stereoscopic display device 6 according to a sixth embodiment will now be described. In the present embodiment, amplitude of each of the barrier drive signals DRVS and DRVA to DRVD, supplied to the opening-closing sections 11 and 12 in performing the stereoscopic displaying on the basis of the first embodiment described above, is set larger. That is, the stereoscopic display device 6 according to the present embodiment has a configuration in which a barrier driving section 140 that generates such barrier drive signals DRVS and DRVA to DRVD is used. Other parts of the configuration in the stereoscopic display device 6 are the same as those according to the first embodiment described above (illustrated in FIG. 1 etc). Note that the same or equivalent elements as those of the stereoscopic display device 1 according to the first embodiment described above are denoted with the same reference numerals, and will not be described in detail.

Referring to FIG. 8, the barrier driving section 140 according to the present embodiment is provided with a barrier drive signal generating section 143. The barrier drive signal generating section 143 generates the barrier drive signal DRV0 whose amplitude is larger than that of the barrier drive signal DRV0 according to the above-described first embodiment, as will be described later in detail.

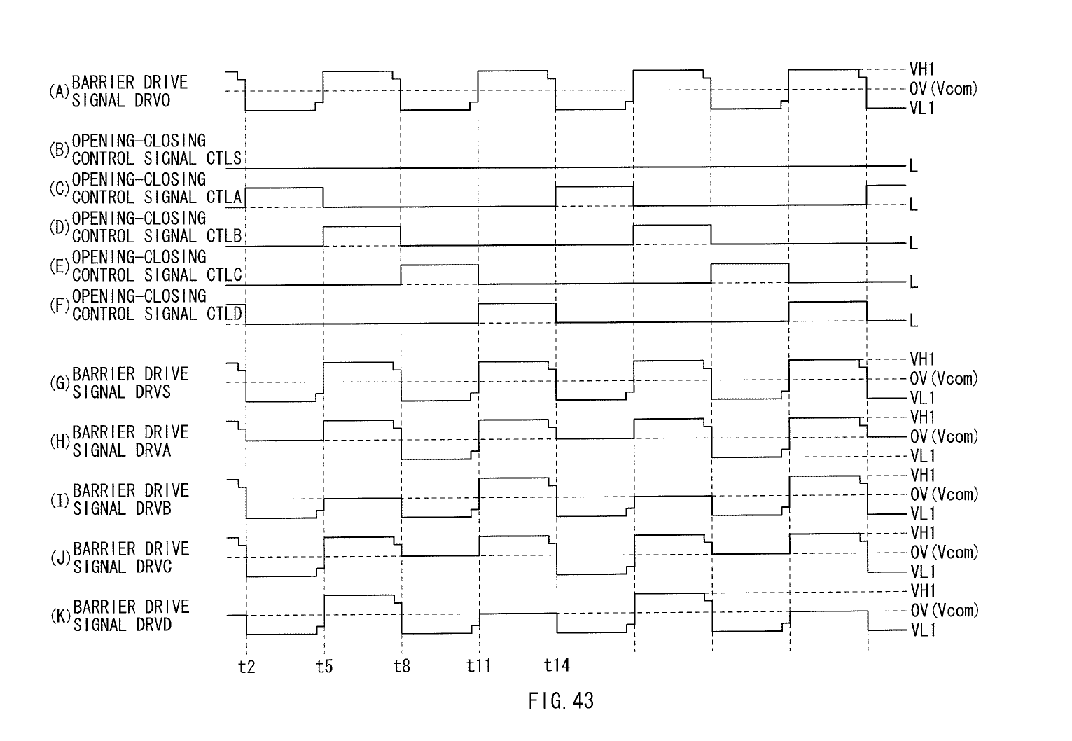

FIG. 43 illustrates an exemplary operation of the barrier driving section 140 in performing the stereoscopic displaying, in which (A) illustrates a waveform of the barrier drive signal DRV0, (B) to (F) illustrate waveforms of the respective opening-closing control signals CTLS and CTLA to CTLD, and (G) to (K) illustrate waveforms of the respective barrier drive signals DRVS and DRVA to DRVD. It is to be noted that timing t2 and so forth illustrated in FIG. 43 correspond to those illustrated in FIGS. 9 and 12, etc.

Referring to (A) of FIG. 43, the barrier drive signal DRV0 according to the present embodiment has the amplitude larger than that of the barrier drive signal DRV0 according to the first embodiment described above, and polarities thereof are reversed at a predetermined cycle ((A) of FIG. 43). In reversing the polarities, the amplitude of the barrier drive signal DRV0 decreases immediately before the reversal of the polarities thereof. For example, when the polarities of the barrier drive signal DRV0 are reversed from the high level voltage VH1 to the low level voltage VL1 (for example, at the timing t8), the voltage level of the barrier drive signal DRV0 decreases by one step from the high level voltage VH1, immediately before the timing at which the polarities are reversed. Similarly, when the polarities of the barrier drive signal DRV0 are reversed from the low level voltage VL1 to the high level voltage VH1 (for example, at the timing t11), the voltage level of the barrier drive signal DRV0 increases by one step from the low level voltage VL1, immediately before the timing at which the polarities are reversed. In this manner, the voltage level of the barrier drive signal DRV0 makes transition in two steps when the polarities thereof reverse.

In the barrier driving section 140, the selector circuits 64S and 64A to 64D each select, based on the respective opening-closing control signals CTLS and CTLA to CTLD, one of such barrier drive signal DRV0 and the common signal Vcom, and each output the thus-selected signal for the respective barrier drive signals DRVS and DRVA to DRVD ((G) to (K) of FIG. 43) as in the first embodiment described above.

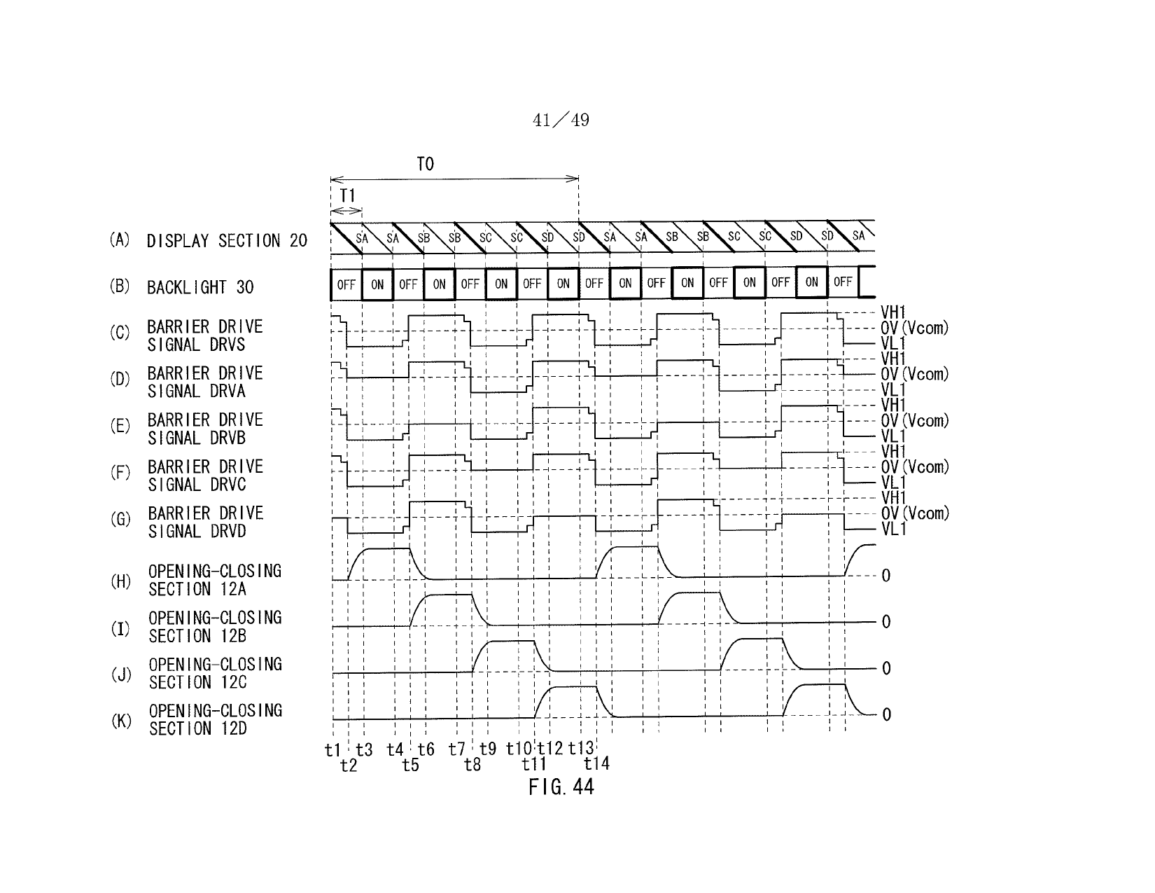

FIG. 44 is a timing chart illustrating operations of the stereoscopic displaying in the stereoscopic display device 6, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D. It is to be noted that timing t2 and so forth illustrated in FIG. 44 correspond to those illustrated in FIG. 43, etc.

First, the stereoscopic display device 6 performs the displaying based on the image signal SA, in a period from timing t1 to timing t4. More specifically, in the display section 20 from the timing t1 to timing t3, the displaying based on the image signal SA is performed first ((A) of FIG. 44). Then, around the timing t2, the barrier driving section 140 varies the barrier drive signal DRVA in two steps to have zero volts (the common signal Vcom), and varies the remaining other barrier drive signals DRVS and DRVB to DRVD to have the low level voltage VL1 ((C) to (G) of FIG. 44). This causes the transmittance T of light in the opening-closing section 12A to increase in the liquid crystal barrier section 10 ((H) of FIG. 44). Then, in the display section 20 from the timing t3 to the timing t4, the displaying based on the image signal SA is performed again ((A) of FIG. 44), and the backlight 30 is turned on ((B) of FIG. 44). Thereby, a viewer may see the displaying based on the image signal SA on the display section 20 from the timing t3 to the timing t4.

Likewise, the stereoscopic display device 6 performs the displaying based on the image signal SB in a period from the timing t4 to timing t7, performs the displaying based on the image signal SC in a period from the timing t7 to timing t10, and performs the displaying based on the image signal SD in a period from the timing t10 to timing t13.

In the stereoscopic display device 6, the amplitude of each of the barrier drive signals DRVS and DRVA to DRVD supplied to the opening-closing sections 11 and 12 is made larger. This makes it possible to improve such as the crosstalk and contrast just as in the fifth embodiment described above.

Also, the stereoscopic display device 6 allows each of the barrier drive signals DRVS and DRVA to DRVD to make transition in two steps, making it possible to further reduce the crosstalk as described below.

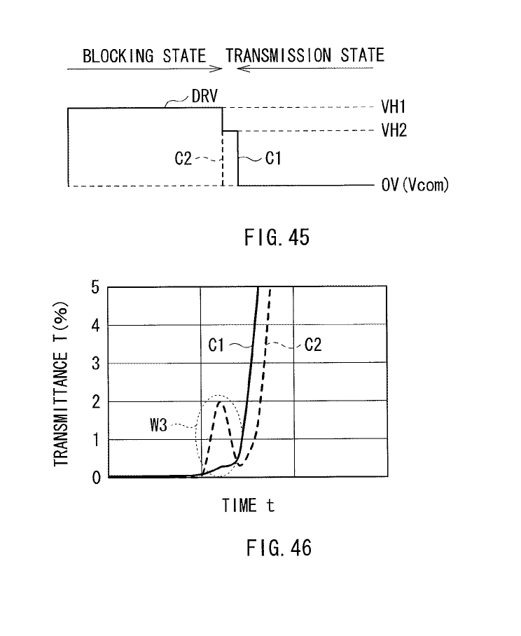

FIG. 45 illustrates an example of a waveform of the barrier drive signal DRV. FIG. 46 illustrates an example of a time change in the transmittance T in the opening-closing section 11 to which the barrier drive signal DRV illustrated in FIG. 45 is supplied. FIGS. 45 and 46 each illustrate an operation of the opening-closing section 11 where the opening-closing section 11 varies from the blocking state (the closed state) to the transmission state (the open state).

An example illustrated in FIG. 45 illustrates that the barrier drive signal DRV (DRVS and DRVA to DRVD) varies from the high level voltage VH1 to zero volts, i.e., the opening-closing section 11 to which such barrier drive signal DRV is applied varies from the blocking state to the transmission state. A waveform denoted by C1 shows an example where the barrier drive signal DRV varies from the high level voltage VH1 to zero volts, through the voltage VH2 which is lower than the voltage VH1. In other words, the waveform denoted by C1 corresponds to the barrier drive signal DRV (DRVS and DRVA to DRVD) according to the present embodiment. Also, unlike the example of C1, a waveform denoted by C2 shows an example where the barrier drive signal DRV varies from the high level voltage VH1 to zero volts directly.

In an example where the barrier drive signal DRV with such waveform denoted by C2 is applied, there may be a case as illustrated in FIG. 46 where the transmittance T in the opening-closing section 11 does not vary monotonously, but follows a course of once starting to rise, then decreasing once (denoted by a portion W3), and rising again thereafter. Such transitional change in the transmittance T may cause twisting in orientation of the liquid crystal molecules M in the blocking state due to the high voltage derived from the high level voltage VH1, indicating that a response in the liquid crystal molecules M may be disturbed when the barrier drive signal DRV varies rapidly to zero volts. In a case where the transmittance T has risen temporarily, a viewer may see contents of displaying on the display section 20 in a period during which the temporal rise in the transmittance T has occurred. In this case, the crosstalk may occur, which may lead to deterioration in the image quality.

In contrast, in the example denoted by C1, the barrier drive signal DRV is varied in two steps. This reduces the disturbance in the response of the liquid crystal molecules M when the opening-closing section 11 varies from the blocking state (the closed state) to the transmission state (the open state), allowing the transmittance T to vary monotonously as illustrated in FIG. 46. Hence, it is possible to reduce the crosstalk occurring in the example denoted by C2, and to reduce a possibility that the image quality deteriorates.

According to the sixth embodiment, the barrier drive signal varies in two steps in performing the stereoscopic displaying, making it possible to improve such as the crosstalk and contrast, and to improve the image quality.

Also, in the sixth embodiment, the barrier drive signal generating section 143 generates the barrier drive signal DRV0 whose voltage level makes transition in two steps. Hence, it is possible to simplify a circuit configuration.

Other effects achieved by the sixth embodiment are the same as those according to the first embodiment described above.

### Modification 6-1

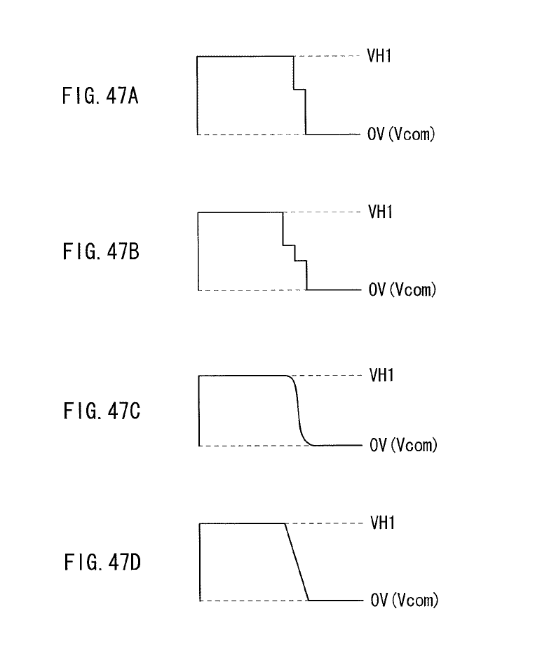

In the sixth embodiment described above, each of the barrier drive signals DRVS and DRVA to DRVD makes transition in two steps, although it is not limited thereto. Alternatively, other than the embodiment of the two-step transition described above (FIG. 47A), one or more of the barrier drive signals DRVS and DRVA to DRVD may vary in three steps (FIG. 47B), or may likewise vary in four steps or more, for example. Also, one or more of the barrier drive signals DRVS and DRVA to DRVD may vary not rapidly from the high level voltage VH1 but may vary slightly smoothly from the high level voltage VH1 (FIG. 47C), or may vary from the high level voltage VH1 toward zero volts according to a linear function (FIG. 47D). It is to be noted that each of FIGS. 47A to 47D illustrates an embodiment where the barrier drive signal varies from the high level voltage VH1 to zero volts, but the same is true for embodiments where the barrier drive signal varies from the low level voltage VL1 to zero volts.

### Modification 6-2

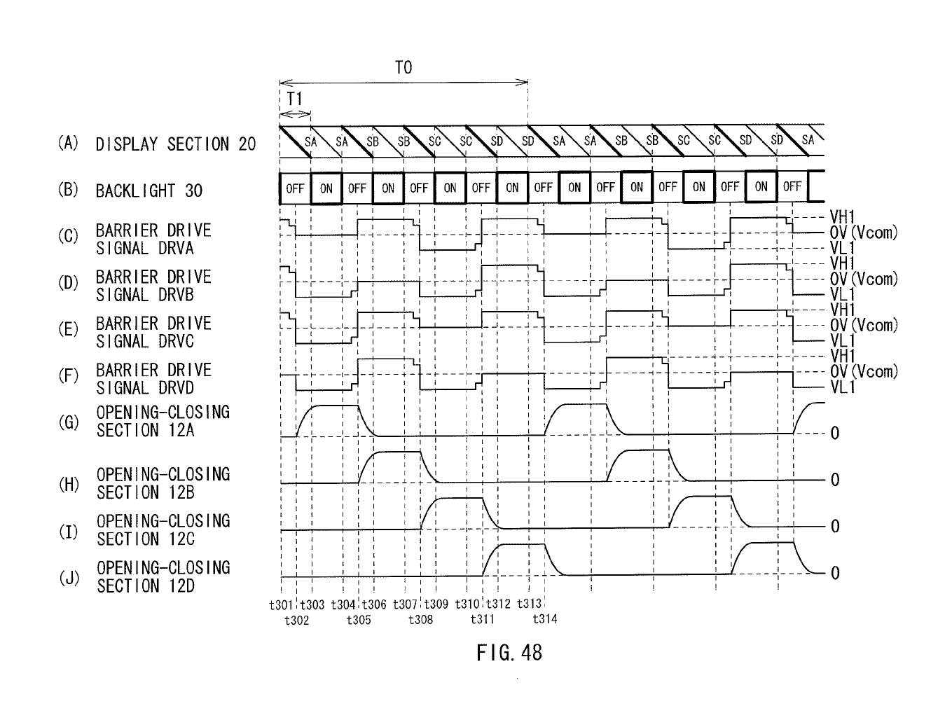

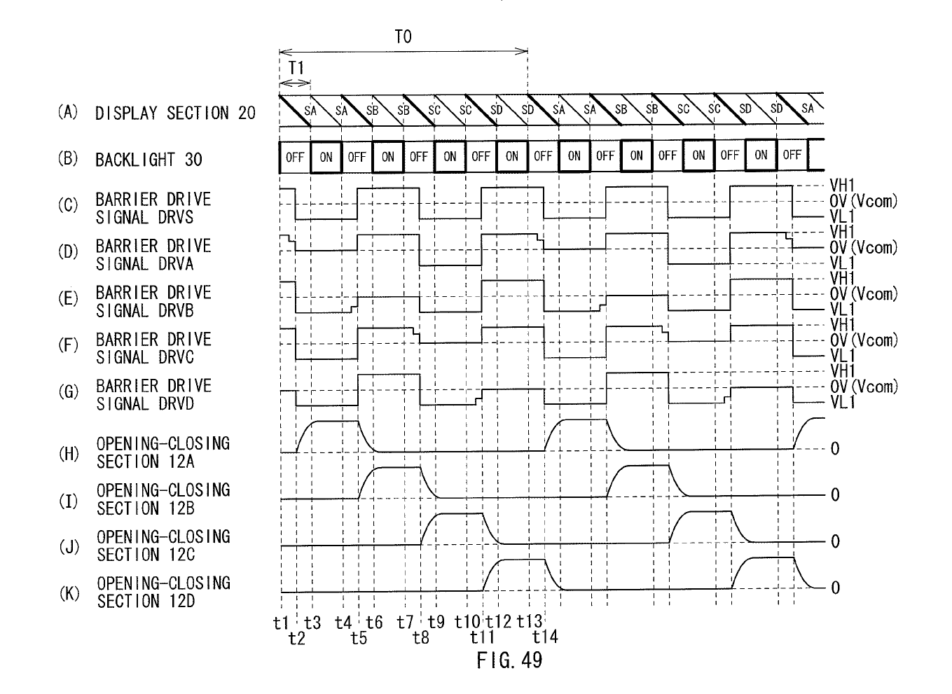

In the sixth embodiment described above, the amplitude of each of the barrier drive signals DRVS and DRVA to DRVD in the stereoscopic display device 1 according to the first embodiment is set larger, as well as the voltage level of each of the barrier drive signals DRVS and DRVA to DRVD therein makes two-step transition, although it is not limited thereto. Alternatively, the amplitude of each of the barrier drive signals DRVS and DRVA to DRVD may be set larger and the voltage level of each of the barrier drive signals DRVS and DRVA to DRVD may make the two-step transition, likewise in each of the first to the fourth embodiments and the modifications thereof, for example. As one embodiment, FIG. 48 illustrates a timing waveform chart in which the present modification is applied to the stereoscopic display device 4 according to the fourth embodiment.

### Modification 6-3

In the sixth embodiment described above, each of the barrier drive signals DRVS and DRVA to DRVD makes two-step transition in varying from the high level voltage VH1 to zero volts, from the high level voltage VH1 to the low level voltage VL1, from the low level voltage VL1 to zero volts, and from low level voltage VL1 to the high level voltage VH1 as illustrated in (G) to (K) of FIG. 44, although it is not limited thereto. Alternatively, each of the barrier drive signals DRVS and DRVA to DRVD may make two-step transition in varying from the high level voltage VH1 to zero volts and from low level voltage VL1 to zero volts only. This makes it possible to reduce the disturbance in the response of the liquid crystal molecules M in varying from the blocking state (the closed state) to the transmission state (the open state). Hence, it is possible to reduce the crosstalk, and to improve the image quality.

Although the technology has been described in the foregoing by way of example with reference to the embodiments and the modifications, the technology is not limited thereto but may be modified in a wide variety of ways.

For example, in the first, the second, and the fourth embodiments and the modifications thereof, the barrier drive signal generating section (such as the barrier drive signal generating section 63) generates the barrier drive signal DRV0 in the form of an AC signal, although it is not limited thereto. Alternatively, the barrier drive signal generating section (such as the barrier drive signal generating section 63) may generate the barrier drive signal DRV0 in the form of a DC signal, for example.

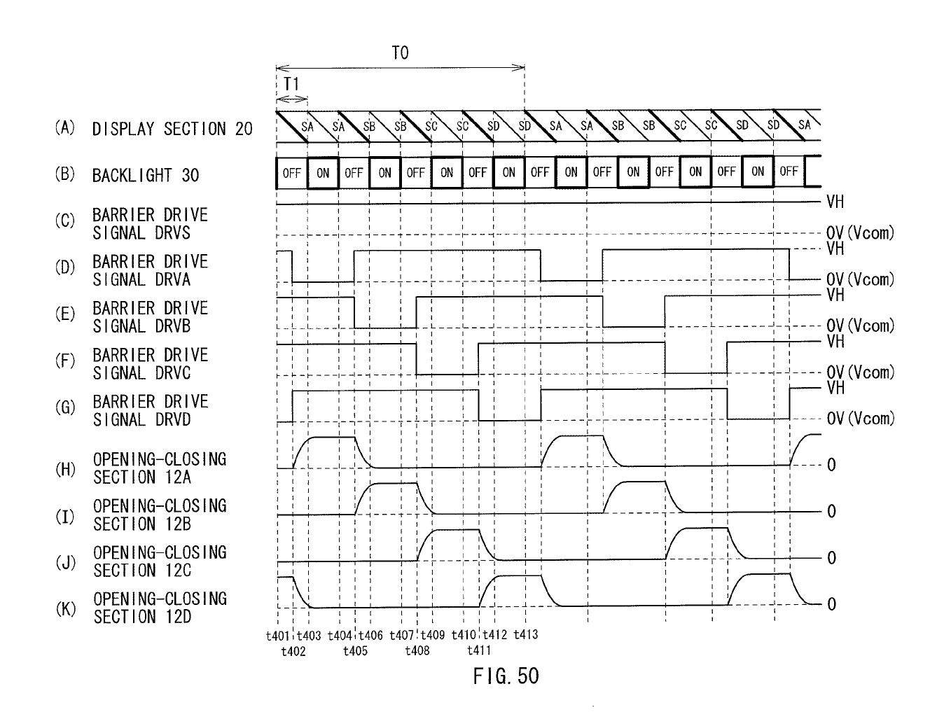

FIG. 50 is a timing chart illustrating operations in a stereoscopic display device according to the present modification, in which (A) illustrates an operation of the display section 20, (B) illustrates an operation of the backlight 30, (C) to (G) illustrate the waveforms of the respective barrier drive signals DRVS and DRVA to DRVD, and (H) to (K) illustrate transmittance T of light for the respective opening-closing sections 12A to 12D.

In the stereoscopic display device according the present embodiment, the barrier drive signal generating section 63 generates the barrier drive signal DRV0 in the form of the DC signal (high level voltage VH in this modification although it is not limited thereto). In performing the stereoscopic displaying, the selector circuit 64S outputs such DC barrier drive signal DRV0 as the barrier drive signal DRVS ((C) of FIG. 50). Also, the selector circuits 64A to 64D, respectively, generate the barrier drive signals DRVA to DRVD based on such barrier drive signal DRV0 and the common signal Vcom, and output the thus-generated barrier drive signals DRVA to DRVD, as in the above-described embodiments ((D) to (G) of FIG. 50).

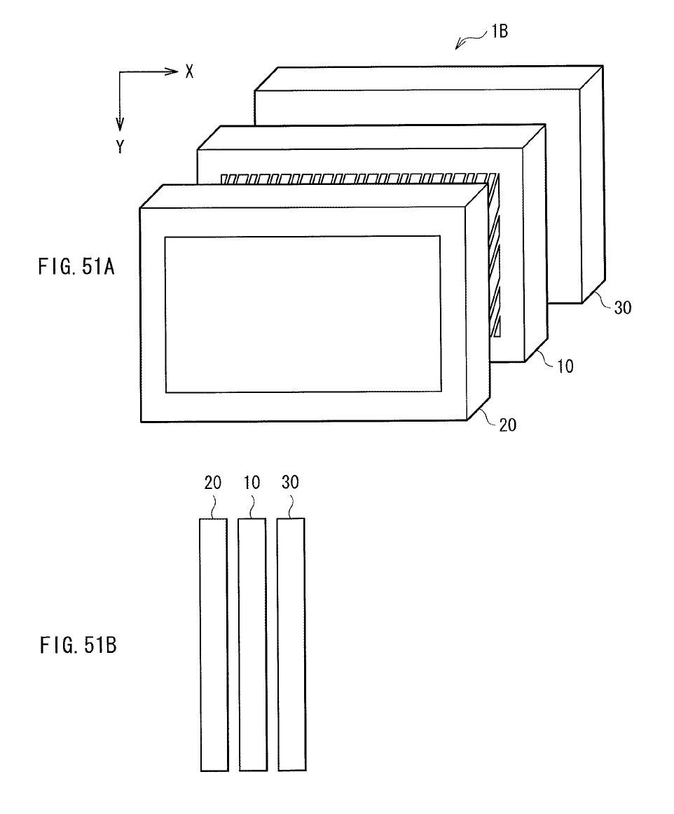

Also, for example, the backlight 30, the liquid crystal section 20, and the liquid crystal barrier section 10 are disposed in this order in the stereoscopic display devices (such as the stereoscopic display device 1) according to the embodiments and the modifications described above, although it is not limited thereto. Alternatively, the backlight 30, the liquid crystal barrier section 10, and the display section 20 may be disposed in this order, as illustrated in FIGS. 51A and 51B.

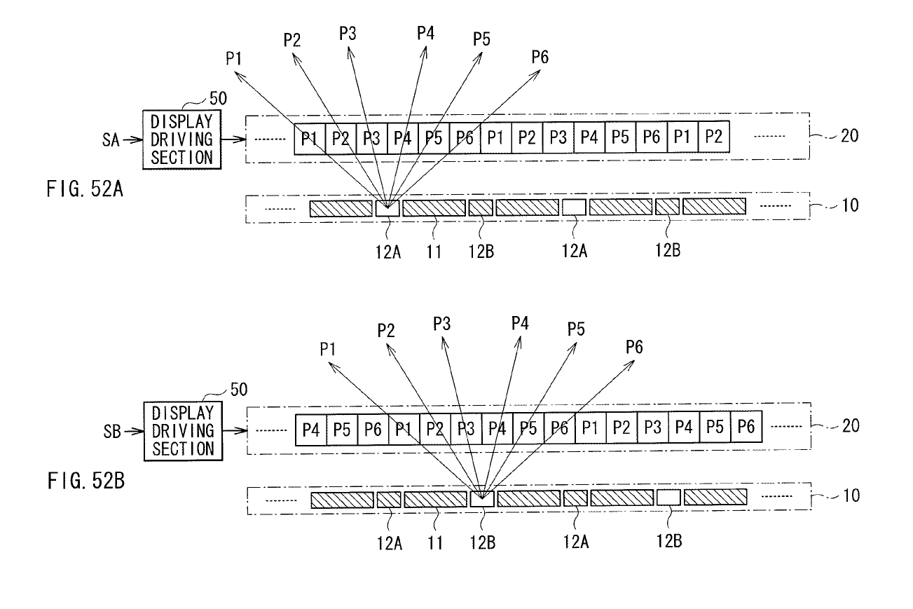

FIGS. 52A and 52B each illustrate an exemplary operation of the display section 20 and the liquid crystal barrier section 10 according to the present modification, in which FIG. 52A illustrates a case where the image signal SA is supplied, and FIG. 52B illustrate a case where the image signal SB is supplied. FIGS. 52A and 52B illustrate an example where the opening-closing sections 12 configure three groups, and the display section 20 displays six perspective images. In the present modification, light beams outputted from the backlight 30 enter the liquid crystal barrier section 10 first. Then, among those light beams that have entered the liquid crystal barrier section 10, light beams having passed through the opening-closing sections 12A and 12B are modulated in the display section 20, to output the six perspective images.

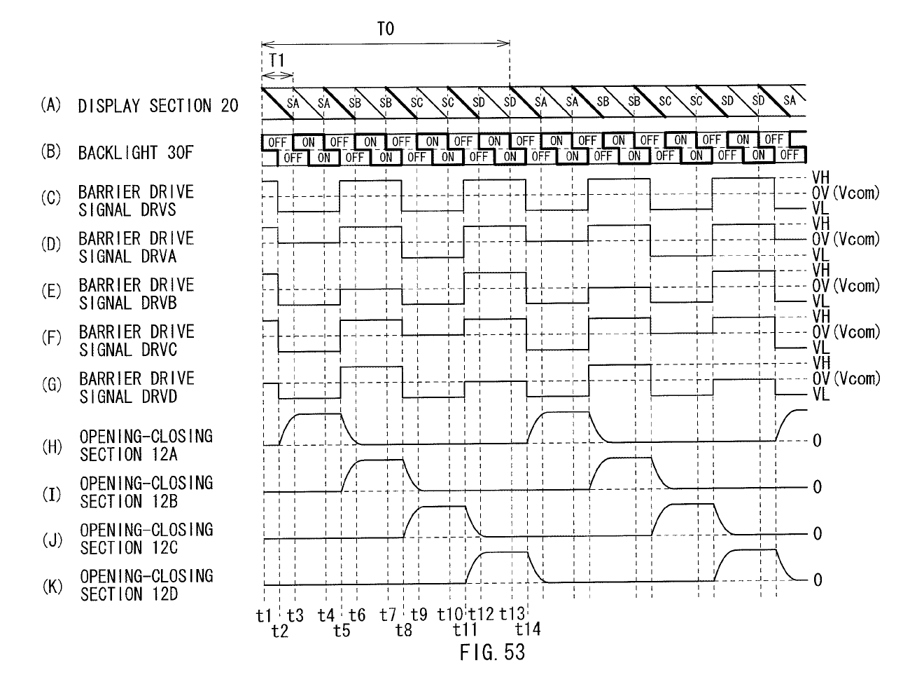

Also, for example, the backlight 30 that emits light based on surface-emission is used in the embodiments and the modifications described above, although it is not limited thereto. Alternatively, a backlight having a plurality of light-emitting subsections that are disposed side-by-side in the vertical direction Y may be used to allow the respective light-emitting subsections to emit light in a time-divisional fashion in synchronization with display scanning in the display section 20. FIG. 53 is a timing chart illustrating operations of stereoscopic displaying, where the present modification is applied to the stereoscopic display device 1 according to the above-described first embodiment. A backlight 30F according to the present modification includes two light-emitting subsections. The use of such backlight makes it possible to improve the image quality in a case where, for example, a response of liquid crystal elements in the display section 20 is slow.

Thus, it is possible to achieve at least the following configurations from the above-described example embodiments and the modifications of the disclosure.

(1) A display device, including:

a display section;

a barrier section including a plurality of liquid crystal barriers that are disposed side-by-side, each of the liquid crystal barriers being switchable between an open state and a closed state; and

a barrier driving section supplying drive signals to two or more liquid crystal barriers that are adjacent to each other and to be placed into the closed state among the plurality of liquid crystal barriers, the drive signals supplied to the two or more liquid crystal barriers having respective polarities that are same with respect to one another.

(2) The display device according to (1), wherein the plurality of liquid crystal barriers include a plurality of first liquid crystal barriers and a plurality of second liquid crystal barriers, the first liquid crystal barriers and the second liquid crystal barriers extending in a first direction and being provided alternately in a direction intersecting the first direction.
(3) The display device according to (2), wherein

the first liquid crystal barriers are grouped into a plurality of barrier groups, and

the barrier driving section drives the first liquid crystal barriers, in turn between the barrier groups in a first period, to be in the open state or the closed state, and drives the second liquid crystal barriers to be in the closed state.

(4) The display device according to (3), wherein

the drive signals include a plurality of first drive signals and a second drive signal, the first drive signals being mutually different for each of the barrier groups, and each of the first and the second drive signals being a signal whose polarity makes transition, and

the barrier driving section supplies the first drive signals to the first liquid crystal barriers and supplies the second drive signal to each of the second liquid crystal barriers.

(5) The display device according to (4), wherein the polarity of each of the first drive signals, supplied to the first liquid crystal barriers that are to be placed into the closed state, is same as the polarity of the second drive signal supplied to each of the second liquid crystal barriers that are to be placed into the closed state.
(6) The display device according to (5), wherein a voltage of each of the first drive signals, supplied to the first liquid crystal barriers that are to be placed into the closed state, is substantially same as a voltage of the second drive signal supplied to each of the second liquid crystal barriers that are to be placed into the closed state.
(7) The display device according to (5), wherein amplitude of each of the first drive signals, supplied to the first liquid crystal barriers that are to be placed into the closed state, is substantially smaller than amplitude of the second drive signal supplied to each of the second liquid crystal barriers that are to be placed into the closed state.
(8) The display device according to any one of (4) to (7), wherein the polarity of the second drive signal reverses for each second period that is shorter than the first period.
(9) The display device according to any one of (4) to (7), wherein the second drive signal includes a partial drive waveform whose polarity reverses for each second period that is shorter than the first period, and the partial drive waveform inverts for each of the first periods.
(10) The display device according to any one of (4) to (7), wherein the polarity of the second drive signal reverses for each of the first periods.
(11) The display device according to any one of (4) to (10), wherein a period during which the first liquid crystal barriers, belonging to a first barrier group of the plurality of barrier groups, are in the open state is partially overlapped with a period during which the first liquid crystal barriers belonging to a second barrier group of the plurality of barrier groups are in the open state.
(12) The display device according to any one of (4) to (11), wherein the first drive signals include:

a first waveform portion by which the first liquid crystal barriers are placed into the closed state;

a second waveform portion by which the first liquid crystal barriers are placed into the open state; and

a third waveform portion provided substantially after the first waveform portion and substantially before the second waveform portion.

(13) The display device according to (12), wherein the second drive signal includes a waveform portion that corresponds to the first waveform portion, and a waveform portion that corresponds to the third waveform portion.
(14) The display device according to any one of (3) to (13), wherein a plurality of displaying modes are included, the displaying modes including a three-dimensional image displaying mode and a two-dimensional image displaying mode, and

the display section displays a plurality of different perspective images in the three-dimensional image displaying mode.

(15) The display device according to (2), wherein a plurality of displaying modes are included, the displaying modes including a three-dimensional image displaying mode and a two-dimensional image displaying mode, and

the display section displays a single perspective image, and the barrier driving section drives the first liquid crystal barriers and the second liquid crystal barriers to be in the open state in the two-dimensional image displaying mode.

(16) The display device according to (1), wherein

the liquid crystal barriers extend in a first direction, and are grouped into a plurality of barrier groups, and

the barrier driving section drives the liquid crystal barriers, in turn between the barrier groups in a first period, to be in the open state or the closed state.

(17) The display device according to (16), wherein the barrier driving section supplies the liquid crystal barriers with the drive signals, that are mutually different for each of the barrier groups and each of which is a signal whose polarity makes transition.
(18) The display device according to (17), wherein the drive signals, supplied to the liquid crystal barriers that are to be placed into the closed state, are same in polarity as the drive signals supplied to the liquid crystal barriers adjacent thereto that are to be placed into the closed state.
(19) The display device according to (17) or (18), wherein the drive signals, supplied to the liquid crystal barriers that are to be placed into the closed state, are same in voltage as the drive signals supplied to the liquid crystal barriers adjacent thereto that are to be placed into the closed state.
(20) The display device according to any one of (17) to (19), wherein each of the drive signals makes the transition for each second period that is shorter than the first period.
(21) The display device according to any one of (17) to (20), wherein the drive signals include:

a first waveform portion by which the liquid crystal barriers are placed into the closed state;

a second waveform portion by which the liquid crystal barriers are placed into the open state; and

a third waveform portion provided substantially after the first waveform portion and substantially before the second waveform portion.

(22) The display device according to any one of (1) to (21), wherein each of the liquid crystal barriers opens and closes based on a potential difference between the drive signal and a common signal.
(23) The display device according to (22), wherein the common signal is a direct-current signal.
(24) The display device according to (22), wherein the common signal is an alternating-current signal.
(25) The display device according to any one of (1) to (24), wherein a transmittance in each of the liquid crystal barriers decreases as the potential difference increases.
(26) The display device according to any one of (1) to (25), further including a backlight, wherein the display section is a liquid crystal display section disposed between the backlight and the barrier section.
(27) The display device according to any one of (1) to (25), further including a backlight, wherein the display section is a liquid crystal display section, and the barrier section is disposed between the backlight and the liquid crystal display section.
(28) A barrier device, including:

a barrier section including a plurality of liquid crystal barriers that are disposed side-by-side, each of the liquid crystal barriers being switchable between an open state and a closed state; and

a barrier driving section supplying drive signals to two or more liquid crystal barriers that are adjacent to each other and to be placed into the closed state among the plurality of liquid crystal barriers, the drive signals supplied to the two or more liquid crystal barriers having respective polarities that are same with respect to one another.

(29) A barrier driving circuit, including:

a barrier driving section supplying drive signals to two or more liquid crystal barriers that are adjacent to each other and to be placed into a closed state among a plurality of liquid crystal barriers, the plurality of liquid crystal barriers being disposed side-by-side and each of the liquid crystal barriers being switchable between an open state and the closed state, and the drive signals supplied to the two or more liquid crystal barriers having respective polarities that are same with respect to one another.

(30) A barrier device driving method, including:

generating drive signals supplied to two or more liquid crystal barriers that are adjacent to each other and to be placed into a closed state among a plurality of liquid crystal barriers, the plurality of liquid crystal barriers being disposed side-by-side and each of the liquid crystal barriers being switchable between an open state and the closed state, and the drive signals supplied to the two or more liquid crystal barriers having respective polarities that are same with respect to one another; and

driving the two or more liquid crystal barriers by supplying the two or more liquid crystal barriers with the generated drive signals.

The present disclosure contains subject matter related to that disclosed in Japanese Priority Patent Application JP 2011-122737 filed in the Japan Patent Office on May 31, 2011 and Japanese Priority Patent Application JP 2012-004928 filed in the Japan Patent Office on Jan. 13, 2012, the entire content of which is hereby incorporated by reference.

Although the technology has been described in terms of exemplary embodiments, it is not limited thereto. It should be appreciated that variations may be made in the described embodiments by persons skilled in the art without departing from the scope of the technology as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

What is claimed is:

1. A display device, comprising:
a display section;
a barrier section including a plurality of liquid crystal barriers that are disposed side-by-side, each of the liquid crystal barriers being switchable between an open state and a closed state; and
a barrier driving section supplying drive signals to two or more liquid crystal barriers that are adjacent to each other and to be placed into the closed state among the plurality of liquid crystal barriers, the drive signals supplied to the two or more liquid crystal barriers having respective polarities that are same with respect to one another.

2. The display device according to claim 1, wherein the plurality of liquid crystal barriers include a plurality of first liquid crystal barriers and a plurality of second liquid crystal barriers, the first liquid crystal barriers and the second liquid crystal barriers extending in a first direction and being provided alternately in a direction intersecting the first direction.

3. The display device according to claim 2, wherein
the first liquid crystal barriers are grouped into a plurality of barrier groups, and
the barrier driving section drives the first liquid crystal barriers, in turn between the barrier groups in a first period, to be in the open state or the closed state, and drives the second liquid crystal barriers to be in the closed state.

4. The display device according to claim 3, wherein
the drive signals include a plurality of first drive signals and a second drive signal, the first drive signals being mutually different for each of the barrier groups, and each of the first and the second drive signals being a signal whose polarity makes transition, and
the barrier driving section supplies the first drive signals to the first liquid crystal barriers and supplies the second drive signal to each of the second liquid crystal barriers.

5. The display device according to claim 4, wherein the polarity of each of the first drive signals, supplied to the first liquid crystal barriers that are to be placed into the closed state, is same as the polarity of the second drive signal supplied to each of the second liquid crystal barriers that are to be placed into the closed state.

6. The display device according to claim 5, wherein a voltage of each of the first drive signals, supplied to the first liquid crystal barriers that are to be placed into the closed state, is substantially same as a voltage of the second drive signal supplied to each of the second liquid crystal barriers that are to be placed into the closed state.

7. The display device according to claim 5, wherein amplitude of each of the first drive signals, supplied to the first liquid crystal barriers that are to be placed into the closed state, is substantially smaller than amplitude of the second drive signal supplied to each of the second liquid crystal barriers that are to be placed into the closed state.

8. The display device according to claim 4, wherein the polarity of the second drive signal reverses for each second period that is shorter than the first period.

9. The display device according to claim 4, wherein the second drive signal includes a partial drive waveform whose polarity reverses for each second period that is shorter than the first period, and the partial drive waveform inverts for each of the first periods.

10. The display device according to claim 4, wherein the polarity of the second drive signal reverses for each of the first periods.

11. The display device according to claim 4, wherein a period during which the first liquid crystal barriers, belonging to a first barrier group of the plurality of barrier groups, are in the open state is partially overlapped with a period during which the first liquid crystal barriers belonging to a second barrier group of the plurality of barrier groups are in the open state.

12. The display device according to claim 4, wherein the first drive signals include:
a first waveform portion by which the first liquid crystal barriers are placed into the closed state;
a second waveform portion by which the first liquid crystal barriers are placed into the open state; and
a third waveform portion provided substantially after the first waveform portion and substantially before the second waveform portion.

13. The display device according to claim 12, wherein the second drive signal includes a waveform portion that corresponds to the first waveform portion, and a waveform portion that corresponds to the third waveform portion.

14. The display device according to claim 3, wherein a plurality of displaying modes are included, the displaying modes including a three-dimensional image displaying mode and a two-dimensional image displaying mode, and
the display section displays a plurality of different perspective images in the three-dimensional image displaying mode.

15. The display device according to claim 2, wherein a plurality of displaying modes are included, the displaying modes including a three-dimensional image displaying mode and a two-dimensional image displaying mode, and
the display section displays a single perspective image, and the barrier driving section drives the first liquid crystal barriers and the second liquid crystal barriers to be in the open state in the two-dimensional image displaying mode.

16. The display device according to claim 1, wherein
the liquid crystal barriers extend in a first direction, and are grouped into a plurality of barrier groups, and
the barrier driving section drives the liquid crystal barriers, in turn between the barrier groups in a first period, to be in the open state or the closed state.

17. The display device according to claim 16, wherein the barrier driving section supplies the liquid crystal barriers with the drive signals, that are mutually different for each of the barrier groups and each of which is a signal whose polarity makes transition.

18. The display device according to claim 17, wherein the drive signals, supplied to the liquid crystal barriers that are to be placed into the closed state, are same in polarity as the drive signals supplied to the liquid crystal barriers adjacent thereto that are to be placed into the closed state.

19. The display device according to claim 18, wherein the drive signals, supplied to the liquid crystal barriers that are to be placed into the closed state, are same in voltage as the drive signals supplied to the liquid crystal barriers adjacent thereto that are to be placed into the closed state.

20. The display device according to claim 17, wherein each of the drive signals makes the transition for each second period that is shorter than the first period.

21. The display device according to claim 17, wherein the drive signals include:
a first waveform portion by which the liquid crystal barriers are placed into the closed state;
a second waveform portion by which the liquid crystal barriers are placed into the open state; and
a third waveform portion provided substantially after the first waveform portion and substantially before the second waveform portion.

22. The display device according to claim 1, wherein each of the liquid crystal barriers opens and closes based on a potential difference between the drive signal and a common signal.

23. The display device according to claim 22, wherein the common signal is a direct-current signal.

24. The display device according to claim 22, wherein the common signal is an alternating-current signal.

25. The display device according to claim 22, wherein a transmittance in each of the liquid crystal barriers decreases as the potential difference increases.

26. The display device according to claim 1, further comprising a backlight, wherein the display section is a liquid crystal display section disposed between the backlight and the barrier section.

27. The display device according to claim 1, further comprising a backlight, wherein the display section is a liquid crystal display section, and the barrier section is disposed between the backlight and the liquid crystal display section.

28. A barrier device, comprising:
a barrier section including a plurality of liquid crystal barriers that are disposed side-by-side, each of the liquid crystal barriers being switchable between an open state and a closed state; and
a barrier driving section supplying drive signals to two or more liquid crystal barriers that are adjacent to each other and to be placed into the closed state among the plurality of liquid crystal barriers, the drive signals supplied to the two or more liquid crystal barriers having respective polarities that are same with respect to one another.

29. A barrier driving circuit, comprising:
a barrier driving section supplying drive signals to two or more liquid crystal barriers that are adjacent to each other and to be placed into a closed state among a plurality of liquid crystal barriers, the plurality of liquid crystal barriers being disposed side-by-side and each of the liquid crystal barriers being switchable between an open state and the closed state, and the drive signals supplied to the two or more liquid crystal barriers having respective polarities that are same with respect to one another.

30. A barrier device driving method, comprising:
generating drive signals supplied to two or more liquid crystal barriers that are adjacent to each other and to be placed into a closed state among a plurality of liquid crystal barriers, the plurality of liquid crystal barriers being disposed side-by-side and each of the liquid crystal barriers being switchable between an open state and the closed state, and the drive signals supplied to the two or more liquid crystal barriers having respective polarities that are same with respect to one another; and
driving the two or more liquid crystal barriers by supplying the two or more liquid crystal barriers with the generated drive signals.
